(19) United States
(12) Patent Application Publication
(10) Pub. No.: US 2015/0205921 A1
(43) Pub. Date: Jul. 23, 2015

(54) SYSTEMS AND METHODS FOR ELECTRONIC HEALTHCARE DATA MANAGEMENT AND PROCESSING

(71) Applicant: Six Sigma Systems, Inc., Phoenix, AZ (US)

(72) Inventors: Mischa Dick, Phoenix, AZ (US); Marjorie A. Green, Overland Park, KS (US)

(73) Assignee: Six Sigma Systems, Inc., Phoenix, AZ (US)

(21) Appl. No.: 14/497,174

(22) Filed: Sep. 25, 2014

Related U.S. Application Data
(60) Provisional application No. 61/930,351, filed on Jan. 22, 2014.

(51) Int. Cl. G06F 19/00

(52) U.S. Cl. CPC G06F 19/322

(57) ABSTRACT

Various embodiments provides for systems and methods that allow for a user to manage their healthcare data and intelligently control access to such healthcare data by healthcare providers, family, friends, and others. According to some embodiments, a system or method stores, on a datastore, healthcare data associated with a first user, establishes an association between the first user and a second user, and controls data access privileges of the second user to the healthcare data on the datastore, where the controlling the data access privileges are based on the association between the first user and the second user. The system or method can access a first subset of data from the healthcare data based on the data access privileges of the second user, and issue or schedule a notification with respect to the second user based on the first subset of data.

### CROSS-REFERENCE TO RELATED APPLICATIONS

The present application claims priority from U.S. Provisional Patent Application Ser. No. 61/930,351, filed Jan. 22, 2014, entitled “EcoWell Manager,” which is incorporated herein by reference.

### BACKGROUND

1. Technical Field

The present system relates generally to health and wellness and, more particularly, management of healthcare data and management of actions related to healthcare data.

2. Description of Related Art

Mobile platforms and applications relating to health, wellness and medical treatment are becoming more user-friendly, sophisticated, and readily available. Such mobile platforms and applications can assist professional healthcare providers, non-professional healthcare providers, and others in health and wellness management of an individual (e.g., patient), can provide physicians with convenient tools for sharing and analyzing patient data of an individual, can promote healthy living for an individual, and can improve or facilitate the delivery of patient care to an individual. They are transforming the health industry by enhancing consumer engagement, lowering healthcare costs, and improving general patient satisfaction.

Unfortunately, an individual's (e.g., patient's) control of their healthcare data (e.g., medical data) is often limited or altogether relinquished (e.g., to healthcare providers) once that data is entered into or received by conventional medical systems (e.g., by a healthcare provider). Generally, the individual has little or no control over which healthcare providers can access the individual's healthcare data, has little or no control over what healthcare providers can do with the individual's healthcare data (e.g., once in their possession), and lacks the ability to safely and conveniently share the individual's healthcare data with non-healthcare providers, such as family or friends. Such functionality can be beneficial, particularly for those patients of the chronically ill community, who are often clinically cared for by non-clinical personal such as family members.

### SUMMARY

Various embodiments described herein provide for systems and methods that manage of healthcare data and manage of actions related such healthcare data. The systems and methods of some embodiments allow a user to manage their healthcare data and intelligently control access to such healthcare data by healthcare providers, family, friends, and others.

According to some embodiments, a system or method stores, on a datastore, healthcare data associated with a first user, establishes an association between the first user and a second user, and controls data access privileges of the second user to the healthcare data on the datastore, where the controlling the data access is based on the association between the first user and the second user. The system or method can access a first subset of data from the healthcare data based on the data access privileges of the second user, and issue or schedule a notification for the second user based on the first subset of data. The healthcare data can include a note, audio, a video, or an image relating to healthcare of the first user. The association can include a family relationship, a friendship, a healthcare professional, or a healthcare non-professional. The data access privileges of the second user can comprise viewing, adding, modifying, or removing a second subset of data with respect to the healthcare data. For some embodiments, the healthcare data includes a second subset of data regarding an existing health condition, a biometric, personal medical history, family medical history, a diet, medication history of the first user, currently prescribed medication regimen, or a prescription issued to the first user. For example, the second subset of data can include an instruction, health practitioner information, a medication identifier, a dosage, an expiration, a medication amount, a refill count, refill date, or a refill condition relating to the prescription of the first user.

Depending on the embodiment, at least some of the healthcare data may be received from the first user through a mobile computing device, and at least some of that healthcare data may be captured by the first user using the mobile computing device (e.g., biometric reader integrated into the mobile computing device).

For some embodiments, the system or method provides an in-system communication transport between two or more users of the system or method. Over the in-system communication transport (e.g., in-system e-mail or chat), the system or method can transmit, based on a request by the first user, a second subset of data from the first user to another user, where the second subset of data is selected from the healthcare data by the first user.

In some embodiments, the system or method determining, based on a second subset of data from the healthcare data, whether the first user is complying with a prescribed medical regimen. Additionally, in some embodiments, the system or method authorized or denies a first request, by the second user, for modifying the data access privileges of the second user to the healthcare data, or authorizing or denying a second request, by the second user, for establishing the association between the first user and the second user.

Various embodiments provide for a computer program product comprising computer instruction codes configured to cause the computer system to perform various operations described herein.

Other features and aspects of various embodiments will become apparent from the following detailed description, taken in conjunction with the accompanying drawings, which illustrate, by way of example, the features of such embodiments.

### BRIEF DESCRIPTION OF THE DRAWINGS

Various embodiments are described in detail with reference to the following figures. The drawings are provided for purposes of illustration only and merely depict some embodiments. These drawings shall not be considered limiting of the breadth, scope, or applicability of embodiments.

FIG. 1 is a block diagram illustrating an example network system that may be used with various embodiments.

FIG. 2 is a block diagram illustrating an example healthcare data system in accordance with various embodiments.

FIG. 3 is a block diagram illustrating an example healthcare data client in accordance with various embodiments.

FIG. 4 is a flowchart illustrating an example method for managing healthcare data for a user in accordance with various embodiments.

FIG. 5 is a screenshot of an example graphical user interface for a healthcare data system in accordance with various embodiments.

FIG. 6 is a screenshot of an example graphical user interface for personal information in accordance with various embodiments.

FIGS. 7 and 8 are screenshots of example graphical user interfaces for relationship invitations in accordance with various embodiments.

FIG. 9 is a screenshot of an example graphical user interface for data access control in accordance with various embodiments.

FIGS. 10 and 11 are screenshots of example graphical user interfaces for health readings in accordance with various embodiments.

FIGS. 12 and 13 are screenshots of an example graphical user interfaces for medications in accordance with various embodiments.

FIGS. 14 and 15 are screenshots of example graphical user interfaces for a user home page in accordance with various embodiments.

FIG. 16 is a screenshot of an example graphical user interface for a health reading in accordance with various embodiments.

FIG. 17 is a screenshot of an example graphical user interface for a user home page in accordance with various embodiments.

FIG. 18 is a screenshot of an example graphical user interface for health readings in accordance with various embodiments.

FIGS. 19-22 are screenshots of example graphical user interfaces for notifications in accordance with various embodiments.

FIGS. 23-26 are screenshots of example graphical user interfaces for notifications in accordance with various embodiments.

FIG. 27 is a screenshot of an example graphical user interface for user-support features in accordance with various embodiments.

FIGS. 28-30 are screenshots of example graphical user interfaces for biometrics in accordance with various embodiments.

FIG. 31 is a screenshot of an example graphical user interface for user-support features in accordance with various embodiments.

FIG. 32 is a screenshot of example graphical user interfaces for documents in accordance with various embodiments.

FIG. 33 is a screenshot of an example graphical user interface for logging food in accordance with various embodiments.

FIGS. 34 and 35 are screenshots of example graphical user interfaces for rules in accordance with various embodiments.

FIG. 36 is a screenshot of an example graphical user interface for user-support features in accordance with various embodiments.

FIGS. 37-45 are screenshots of example graphical user interfaces for user account setup features in accordance with various embodiments.

FIG. 46 is a block diagram illustrating an exemplary digital device that can be utilized in the implementation of various embodiments.

### DETAILED DESCRIPTION

Various embodiments provide for systems and methods relating to health and wellness and, more particularly, management of healthcare data and management of actions related to healthcare data. In particular, the systems or methods of some embodiments can implement an application that may improve overall health or wellness of users, create sustainable long-term preventative health management for large populations and communities, reduce the need for acute clinical care, lower healthcare costs, assist in disease management and prevention, and provide comprehensive data access to healthcare data that allows for better healthcare decision-making.

As used herein, users can include, without limitation, patients that are users (“patient users”), professional or non-professional healthcare providers that are users (“healthcare provider users”), family members that are users (“family users”), and friends that are users (“friend users”). For some embodiments, a first user can establish an association (e.g., a relationship) with a second user such that the association and its type may be used in determining the second user's access to the first user (e.g., via an in-system communication system) or the first user's data (e.g., healthcare data).

As used herein, a healthcare team or a medical network associated with a patient user will be understood to comprise a group of one or more users responsible in the patient user's health or wellness. A user's members to the healthcare team or medical network may provide the user with default data access privileges to the patient user's healthcare data. Additionally, for some embodiments, the default data access privileges are further based on the user's association (e.g., relationship) with the patient user.

As also used herein, a notification will be understood to include, without limitation, any form of visual, textual, or audio alert or reminder transmitted or received by a computing device. Depending on the embodiment, a given notification may relate to a health reading (e.g., reminder to take health reading, or warning that a health reading is out of range), a medical appointment, medication (e.g., reminder to take medication on a scheduled-basis, or alert that a dosage has been missed), a request for information (e.g., by another user), associations between users (e.g., an invitation to a first user to establish a relationship with a second user), a communication between users (e.g., an in-system communication message from a first user to a second user), or some other activity performed by a system or method described herein.

In various embodiments, systems or methods are provided to electronically store healthcare data (e.g., medical data), share healthcare information, communicate with others, calendar healthcare-related appointments, and set healthcare-related notification (e.g., alerts or reminders). The system or method may be configured to limit access (e.g., input) of healthcare information exclusively to patient users and their defined healthcare team or medical network. In particular embodiments, the system or method allows the patient user to define privacy settings and input their own healthcare data, including data related to wellness, appointments, medication regimens, prescriptions, health readings, and the like. The system or method may retrieve healthcare information that may then be personalized to a patient user's needs. Depending on the embodiment, some or all of a system or method described herein may be stored on one or more computing devices (e.g., servers) associated with a user, vendor, or third party, such as servers of a hospital or other health care facility. Additionally, for some embodiments, some or all of a system or method described herein may be implemented using cloud-based computing resources, such a virtual computer, a PaaS, or an IaaS.

Some embodiments provide for a user-defined and user-controlled system comprising: an application that functions on a computing device, such as a mobile devices or desktop computer, and that manages or utilizes healthcare information stored on the computing device, healthcare information stored on a server accessible to the computing device (e.g., over a computer network), or a combination of both. The healthcare information to the application may be provided by a database containing health, wellness, and personal information, which may be inputted by a user, such as a patient, a professional healthcare provider (e.g., doctor, nurse, etc.), or a non-professional healthcare provider (e.g., medical in-take personnel). The application may enable a user of the system, such as a patient user or a healthcare provider user, to add a patient's healthcare information to the system. With respect to a patient, the healthcare information can include prescription dosage, body composition, healthcare providers, medical appointments, medical activity levels, or current physical and mental conditions. The application can allow a user to calendar recurring appoints and reminders, including doctor's appointments, reminders to take medication, reminders to refill prescription medication, and the like. A user may direct the application to generate reports of healthcare data historically entered to the system by the user.

The application may be configured to deliver or otherwise provide alerts, reminders, or other notifications to users of the system. As users of the system, those providing healthcare to an individual (e.g., patient user) can define, review, or modify parameters (e.g., limits) with respect to alerts, reminders, or other notifications. The alerts, reminders, or other notifications may be delivered or transmitted via different types of mediums, such as electronic mail (e.g., e-mail), pop-up alerts (e.g., on a smartphone), or a text message (e.g., on a mobile phone).

In some embodiments, the systems or methods described herein may provide a user (e.g., a patient user) profile a message wall on which other users, such as family, friends, or healthcare providers, can post messages to the wall. For some embodiments, the other users capable of posting to the message wall may be limited to those in the user's healthcare team or medical network. Through a user's message wall, users can exchange or otherwise share healthcare information relating to the user.

A patient user of a system or method described herein can define family, friend, or healthcare provider users included by their healthcare team or medical network and monitor activities of those users in the healthcare team/medical network as it relates to the patient user. A patient user can control privacy settings with respect to the patient user's healthcare data on the system, and the privacy settings can govern access (e.g., visibility) of the patient user's healthcare data by other users of the system. For example, one or more users (e.g., healthcare provider users) included by another user's (e.g., a patient user's) healthcare team or medical network may access healthcare information, alerts, and data inputted by the other user, subject to that other user's privacy settings. A user may establish a profile to which they input their personal information and which they may or may not make publicly available to users of a healthcare team or a medical network. Through data access control and privacy settings, systems or methods described herein can allow a user to designate any of the user's healthcare data as public, private, or restricted to particular users (e.g., those included in the user's healthcare team or medical network).

A patient user, or a healthcare provider user, may request a system or method described herein to send a copy of some (or all) of the patient's healthcare data or a patient's healthcare report (e.g., including data plotted in graphic or tabular form over time) to another user inside the healthcare team or medical network, or a party outside the healthcare team or medical network (e.g., via e-mail). For some embodiments, where healthcare data is shared through a system or method described herein, the healthcare data may be communicated via e-mail, Skype®, or text message.

According to some embodiment, the systems or methods described herein can implement offline access to healthcare data by a user when the user's computing device lacks network access (e.g., access to Internet) and the healthcare data stored locally on the user's computing device cannot be synchronized in real-time with the centrally-stored version of healthcare data (e.g., on a central server) accessible by other users of the healthcare team or medical network. Such offline access can include viewing or modifying healthcare data (e.g., adding, deleting, or updating information), whereby the user's modification of healthcare data on the user's computing device may not be reflected by the user's healthcare data accessible to other users associated with the healthcare team or medical network. Where offline access involves modification of healthcare data at the user's computing device, such modification can be synchronized with the centrally-stored healthcare data (e.g., on a central server) accessible by other users of the healthcare team or medical network.

For some embodiments, the systems or methods described herein may present healthcare data to a user sequential according to time, by historical trending, or by identification of anomalous events. When the healthcare data is presented on a user's computing device (e.g., mobile device), such healthcare data may be presented in portrait or landscape mode.

Some embodiments provide systems or methods that permit a family user or a friend user to have data access privileges to a patient user's healthcare data, where the data access privileges are controlled according to preferences or settings defined by the patient user's (e.g., the patient user's permission). In doing so, the systems or methods can enable such family or friend users to monitor or maintain the patient's health or wellness and, as a result, such family or friend users can better care for the patient user. These systems or methods can be particularly useful for patient users who are chronically ill, and who are typically provided care by non-clinical personnel, such as their family members.

In some embodiments, a patient user can self-define a health and wellness ecosystem, whereby the ecosystem can include the patient user's health and wellness data (generally referred to herein as “healthcare data”), associations (e.g., relationships) between the patient user and other users of the ecosystem, a group of users of the ecosystem that the patient user regards as his or her healthcare team or medical network, data access control by the patient user over their healthcare data, and explicit or automatic sharing of the patient user's healthcare data with other users based on associations or membership to the patient user's healthcare team. Once a patient user has defined the one or more other users in their personal ecosystem, and once they have defined access rights, the users in the patient user's ecosystem may define the details of their interaction with respect to the patient user's ecosystem, which can include permitting the definition or setup of trigger conditions (e.g., limits or thresholds) or action types that may result in a corresponding response by the ecosystem (e.g., such as a reminder or alert). For some embodiments, users a particular ecosystem associated with a patient user may see some or all of that particular ecosystem, thereby providing those users information to optimize their particular interaction with the patient user.

Various embodiments provide for an electronic medical record and data-processing system that functions as an application for use with mobile technology. For example, some embodiments may be used on or with wireless and mobile devices to provide real-time updates of a patient user's healthcare information to whomever the patient user grants data access privileges. Some embodiments provide a system specifically designed to support a patient user-defined healthcare ecosystem accessible to both the clinical healthcare community and the non-clinical healthcare community, such as of family and friends. Such a system can facilitate the use of appropriate resources at the proper time to decrease cost of healthcare and increase quality of life for patients. For some embodiments, patient, healthcare provider, family or friend users can input medical data with respect to the patient user, and set up alerts with respect to the patient user, while the patient user can define privacy parameters for other users that are allowed to access the patient user's healthcare data. In some instances, the systems or methods described herein can encourage a patient user to comply with medical regimens (e.g., medication regimens) and can hold the patient user accountable to those who are authorized to access the patient user's healthcare data. Additionally, various embodiments provide an effective tool for communicating healthcare data to healthcare providers, family members, and friends, and while provider an effect tool for keeping records of changes in the patient user's health and wellness.

Various embodiments implement an application that provides a convenient platform for its users to input data and parameters, and share that healthcare information with others. The mobile application can serve as a method to upload, collect, transmit, receive, download, and display data in real-time. The mobile application can provide a comprehensive system for healthcare monitoring of a patient where the system is owned or at least controlled by the patient user, and where the system is not owned by or endorsed by an insurance company, a hospital, or the like. The system may be regarded as patient user- centric in its aim in improving health and wellness management. The application can provide a form of participatory medicine that active involves patient users and those users within their ecosystem. Active participation in the application by the users can increase the likelihood of improved outcomes, compliance with medication regimens, reduced medical errors, and increased satisfaction with respect to patient users.

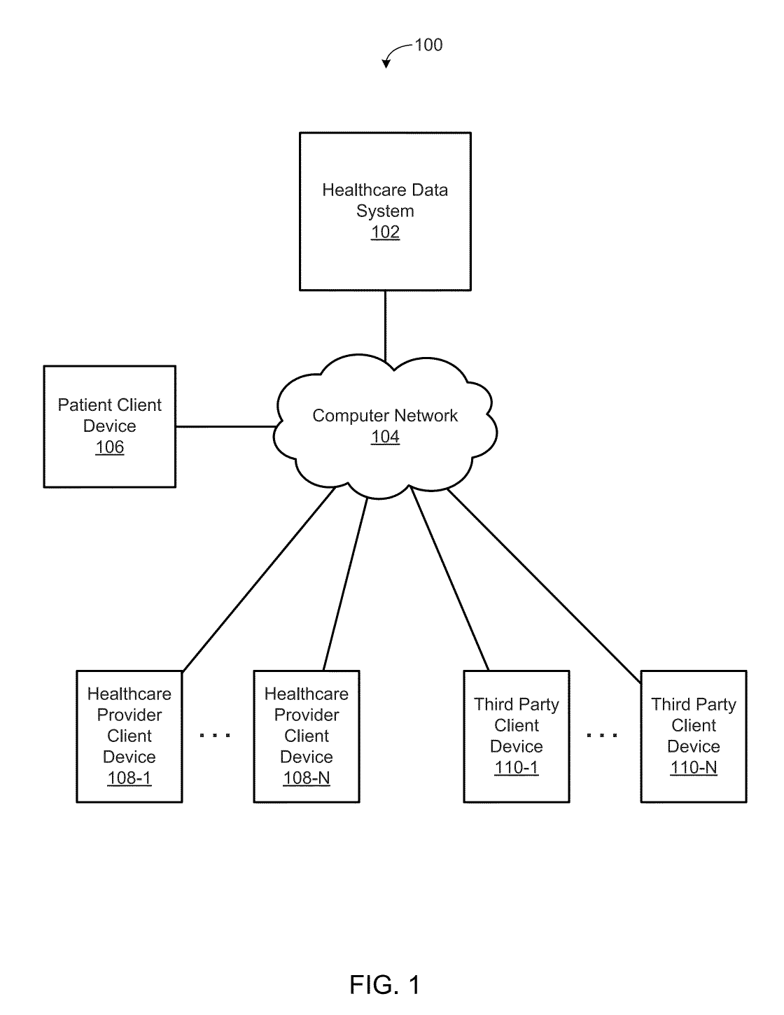

FIG. 1 is a block diagram illustrating an example network system 100 that may be used with various embodiments. As shown in FIG. 1, the example network system 100 can comprise a healthcare data system 102, a patient client device 106, healthcare provider client devices 108-1 through 108-N (hereafter collectively referred to as “healthcare provider client devices 108”), third party client devices 110-1 through 110-N (hereafter collectively referred to as “third party client devices 110”), and a computer network 104 communicatively coupling together the healthcare data system 102 each of the patient client device 106, healthcare provider client devices 108, and third party client devices 110. For illustrative purposes, the patient client device 106 will be understood to be used by a patient user to access the healthcare data system 102, each of the healthcare provider client devices 108 will be understood to be ones used by professional or non-professional healthcare provider user to access the healthcare data system 102, and each of the third party client devices 110 will be understood to ones used by friend, family, and other users to access the healthcare data system 102. It will be understood that for some embodiments, the components or the arrangement of components may differ from what is depicted in FIG. 1.

In accordance with some embodiments, the computer network 104 may be implemented or facilitated using one or more local or wide-area communications networks, such as the Internet, WiFi networks, WiMax networks, private networks, public networks, and the like. Depending on the embodiment, some or all of the communication connections with the computer network 104 may utilize encryption (e.g., Secure Sockets Layer [SSL]) to secure information being transferred between the various entities shown in the example environment 100.

The healthcare data system 102, the patient client device 106, each of the healthcare provider client devices 108, and each of the third party client devices 110 may be implemented using one or more digital devices, which may be similar to the digital devices discussed later with respect to FIG. 50. For instance, the patient client device 106 may be any form of computing device capable of executing an application, presenting a graphical user interface (GUI) through a display (e.g., a touch screen display) coupled to the computing device, and receiving user input with respect to the GUI. Through interaction with the GUI, a patient user can use the patient client device 106 to interact with the healthcare data system 102 and access one or more features offered by the healthcare data system 102 over the computer network 104.

For instance, through the computer network 104, the patient client device 106 can provide, and receive updates to the GUI presented on a touch screen display coupled to the patient client device 106. Through systems or methods described herein, a patient user at the patient client device 106 can store their healthcare data on the healthcare data system 102, and can establish on the healthcare data system 102 an association with other users on the healthcare data system 102, such as a healthcare provider user at one of the healthcare provider client devices 108, or family or friend user at one of the third party client devices 110. Using the systems or methods described herein, the patient user can control data access privileges, to the patient user's healthcare data stored on the healthcare data system 102, by those other users. The data access control may be based on the association between the patient user and those other users. The system or method described herein can also enable the healthcare data system 102 to access particular information from the patient user's healthcare data, according to the data access privileges granted by the other users, and issue or schedule a notification with respect to the patient user or to the other users based on the accessed particular information.

As described herein, the healthcare data may include a note, audio, video, or an image relating to healthcare of the patient user, and the associations between the patient user and the other users can include a family relationship, a friendship, a healthcare professional, or a healthcare non-professional. For some embodiments, the healthcare data includes a subset of data regarding an existing health condition, a biometric, personal medical history, family medical history, a diet, medication history of the patient user, currently prescribed medication regimen, or a prescription issued to the patient user. The subset of data can include, for instance, an instruction, health practitioner information, a medication identifier, a dosage, an expiration, a medication amount, a refill count, refill date, or a refill condition relating to the prescription of the patient user. For some embodiments, at least some of the healthcare data is received from the patient user through the patient client device 106, such as by way of upload of notes or multimedia. The patient client device 106 itself may be used in the capture of the healthcare data, such as when a biometric reader integrated or coupled to the patient client device 106 is used to capture biometric readings as the healthcare data.

For some embodiments, the system or method described herein provide an in-system communication transport whereby the patient user at the patient client device 106 can communicate with one or more of the users at the healthcare provider client devices 108 or the third party client devices 110 through the healthcare data system 102. The in-system communication transport may include audio, video, real-time chat, or electronic mail as mediums of communication. Through in-system communication transport, the system or method can permit a patient user at the patient client device 106 to securely transmit and deliver, to one or more of the users at the healthcare provider client devices 108 or the third party client devices 110, information selected by the patient user from the patient user's healthcare data.

As used herein, computing devices may include a mobile phone, a tablet computing device, a laptop, a desktop computer, personal digital assistant, a portable gaming unit, a wired gaming unit, a thin client, a set-top box, a portable multi-media player, or any other type of touch-enabled computing device known to those of skill in the art. Further, the healthcare data system 102 may comprise one or more servers, which may be operating on or implemented using one or more cloud-based resources (e.g., System-as-a-Service [SaaS], Platform-as-a-Service [PaaS], or Infrastructure-as-a-Service [IaaS]).

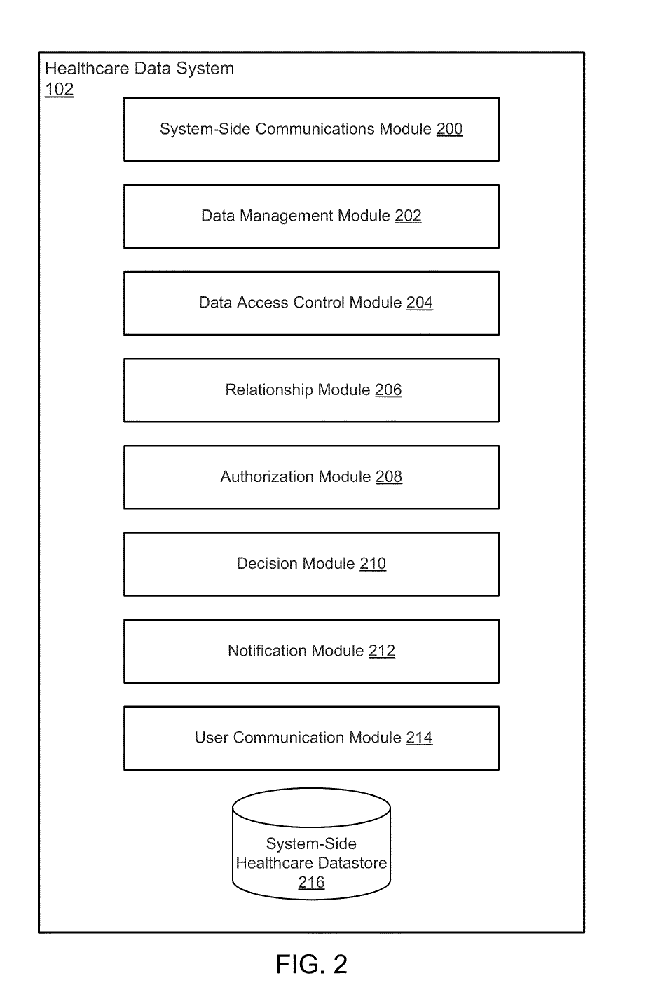

FIG. 2 is a block diagram illustrating an example healthcare data system in accordance with various embodiments. As shown in FIG. 2, the healthcare data system 102 can comprise a system-side communications module 200, a data management module 202, a data access control module 204, a relationship module 206, an authorization module 208, a decision module 210, a notification module 212, a user communication module 214, and a system-side healthcare datastore 216. It will be understood that for some embodiments, the components or the arrangement of components may differ from what is depicted in FIG. 2.

The system-side communications module 200 may be configured to facilitate data communication between the healthcare data system 102 and one or more of the patient client device 106, healthcare provider client devices 108, and third party client devices 110. For instance, as a patient user at the patient client device 106 interacts with the healthcare data system 102, data may be exchanged between the patient client device 106 and the healthcare data system 102 via the system-side communications module 200 over a computer network (e.g., the computer network 104).

The data management module 202 may be configured to manage storage and retrieval of healthcare data on the healthcare data system 102, and may do so using the system-side healthcare datastore 216. For some embodiments, the data management module 202 can receive healthcare information (e.g., from the healthcare data client 300) and store the received healthcare information on the system-side healthcare datastore 216 as healthcare data associated with a patient user. Additionally, the data management module 202 may add healthcare information to, remove healthcare information from, modify healthcare information stored on, or obtain healthcare information from the system-side healthcare datastore 216. For some embodiments, the data management module 202 facilitates access of healthcare data on the healthcare data system 102 by the various components of the healthcare data system 102. The data management module 202 can enable users of the healthcare data system 102 to upload, collect, transmit, receive, download, and display healthcare information associated with a patient user in real-time. Healthcare information managed by the data management module 202 can include, for example, text or multimedia information inputted by a user (e.g., the patient user or a healthcare provider user, a family user or a friend user), existing health conditions, medical history, family history, medication history, currently prescribed medication, prescribed medical regimen, medical, health, or wellness reports, health readings (e.g., biometrics), lifestyle, diet, medical appointments, healthcare reminders and associated settings, healthcare alerts and associated settings, and the like.

The data access control module 204 may be configured to define, modify, or otherwise facilitate control of a given user's data access privileges to another user's healthcare data. In some embodiments, the data access control module 204 controls data access privileges according to a patient user's preferences or settings with respect to the patient user's healthcare data. For instance, the patient user's preferences or settings may define data access privileges according to the type of healthcare information being access, based on the identity of the user accessing the patient's healthcare data, based on the association between the accessing user and the patient user, based on whether the accessing users is a member of the patient user's healthcare team or medical network, or some combination thereof. The data access control imposed by the data access control module 204 can determine whether a user can add, remove, modify, or view information with respect to the patient user's healthcare data. In doing so, the data access control module 204 can limit a user's from adding, removing, modifying, or reviewing healthcare information associated with the patient user, such as text or multimedia information inputted by a user (e.g., the patient user or a healthcare provider user, a family user or a friend user), existing health conditions, medical history, family history, medication history, currently prescribed medication, prescribed medical regimen, medical, health, or wellness reports, health readings (e.g., biometrics), lifestyle, diet, medical appointments, healthcare reminders and associated settings, healthcare alerts and associated settings, and the like. Depending on the embodiment, the patient user's preferences or settings that govern data access control by the data access control module 204 may be modified by the patient user or other users to whom the patient user has granted such rights. For some embodiments, the data access control module 204 can enable a patient user to define data access control settings according to a group of users or according to individual users. For example, a patient user may define the data access control such that like their profile on the healthcare data system 102 remains private or visible to others users on the healthcare data system 102.

The relationship module 206 may be configured to add, remove, modify, or otherwise facilitate an association between two or more users on the healthcare data system 102. As described herein, an association can include a family relationship, a friendship, a healthcare professional, a healthcare non-professional, or the like. Depending on the embodiment, an association may be established between two users by way of one user extending a request for association (e.g., an invitation to join a patient user's healthcare group) and the other user accepting the request for association. For some embodiments, two users can have more than one association between them, such as when a patient user is associated with a healthcare provider user, and the healthcare provider is also a member of the patient user's healthcare team or medical network. As described herein, data access privileges to a first user's healthcare data by a second user may be determined, at least partially, based on the association between the first and second users. Additionally, the association between a first user and a second user may determine whether the healthcare data system 102 issues to the second user notifications that relate to the first user. For example, a specific notification regarding the first user may be issued to the second user if the second user is associated with the first user as a healthcare provider, but not if the second user is associated with the first user as merely a friend.

The authorization module 208 may be configured to facilitate the approval or denial of a request from a first user to a second user, such a request from a family user to a patient user to add healthcare information in connection with the patient user. Other requests that a patient user may approve or deny may include a request by a user (e.g., a healthcare provider user) to be associated with the patient user, or a request by a user (e.g., a healthcare provider, family, or friend user) to modify data access control to the patient user's healthcare data.

The decision module 210 may be configured to access (e.g., read) information from a patient user's healthcare data, analyze the information, perform one or more actions in relation to the patient user based on the analysis and one or more decision rules that govern the operation of the decision module 210. For example, the decision module 210 can include a decision engine that can respond to changes in a patient user's healthcare information by automatically creating, scheduling, or issuing notifications regarding a patient user (e.g., alerts or reminders) based on the on parameters in the patient user's preferences or settings. Additionally, the decision module 210 may create, schedule, or issue such notifications for the patient user, or for another user based on the other user's association with the patient user. For some embodiments, rules are defined according to one or more triggers or conditions, which when satisfied may cause the decision module 210 to perform one or more actions defined by the rule. For instance, a rule may perform a particular action (e.g., cause an alert to issue) when healthcare data for a patient indicates a blood glucose level that is above value X and a pulse that is below a value Y. Depending on the embodiment, a trigger or a condition of a rule may relate to a rate of change (e.g., patient's weight has increased by 5 pounds in 3 days). When performing an action, the decision module 210 may perform the action with respect to itself or cause one or more other components (e.g. modules) of the healthcare data system 102 to perform the action.

For example, where a patient user has missed a medication dosage or enters a health reading outside a prescribed range, the decision module 210 may detect such information in the patient's healthcare data stored on the healthcare data system 102, and the decision module 210 may issue an alert or schedule a reminder accordingly. In the case of a missed medication dosage, the decision module 210 may schedule a reminder for the patient user to take the medication dosage, may log the missed medication dosage (e.g., in the patient user's medication log), or alert a healthcare provider user, associated with the patient user (e.g., on their healthcare team), that the patient user has missed a medication dosage. In the case of a health reading outside a prescribed range, the decision module 210 may issue an alert to both the patient user and an associated healthcare provider user, and query the patient user as to whether they would need healthcare assistance or would like to schedule a medical appointment.

The notification module 212 may be configured to create, issue, schedule, deliver, or otherwise facilitate notifications to users on the healthcare data system 102. For some embodiments, the notification module 212 is responsible for issuing alerts regarding missed medication dosages, out of range health readings, or missed medical appointments. Additionally, for some embodiments, the notification module 212 is responsible for scheduling reminders with regard to medical appointments, medication dosages, prescription refill, prescription expiration, tasks associated with a medical regimen, health readings, and the like. The notification module 212 may utilize a push mechanism, pull mechanism, or a combination of both to facilitate notifications in the healthcare data system 102. Depending on the embodiment, the notification module 212 may deliver notification via in-system notification system, an in-system communication system used between users, or an external communication medium, such as e-mail, text messaging, Skype®, social networking, automatic voice call (e.g., IVR), and the like.

The user communication module 214 may be configured to facilitate in-system communication between two or more users of the healthcare data system 102. In some embodiments, the user communication module 214 helps implement a secure and confidential communication medium between two or more users of the healthcare data system 102, which can include voice (e.g., phone call or voice chat), chat, messages, and exchange of healthcare information, which may be textual or multimedia in form. For some embodiments, the user communication module 214 may assist in implementing a virtual message “wall” in connection with a user (e.g., patient user) on which other users (e.g., that are included in their ecosystem) can post comments or communicate with the user.

Through the in-system communication, the user communication module 214 can enable healthcare information to remain securely confined within the healthcare data system 102 without need or use of an external communication system.

The system-side healthcare datastore 216 may be configured to implement or facilitate data storage with respect to various components of the healthcare data system 102, including data storage of healthcare information received in connection with one or more users of the healthcare data system 102. Depending on the embodiment, the system-side healthcare datastore 216 may be implemented by a database or the like. Those skilled in the art will appreciate that various actions performed by the healthcare data system 102 on healthcare information (e.g., receiving, providing, exchanging, sharing, and storing) may be performed in compliance with one or more government regulations (e.g., state or federal), such as those enumerated by HIPAA and the like.

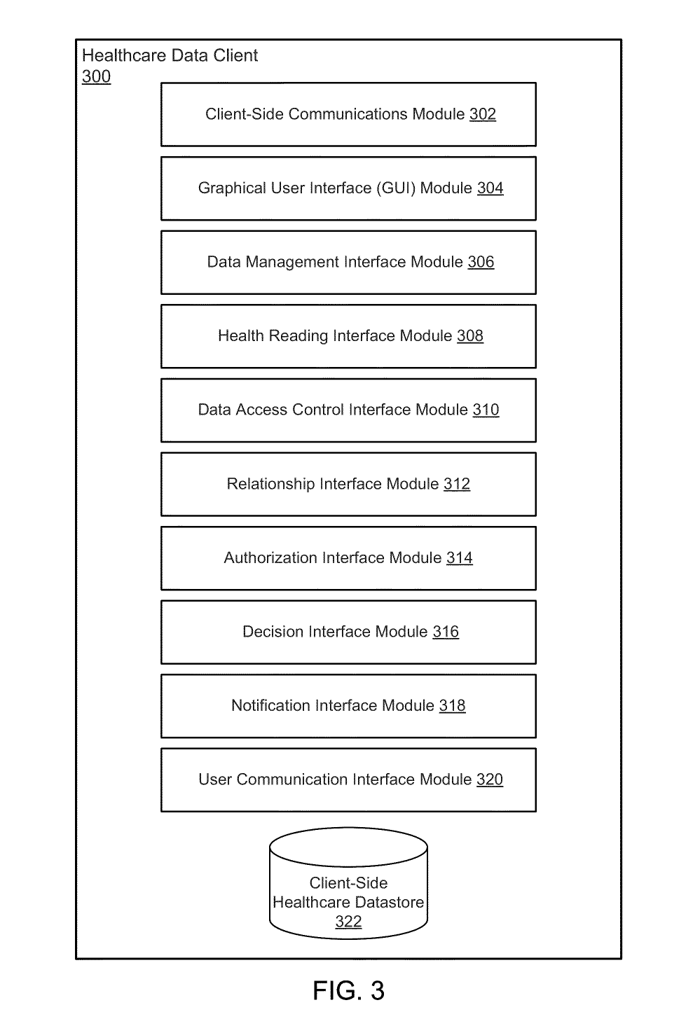

FIG. 3 is a block diagram illustrating an example healthcare data client 300 in accordance with various embodiments. For some embodiments, the healthcare data client 300 is included by a client device to facilitate access to, and user interaction with, one or more features of the healthcare data system 102. For instance, one or more of the patient client device 106, the healthcare provider client devices 108, and the third party client devices 110 can include the healthcare data client 300 in order to facilitate access and interaction between their respective users and the healthcare data system 102. Depending on the embodiment, the healthcare data client 300 may be implemented as a module that can be included by, or coupled to, the client device. For example, the healthcare data client 300 may be implemented as a software application that can operate on a client device. As shown in FIG. 3, healthcare data client 300 can comprise a client-side communications module 302, a graphical user interface (GUI) module 304, a data management interface module 306, a health reading interface module 308, a data access control interface module 310, a relationship interface module 312, an authorization interface module 314, a decision interface module 316, a notification interface module 318, a user communication interface module 320, and a client-side healthcare datastore 322. It will be understood that for some embodiments, the components or the arrangement of components may differ from what is depicted in FIG. 3.

The client-side communications module 302 may be configured to facilitate data communication between the healthcare data client 300, including by a client device, and a healthcare data system 102. In one example, as a healthcare provider user interacts with the healthcare data system 102 through the GUI module 304 of the healthcare data client 300, data may be exchanged between the healthcare data client 300 and the healthcare data system 102 via the client-side communications module 302 over a computer network (e.g., the computer network 104).

The GUI module 304 may be configured to facilitate the generation or presentation of various graphical user interfaces of the healthcare data client 300, which may allow the user to interact with or access features provided by the healthcare data system 102. For example, the GUI module 304 may operate in conjunction with (and therefore enable) one or more of the data management interface module 306, the health reading interface module 308, the data access control interface module 310, the relationship interface module 312, the authorization interface module 314, the decision interface module 316, the notification interface module 318, and the user communication interface module 320 to implement their respective graphical user interfaces.

In some embodiments, the data management interface module 306 is configured to implement one or more graphical user interfaces that enable a user at a client device to access features of the healthcare data system 102 relating to adding, removing, modifying, and reviewing healthcare information stored by the healthcare data system 102. The data access control interface module 310 may be configured to implement one or more graphical user interfaces that enable a user at a client device to access features of the healthcare data system 102 relating to controlling data access privileges to healthcare information, which can include the healthcare information relating to the user or relating to another user. For example, through a graphical user interface provided by the data access control interface module 310, a healthcare provider may modify data access privileges to a patient user's healthcare information by a friend user associated with the patient user.

For some embodiments, the relationship interface module 312 may be configured to implement one or more graphical user interfaces that enable a user at a client device to access features of the healthcare data system 102 relating to establishing, removing, or modifying an association between two or more users. For example, through a graphical user interface provided by the relationship interface module 312, a patient user may establish an association with one or more healthcare provider, family, or friend users on the healthcare data system 102.

The authorization interface module 314 may be configured to implement one or more graphical user interfaces that enable a user at a client device to access features of the healthcare data system 102 relating to approving or denying requests sent by other users, such as requests to establishes associations or requests to access healthcare information.

The decision interface module 316 may be configured to implement one or more graphical user interfaces that enable a user at a client device to access features of the healthcare data system 102 relating to controlling or configuring the decision rules that govern the behavior of the decision module 210 of the healthcare data system 102.

For some embodiments, the notification interface module 318 may be configured to implement one or more graphical user interfaces that enable a user at a client device to access features of the healthcare data system 102 relating to receiving, transmitting, or reviewing notifications in the healthcare data system 102. For instance, through a graphical user interface provided by the notification interface module 318, a user may receive an alert and select to review details regarding the received alert. In some embodiments, the user communication interface module 320 may be configured to implement one or more graphical user interfaces that enable a user at a client device to access features of the healthcare data system 102 relating to an in-system communication transport of the healthcare data system 102, which may permit two or more users to securely communicate and exchange information without use of an external communication medium.

The health reading interface module 308 may be configured to facilitate health reading at the healthcare data client 300, and facilitate submission of an obtained health reading to the healthcare data system 102. For some embodiments, the health reading interface module 308 facilitates health readings using a device separate from but communicatively coupled to the client device (e.g., through a wired or wireless connection) on which the healthcare data client 300 is operating. For instance, a patient user may take their health reading using a separate biometric device (or reader), such as an analog or digital thermometer, oximeter, ECG, blood glucose monitor, a blood pressure monitor, or the like, and enter biometric data from the biometric device into a graphical user interface provided by the health reading interface module 308. In another instance, after a patient user takes a health reading using a biometric device separate from the healthcare data client 300 (e.g., separate from the client device running the healthcare data client 300), the health reading interface module 308 may facilitate synchronization of the biometric data from the biometric device to the healthcare data client 300. Such synchronization between the biometric device and the healthcare data client 300 may be facilitated over wireless communication, such as over an 802.11x wireless network or Bluetooth®, or over wired communication, such as through a universal serial bus (USB) connection or Ethernet port. Health readings received via the health reading interface module 308 can be stored locally (e.g., on the client-side healthcare datastore 322), communicated to the healthcare data system 102 as healthcare information, or both.

The client-side healthcare datastore 322 may be configured to may be configured to implement or facilitate data storage with respect to various components of the healthcare data client 300, including data storage of healthcare information received at the healthcare data client 300 in connection with one or more users accessing the healthcare data system 102 using the healthcare data client 300. Depending on the embodiment, the client-side healthcare datastore 322 may be implemented by a database or the like. For some embodiments, the client-side healthcare datastore 322 enables a user at the healthcare data client to work offline. For instance, where the healthcare data client 300 received data from the healthcare data system 102 (e.g., in the course of a user interacting with the healthcare data system 102), the client-side healthcare datastore 322 store the received information locally such that a user at the healthcare data system 102 can continue to access the received data even in the event that the healthcare data client 300 is unable to subsequently communicate with the healthcare data system 102. As another example, in the event that the healthcare data client 300 is unable to communicate with the healthcare data system 102, data received from a user (e.g., health reading entered) at the healthcare data client 300 can be locally stored at the client-side healthcare datastore 322 and later synchronized with the healthcare data system 102 once communication is resumes.

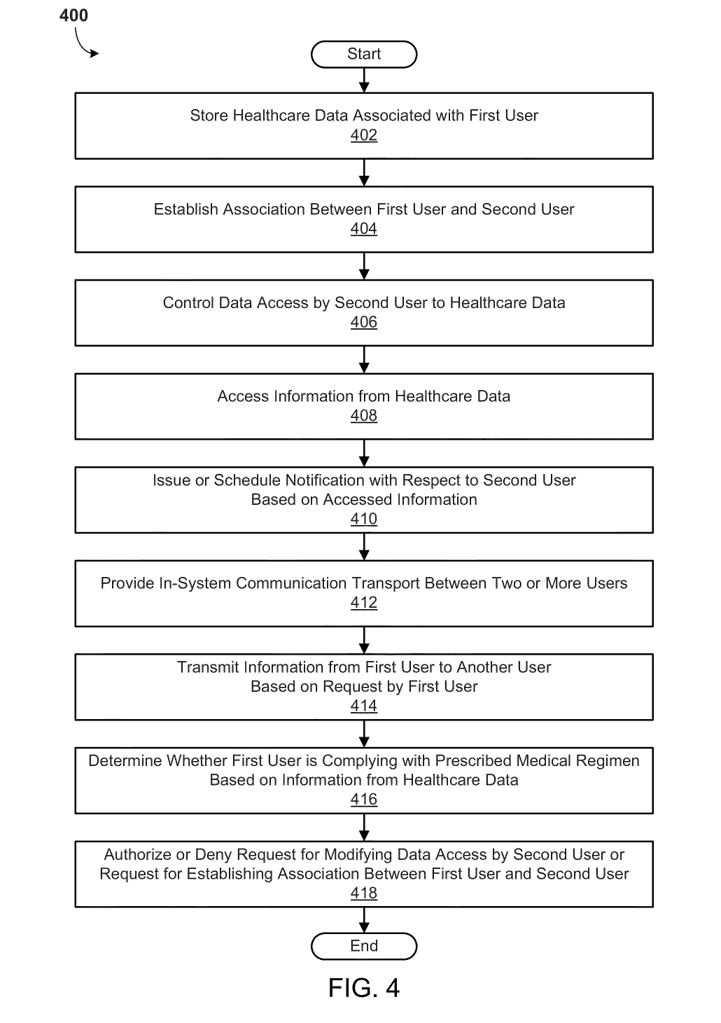

FIG. 4 is a flowchart illustrating an example method 400 for managing healthcare data for a user in accordance with various embodiments. As described below, for some embodiments, the method 400 may perform operations in connection with the healthcare data system 102.

The method 400 may start at operation 402, with the data management module 202 storing healthcare data, associated with a first user, on the system-side healthcare datastore. At operation 404, the relationship module 206 can establish an association, such as a relationship, between the first user and a second user. At operation 406, the data access control module 204 can control or otherwise define data access privileges of the second user to the healthcare data associated with the first user. At operation 408, the decision module 210 can access information from the healthcare data associated with the first user. At operation 410, the decision module 210 can cause the notification module 212 to issue, or schedule a notification to be issued by the notification module 212, based on the information accessed from the healthcare data associated with the first user.

At operation 412, the user communication module 214 may provide in-system communication transport that facilitates communication between two or more users, such as between the first user and the second user. At operation 414, the user communication module 214 can transmit information from the first user to another user based on a requested by the first user.

At operation 416, the decision module 210 can determine, based on information from the healthcare data associated with the first user, whether the first user is complying with a prescribed medical regimen.

At operation 418, the authorization module 208 can authorize or deny requests for modifying data access privileges of the second user, or request establishing the association between the first user and the second user.

Though the operations of the above method may be depicted and described in a certain order, those skilled in the art will appreciate that the order in which the operations are performed may vary between embodiments, including performing certain operations in parallel. Additionally, those skilled in the art will appreciate that the components described above with respect to the method 400 of the flowchart are merely examples of components that may be used with the method, and for some embodiments other components may also be utilized in some embodiments.

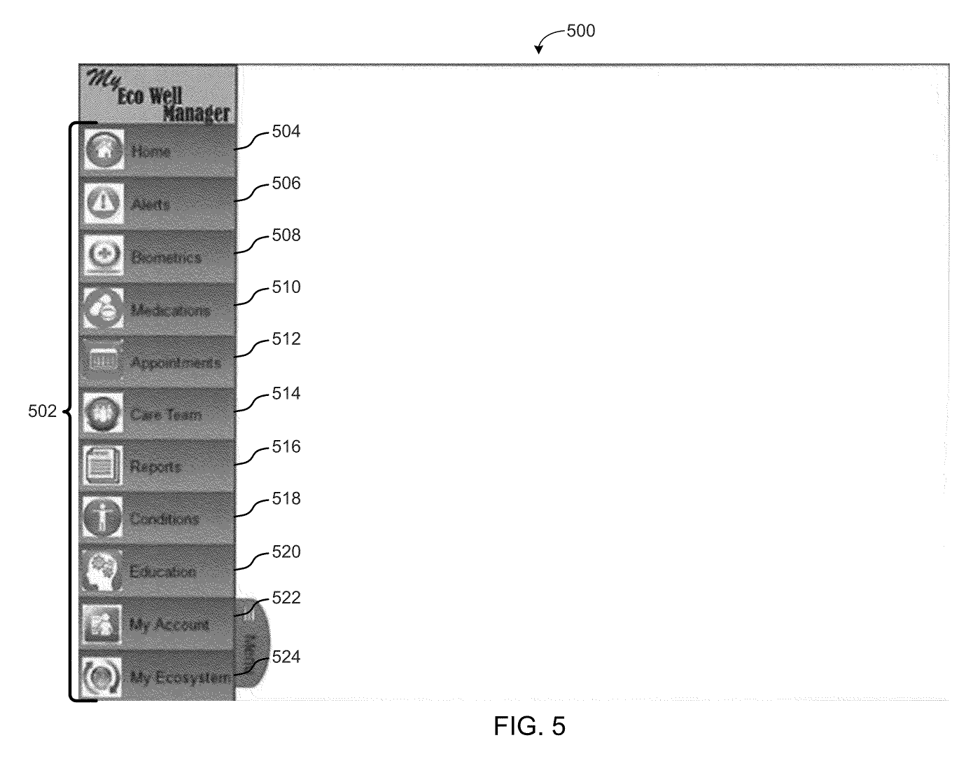

FIGS. 5-22 present screenshots of various graphical user interfaces that may be implemented by various embodiments, and that may be utilized by a user (e.g., patient user, family user, healthcare provider user, etc.) to interact with a system, such as the healthcare data system 102, through a client, such as the healthcare data client 300. Those skilled in the art will appreciate that various embodiments may include more, less, or different graphical user interfaces than those depicted in FIGS. 5-22.

FIG. 5 is a screenshot of an example graphical user interface 500 for a healthcare data system in accordance with various embodiments. As shown in FIG. 5, the graphical user interface 500 includes graphical user interface features 502 that can facilitate a user's interaction with a healthcare data system in accordance with an embodiment. For example, the graphical user interface 500 may enable a user to access one or more graphical user interfaces provided through the healthcare data system 102, such as graphical user interfaces relating to healthcare data management on the healthcare data system 102, healthcare readings on the healthcare data system 102, data access control on the healthcare data system 102, relationships between users on the healthcare data system 102, authorizations on the healthcare data system 102, medical regimen compliance on the healthcare data system 102, decisions on the healthcare data system 102, notifications on the healthcare data system 102, or communication between users on the healthcare data system 102. For some embodiments, the graphical user interface 500 is provided by the GUI module 304.

As depicted in FIG. 5, the graphical user interface features 502 can include a feature 504 to access home page, through which a user may access one or more features on the healthcare data system 102 that specifically relate to the user. The graphical user interface features 502 can include a feature 506 that permits a user to access alerts, reminders, or notifications on the healthcare data system 102, which may relate to the user or another user on the healthcare data system 102. The graphical user interface features 502 can include a feature 508 providing a user with access to biometric-related information or features of the healthcare data system 102, such as a feature that permitted a user to take taking their biometric reading. The graphical user interface features 502 can include a feature 510 allowing a user to access medication-related information or features provided by the healthcare data system 102. The graphical user interface features 502 can include a feature 512 that allows a user to access information regarding medical appointments known or maintained by the healthcare data system 102. The graphical user interface features 502 can include a feature 514 by which a user can access information or features relating to one or more users that the user included in their healthcare team on the healthcare data system 102. The graphical user interface features 502 can include a feature 516 that allows a user to access one or more healthcare reports on the healthcare data system 102. The graphical user interface features 502 can include a feature 518 providing a user access to one or more health-related condition of a given user on the healthcare data system 102 (e.g., the user's health-related condition). The graphical user interface features 502 can include a feature 520 permitting a user access to healthcare education information or features on the healthcare data system 102, such a medical encyclopedia used by professional and non-professional healthcare providers. The graphical user interface features 502 can include a feature 522 through which a user can access information and features relating to their user account on the healthcare data system 102, such as login information, personal information, e-mail address, and the like. The graphical user interface features 502 can include a feature 524 facilitating access to a user's personal healthcare ecosystem maintained by the healthcare data system 102. Those skilled in the art will appreciate that features included by the graphical user interface features 502 may vary between embodiments and may differ from (e.g., more or less than) those depicted in FIG. 5.

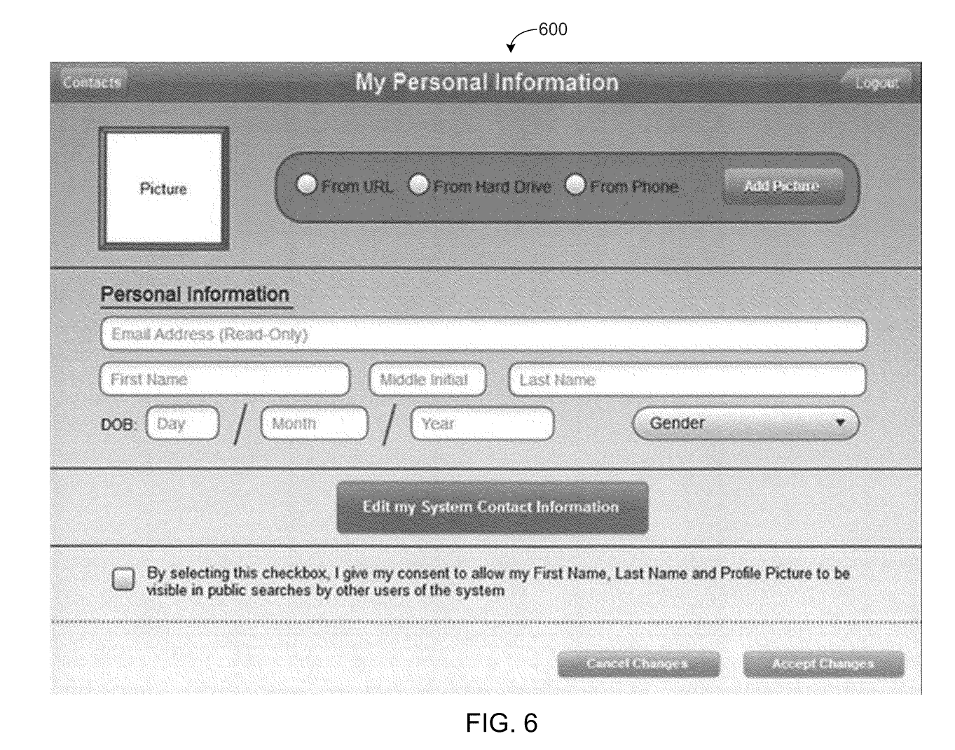

FIG. 6 is a screenshot of an example graphical user interface 600 for personal information in accordance with various embodiments. Through the graphical user interface 600, a given user on the healthcare data system 102 may add, remove, or otherwise modify their personal information maintained by the healthcare data system 102, which can include personal information included as part of a user account profile. For example, as shown in FIG. 6, the graphical user interface 600 may permit the given user to add, remove, or modify their personal picture, e-mail address, legal name, date of birth, gender, or contact information. Depending on the embodiment, the graphical user interface 600 may be presented or otherwise provided by the data management interface module 306 of the healthcare data client 300, and the features provided through the graphical user interface 600 may be implemented by the data management module 202 of the healthcare data system 102.

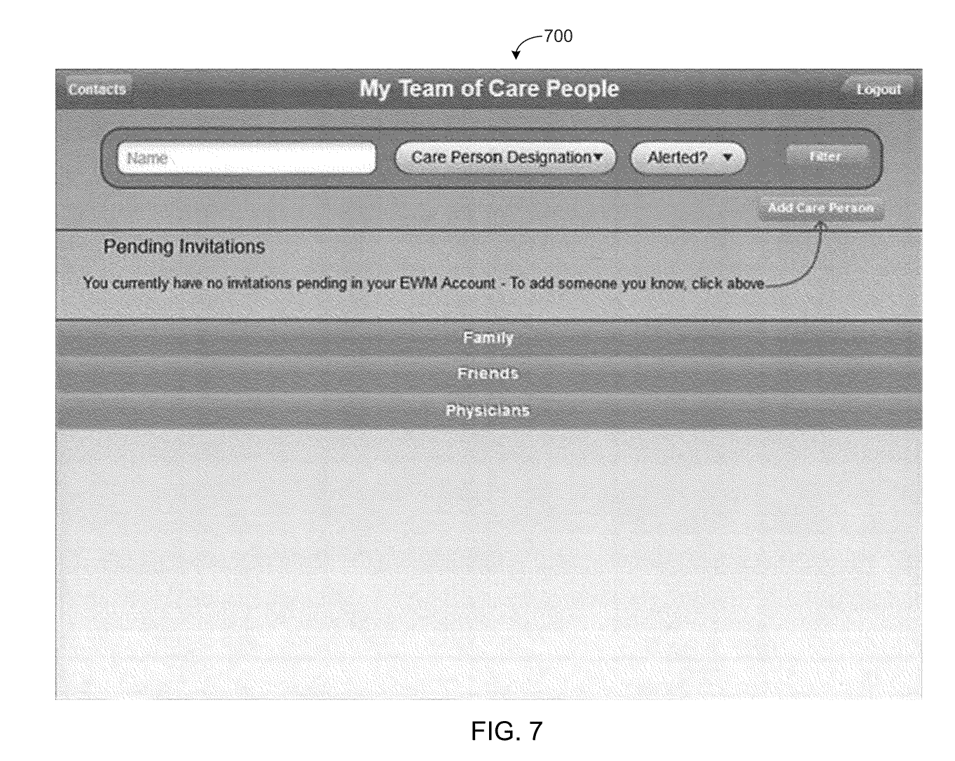

FIG. 7 is a screenshot of an example graphical user interface for relationship invitations in accordance with various embodiments. Through the graphical user interface 700, a given user on the healthcare data system 102 may add, remove, or modify their association (e.g., relationship) with another user of the healthcare data system 102 and, more particularly, may add or remove the other user from the given user's healthcare team on the healthcare data system 102. For instance, the graphical user interface 700 may permit the given user to search for, or to enter information regarding, another user on the healthcare data system 102, and add that other user to their healthcare team. The other user may be a family member, friend, a professional healthcare provider (e.g., physician or physician's assistant), or a non-professional healthcare provider (e.g., medical insurance administrator in a medical office) that may be treating or interested in monitoring the health or wellness of the given user over the healthcare data system 102. In some embodiments, the given user may also receive, from another user on the healthcare data system 102, an invitation to be added to their healthcare team. As described herein, by adding one or more users on the healthcare data system 102 to their healthcare team, the given user can grant those users with limited or unlimited data access privileges (e.g., as determined by the given user) to the given user's healthcare data on the healthcare data system 102. The data access privileges may, for instance, be limited according to the rights granted by the given user to the given user's healthcare team, and may further be limited according to the given user's particular association (e.g., relationship) with those users (e.g., family member, friend, healthcare professional). For some embodiments, the graphical user interface 700 may be provided by the relationship interface module 312 of the healthcare data client 300, and the features provided through the graphical user interface 700 may be implemented by the relationship module 206 of the healthcare data system 102.

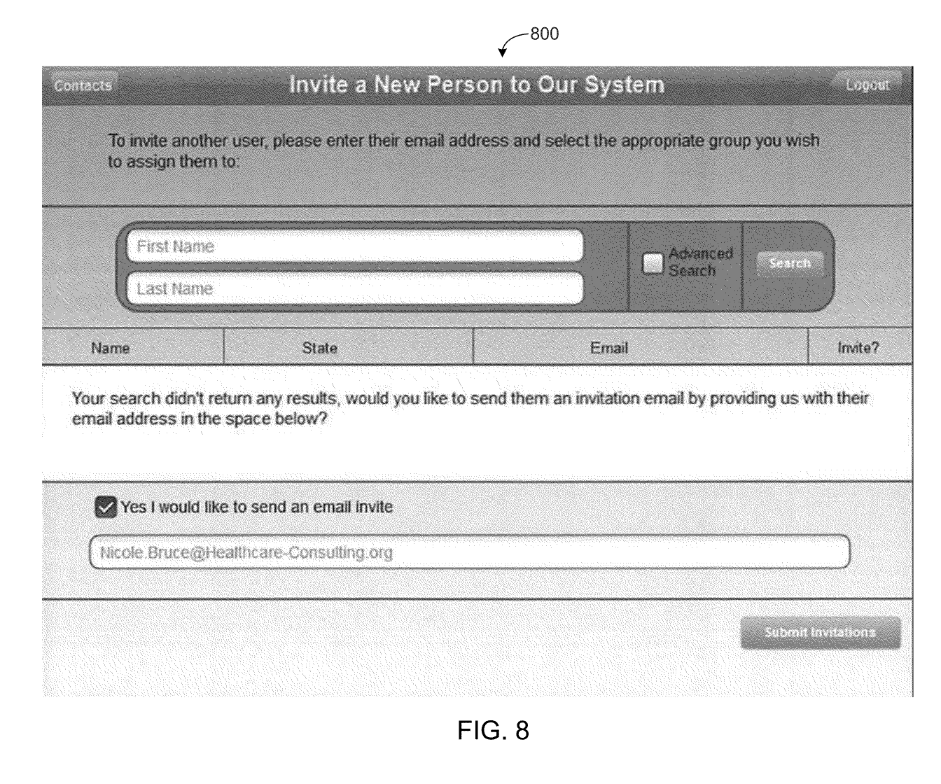

FIG. 8 is a screenshot of an example graphical user interface 800 for relationship invitations in accordance with various embodiments. Through the graphical user interface 800, a given user on the healthcare data system 102 may create, remove, or otherwise manage invitations to one or more individuals to be new users to the healthcare data system 102. Depending on the embodiment, before an invitation is sent to an individual to be a new user to the healthcare data system 102, the given user may search the healthcare data system 102 for existing users to determine whether the individual is already a user of the healthcare data system 102. The user may search for existing users by way of entering the individual's information, such as the individual's first name, last name, or e-mail address. When the given user determines that an invitation to the healthcare data system 102 should be extended to an individual, the user may do so through the healthcare data system 102 by entering the individual's e-mail address to transmit the invitation via an e-mail or by entering the individual's social network username to transmit the invitation over a social network. For some embodiments, the graphical user interface 800 may be provided by the relationship interface module 312 of the healthcare data client 300, and the features provided through the graphical user interface 700 may be implemented by the relationship module 206 of the healthcare data system 102.

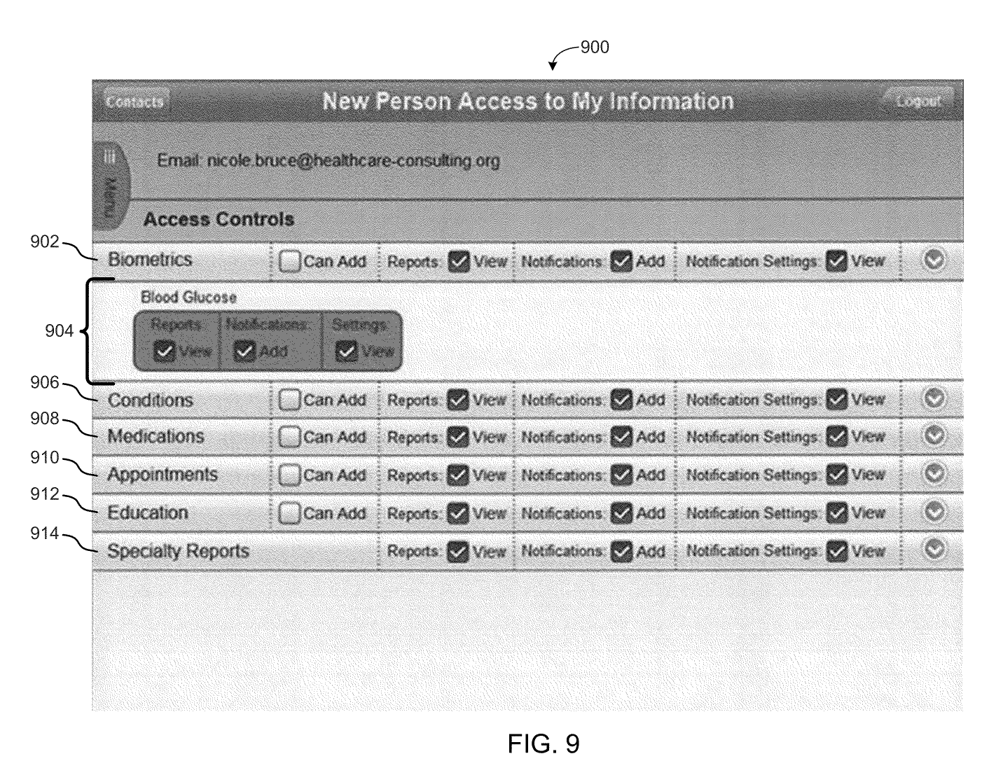

FIG. 9 is a screenshot of an example graphical user interface 900 for data access control in accordance with various embodiments. Through the graphical user interface 900, a given user on the healthcare data system 102 may control (e.g., modify) data access privileges to their healthcare data on the healthcare data system 102. Additionally, the graphical user interface 900 may enable the given user to control data access privileges with respect to a new or existing user of the healthcare data system 102. As shown in FIG. 9, the graphical user interface 900 may include a feature 902 relating to data access control over the given user's biometric information on the healthcare data system 102, a feature 906 relating to data access control over the given user's health condition information on the healthcare data system 102, a feature 908 relating to data access control over the given user's medication information on the healthcare data system 102, a feature 910 relating to data access control over the given user's medical appointment information on the healthcare data system 102, a feature 912 relating to data access control over the given user's education information on the healthcare data system 102, and a feature 914 relating to data access control over the given user's specialty healthcare reports on the healthcare data system 102.

For some embodiments, the feature 902 provides the given user the ability to grant or deny another user of the healthcare data system 102 permission to: add to the given user's biometric information on the healthcare data system 102; view the given user's biometric-related reports on the healthcare data system 102; add an alert, reminder or notification relating to the given user's biometric-related information on the healthcare data system 102; or view an alert, reminder or notification relating to the given user's biometric-related information on the healthcare data system 102. For some embodiments, one or more of the features 902, 906, 908, 910, 912, and 914 can be expanded to present the given user with granular data access control with respect particular the given user's healthcare data. For instance, as depicted in FIG. 9, the feature 902 can be expanded to present specific data access controls 904 with respect to the given user's biometric-related information, such as blood glucose levels, on the healthcare data system 102.

Through the feature 906, various embodiments permit the given user to grant or deny another user of the healthcare data system 102 permission to: add to the given user's health condition information on the healthcare data system 102; view the given user's health condition reports on the healthcare data system 102; add an alert, reminder or notification relating to the given user's health condition information on the healthcare data system 102; or view an alert, reminder or notification relating to the given user's health condition information on the healthcare data system 102. In various embodiments, the feature 908 provides the given user the ability to grant or deny another user of the healthcare data system 102 permission to: add to the given user's medication information on the healthcare data system 102; view the given user's medication-related reports on the healthcare data system 102; add an alert, reminder or notification relating to the given user's medication information on the healthcare data system 102; or view an alert, reminder or notification relating to the given user's medication information on the healthcare data system 102.

In some embodiments, the feature 910 provides the given user the ability to grant or deny another user of the healthcare data system 102 permission to: add to the given user's medical appointment information on the healthcare data system 102; view the given user's medical appointment-related reports on the healthcare data system 102; add an alert, reminder or notification relating to the given user's medical appointment information on the healthcare data system 102; or view an alert, reminder or notification relating to the given user's medical appointment information on the healthcare data system 102. The feature 912 may provide the given user the ability to grant or deny another user of the healthcare data system 102 permission to: add to the given user's healthcare education information on the healthcare data system 102; view the given user's healthcare education-related reports on the healthcare data system 102; add an alert, reminder or notification relating to the given user's healthcare education information on the healthcare data system 102; or view an alert, reminder or notification relating to the given user's healthcare education information on the healthcare data system 102. With respect to the feature 914, the given user can grant or deny another user of the healthcare data system 102 permission to: view the given user's specialty healthcare reports on the healthcare data system 102; add an alert, reminder or notification relating to the given user's specialty healthcare reports on the healthcare data system 102; or view an alert, reminder or notification relating to the given user's specialty healthcare reports on the healthcare data system 102. Those skilled in the art will appreciate that various embodiments may include features that provide data access control to more, less, or different healthcare data on the healthcare data system 102. For some embodiments, the graphical user interface 900 may be provided by the data access control interface module 310 of the healthcare data client 300, and the features provided through the graphical user interface 900 may be implemented by the data access control module 204 of the healthcare data system 102.

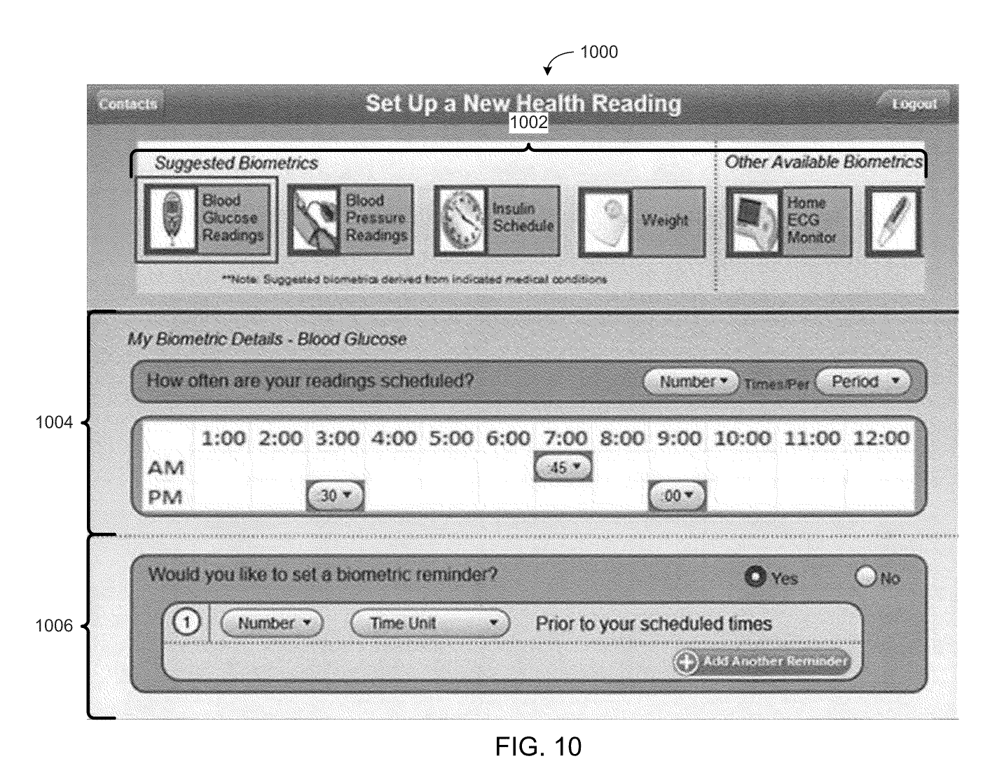

FIG. 10 is a screenshot of an example graphical user interface 1000 for health readings in accordance with various embodiments. In particular, the graphical user interface 1000 may enable, regularly schedule, or otherwise facilitate a given user on the healthcare data system 102 to take their health reading or enter their health reading to the healthcare data system 102, such as taking or entering a biometric reading. As shown in FIG. 10, the graphical user interface 1000 may include a panel 1002 to suggest one or more health readings that the given user can take or enter, and one more health readings that are available for the given user to take or enter. Examples of health readings that can be taken or entered through the graphical user interface 1000 can include blood glucose readings, blood pressure readings, insulin schedule, weight, heart activity (e.g., ECG), temperature readings, oxygen reading, and other biometric readings. Once a particular health reading is selected (e.g., blood glucose readings), the graphical user interface 1000 may include a panel 1004 by which the given user can provide details to schedule the selected health reading. The details may include entering how often the selected health readings are scheduled and when the selected health readings are scheduled. The graphical user interface 1000 can include a panel 1006 that permits the given user to set a reminder regarding the selected health readings scheduled through the panel 1004. For some embodiments, the graphical user interface 1000 may be provided by the health reading interface module 308 of the healthcare data client 300, and the data (e.g., health reading scheduling information) received through the health reading interface module 308 may be transmitted to or received from the healthcare data system 102 by way of the data management module 202.

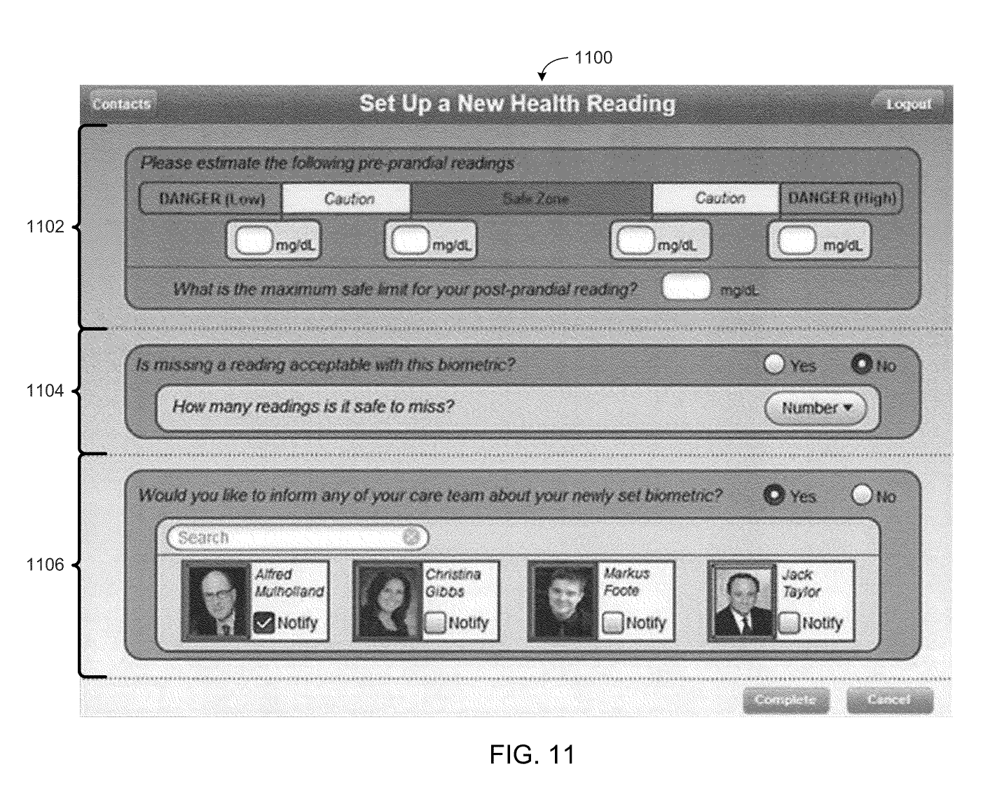

FIG. 11 is a screenshot of an example graphical user interface 1100 for health readings in accordance with various embodiments. In particular, the graphical user interface 1100 may enable, regularly schedule, or otherwise facilitate a given user on the healthcare data system 102 to take their health reading or enter their health reading to the healthcare data system 102. As shown in FIG. 11, the graphical user interface 1100 may include a panel 1102 for the given user to specify additional details regarding a selected health reading (e.g., estimate on pre-prandial readings) or a panel 1104 for the given user to specify how many of the selected health readings are acceptable or safe to miss. Additionally, the graphical user interface 1100 can include a panel 1106 for the given user to specify one or more users to which they are associated on the healthcare data system 102, such as those in their healthcare team or medical network, that would be interested in knowing about new readings or entries with respect to the selected health reading. For some embodiments, the graphical user interface 1100 may be provided by the health reading interface module 308 of the healthcare data client 300, and the data (e.g., health reading data) received or accessed through the health reading interface module 308 may be transmitted to or received from the healthcare data system 102 by way of the data management module 202.

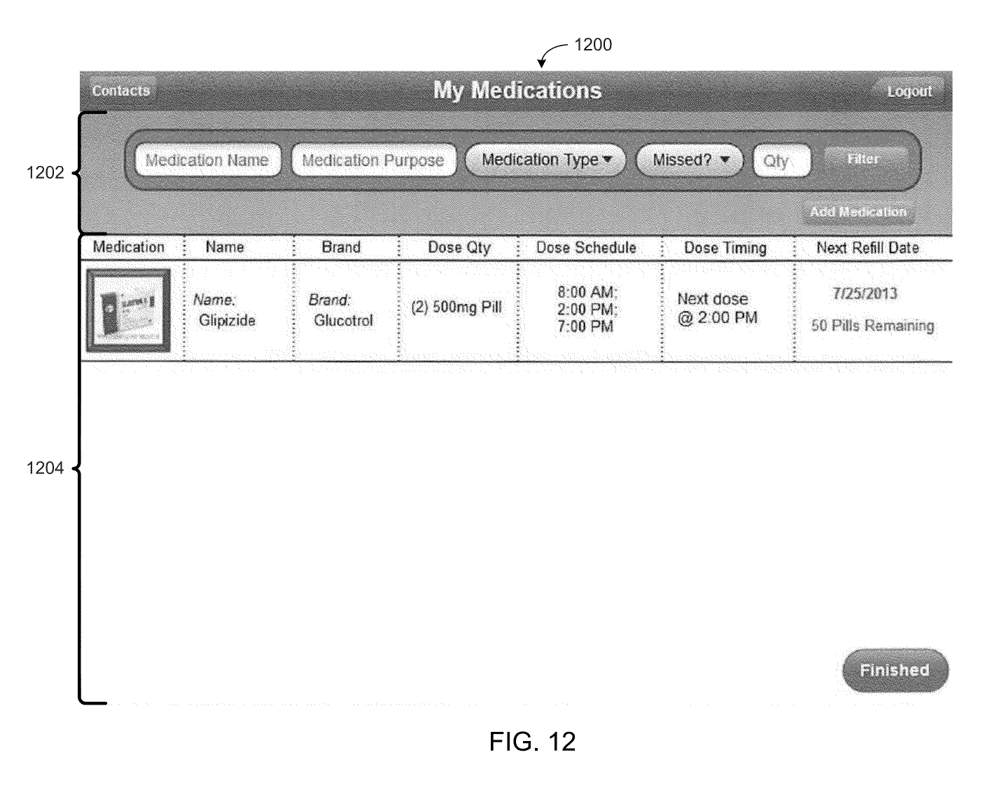

FIG. 12 is a screenshot of an example graphical user interface 1200 for medications in accordance with various embodiments. Through the graphical user interface 1200, a given user on the healthcare data system 102 may search, review, add, or remove medications (e.g., prescription or non-prescription) with respect to their medication regimen managed by the healthcare data system 102. For example, the graphical user interface 1200 may present the given user with a listing 1204 of medication currently in their medication regimen, and the medications presented in the listing 1204 may be those added to the given user's medication regimen by the given user (e.g., patient user) or by another user included in the given user's healthcare team or medical network (e.g., healthcare provider user, such as a doctor or nurse). User-defined data access privileges may determine whether a particular user of the healthcare data system 102 may be able to add, remove, or modify medications from the given user's medication regimen. As shown in FIG. 12, each medication included in the listing of 1204 of medication may indicate one or more of the name of the medication, the brand of the medication, the dose quantity, the dose schedule, the dose timing (e.g., when the next dose is), the next refill date, and the remaining quantity of medication. The graphical user interface 1200 may also include a panel 1202 that permits the given user to filter the listing of 1204 of medication according to user-specified parameters, such as medication name, purposes, type, whether a dose is missed, quantity, and the like. For some embodiments, the graphical user interface 1200 may be provided by the data management interface module 306 of the healthcare data client 300, and the features provided through the graphical user interface 1200 may be implemented by the data management interface module 306 of the healthcare data system 102.

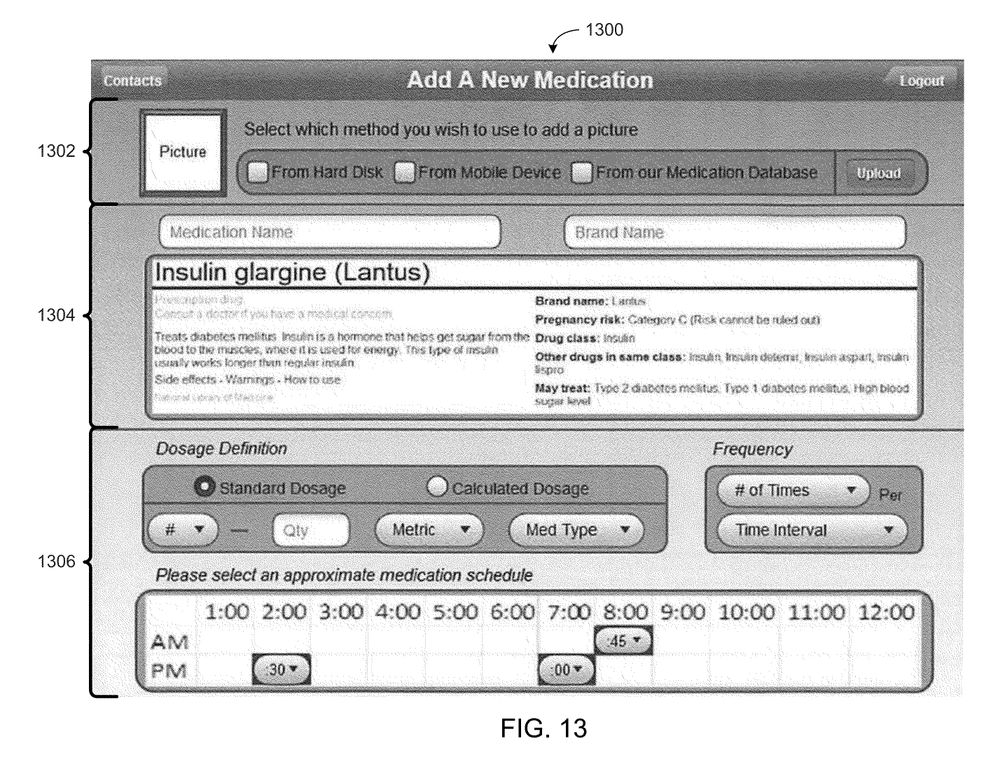

FIG. 13 is a screenshot of an example graphical user interface 1300 for medications in accordance with various embodiments. In particular, the graphical user interface 1300 may allow a given user on the healthcare data system 102 to add new medication to their medication regimen managed by the healthcare data system 102. As shown in FIG. 13, the graphical user interface 1300 may include a panel 1302 by which the given user can add (e.g., upload) an image associated with medication being added to the given user's medical regimen. The graphical user interface 1300 may include a panel 1304 by which the given user can add details regarding the medication, such as medication name and brand name. Based on the details the given user adds regarding the medication, the panel 1304 may present detailed information regarding that medication including, but not limited to, what type of medication it is (e.g., prescription drug or not), provide a general description of the medication's use, side effects of the medication, warnings associated with the medication, how the medication can be used, drug class, pregnancy risk, other drugs in the same class, and what ailments the medication treats. The graphical user interface 1300 may also include a panel 1304 through which the given user can enter details regarding medication dosage or scheduling. As depicted in FIG. 13, the panel 1304 may permit the given user to define a standard dosage or a calculated dosage, define the dosage frequency (e.g., times per a day), or define a medication schedule based on time, date or both. For some embodiments, the graphical user interface 1300 may be provided by the data management interface module 306 of the healthcare data client 300, and the features provided through the graphical user interface 1300 may be implemented by the data management interface module 306 of the healthcare data system 102.

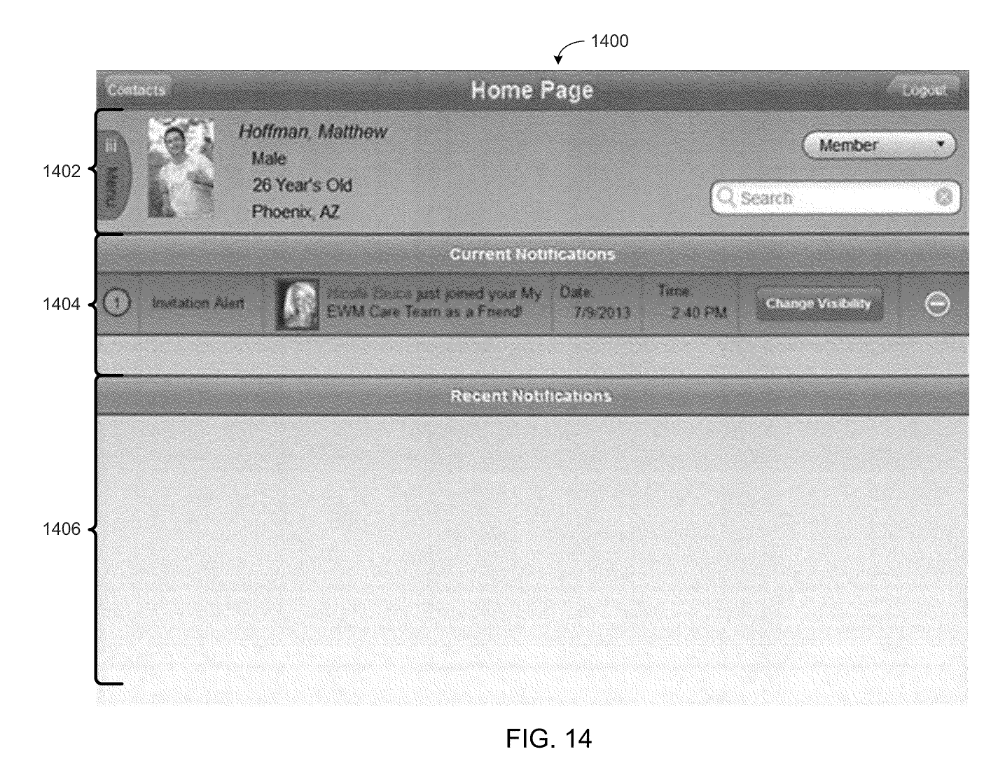

FIG. 14 is a screenshot of an example graphical user interface 1400 for a user home page in accordance with various embodiments. The user home page provided by the graphical user interface 1400 can present and summarize the most recent healthcare information, alerts, and notifications on the healthcare data system 102 that are relevant to a given user on the healthcare data system 102. As depicted in FIG. 14, the graphical user interface 1400 can include a panel 1402 that presents the given user's personal information and providing access to general menus of the healthcare data system 102. The graphical user interface 1400 can include a panel 1404 for current notifications (e.g., alerts or reminders) that await the given user's attention or consideration, and can include a panel 1406 for recent notifications reviewed by the given user. In FIG. 14, the panel 1404 depicts a current notification regarding an invitation alert, whereby another user of the healthcare data system 102 is requesting to be invited to (e.g., join) the given user's healthcare team. Through the panel 1404, the given user may accept or deny the invitation from the requesting user and when accepting the invitation, may further adjust the requesting user's data access control (e.g., visibility of) the given's user healthcare data. For some embodiments, the graphical user interface 1400 may be provided by the user communication interface module 320 of the healthcare data client 300, and the features provided through the graphical user interface 1400 may be implemented by the user communication module 214 of the healthcare data system 102.

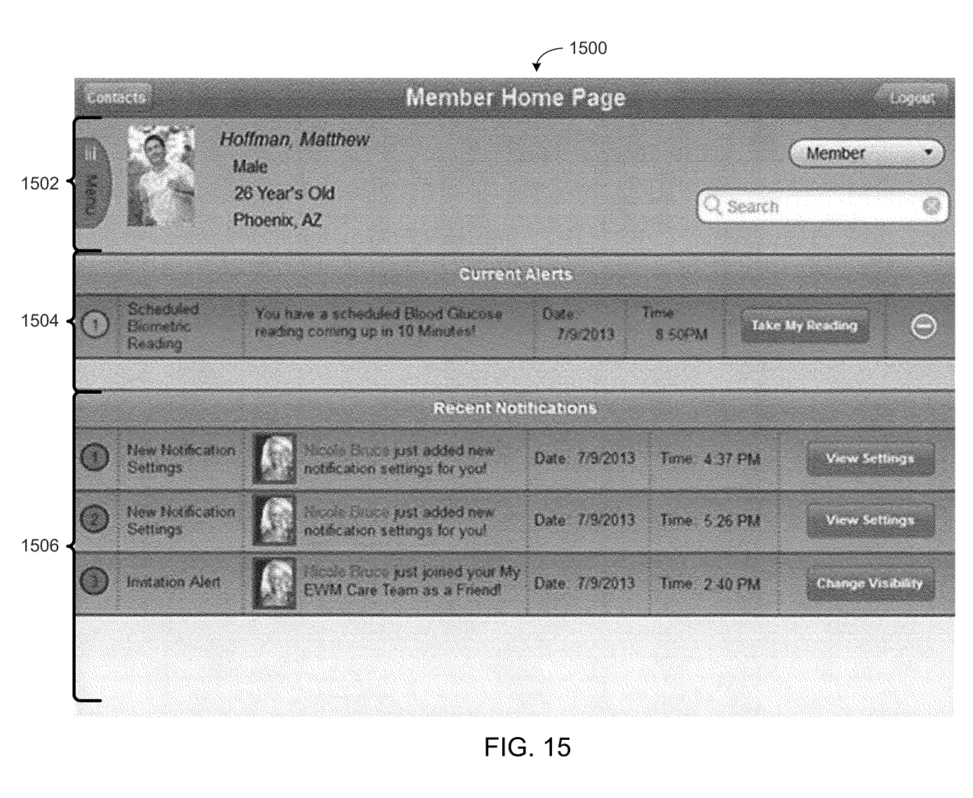

FIG. 15 is a screenshot of an example graphical user interface 1500 for a user home page in accordance with various embodiments. The user home page provided by the graphical user interface 1500 can present and summarize the most recent healthcare information, alerts, and notifications on the healthcare data system 102 that are relevant to a given user on the healthcare data system 102. As shown in FIG. 15, the graphical user interface 1500 can include a panel 1502 for the given user's personal information, a panel 1504 for current notifications (e.g., alerts or reminders) that await the given user's attention or consideration, and a panel 1506 for recent notifications reviewed by the given user.

As depicted in FIG. 15, the panel 1504 can present a current alert reminding the given user that he or she has an upcoming, scheduled biometric reading. A current alert in the panel 1504 can present the given user with an option to respond to that current alert. For example, the given user may respond to the current alert by: snoozing the current alert for a set period of time (e.g., 10 minutes); removing the current alert (e.g., delete the alert from the user home page); reviewing the current alert in greater detail (e.g., open the current alert to review or adjust its settings); or to accomplish a task associated with the current alert (e.g., navigate the given user to another graphical user interface that will allow them to accomplish a task requested by the current alert). In FIG. 15, the current alert shown in the panel 1504, which reminds the given user regarding a scheduled biometric reading, presents the given user with an option to take the scheduled biometric reading and an option to remove the current alert from their user home page.

As also depicted in FIG. 15, the panel 1506 can multiple recent notifications (e.g., alerts or reminders) reviewed by the given user, such an invitation alert that another user on the healthcare data system 102 has joined the given user's healthcare team, or that another user on the healthcare data system 102 has added notification settings for the given user (e.g., healthcare provider user adds reminder for the given user to take medication on a scheduled basis). Through the panel 1506, the given user can review the details associated with a particular recent notification. For instance, where a recent notification relates to another user joining the given user's healthcare team, the given user may be presented with an option to review or adjust the visibility settings for that other user. In another example, where a recent notification relates to another user adding or adjusting a notification setting (e.g., an alert or reminder) with respect to the given user, the given user may be presented with an option to review or adjust the notification setting.

Depending on the embodiment, the graphical user interface 1400 may be provided by the user communication interface module 320 of the healthcare data client 300, and the features provided through the graphical user interface 1400 may be implemented by the user communication module 214 of the healthcare data system 102.

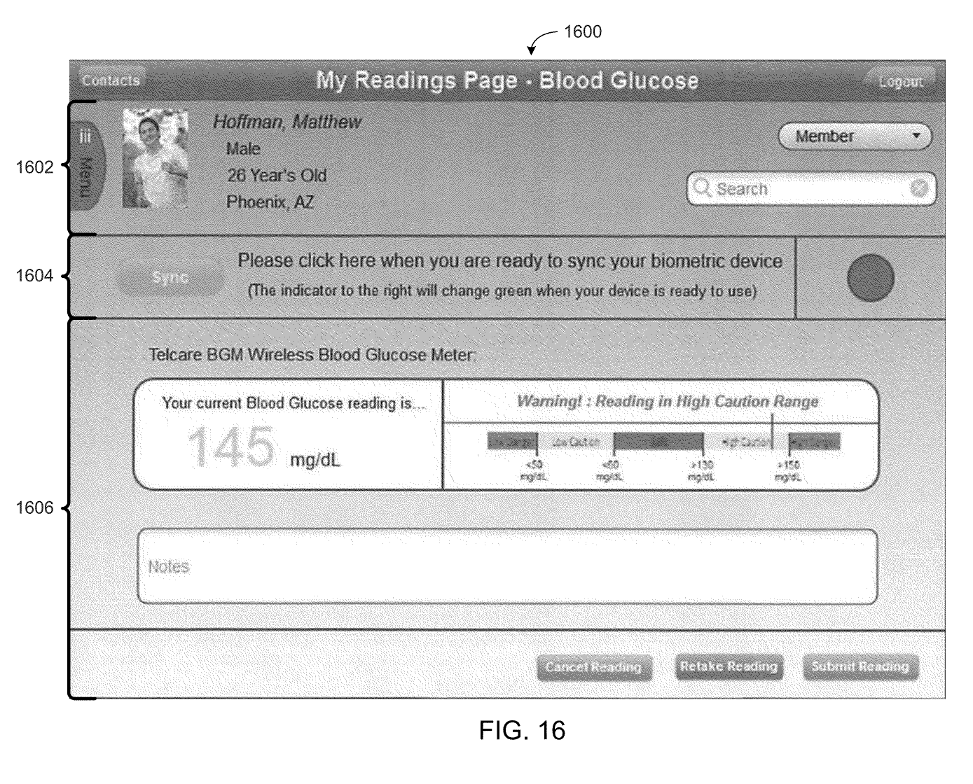

FIG. 16 is a screenshot of an example graphical user interface 1600 for a health reading in accordance with various embodiments. Through the graphical user interface 1600, a given user on the healthcare data system 102 may take or review their health reading (e.g., biometric reading) and may enter their health reading into the healthcare data system 102. As shown in FIG. 16, the graphical user interface 1600 can include a panel 1602 that presents the given user's personal information and providing access to general menus of the healthcare data system 102.

Where the given user is taking a health reading using a separate device (e.g., biometric reading device, such as a thermometer, a oximeter, or electrocardiogram) that can synchronize with the computing device through which the graphical user interface 1600 is presented (e.g., synchronize over using Bluetooth® or some other communication medium), the graphical user interface 1600 may include or otherwise enable a panel 1604 that allows the given user to initiate such synchronization. The given user may, for example, initiate such synchronization after the given user has used the separate device (e.g., Telcare® BGM Wireless Blood Glucose Meter) to obtain their biometric reading. The separate device may facilitate synchronization over a wired or wireless connection, and can include medical devices used in taking such biometric readings as blood glucose levels, blood pressure, weight, temperature, oxygen level, pulse, or heart activity (e.g., ECG) from an individual. As an alternative or substitute to synchronization, the given user may take a health reading using the computing device through which the graphical user interface 1600 is presented (e.g., healthcare data client 300 an integrated biometric reader) or, through the graphical user interface 1600 (or some other graphical user interface), the given user may manually enter a health reading provided by a separate device.

As shown in FIG. 16, the graphical user interface 1600 can also include a panel 1606 by which the given user can review a health reading recently obtained (e.g., biometric reading last obtained by synchronization through the panel 1604). Before the given user submits a given health reading to the healthcare data system 102, the panel 1606 may provide the given user with some analysis of the health reading, may permit the given user to retake the health reading, may permit the given user to cancel the current health reading, and may further permit the given user to add an associated note with respect to the health reading.

Depending on the embodiment, the graphical user interface 1600 may be provided by the health reading interface module 308 of the healthcare data client 300, and the data received or accessed through the health reading interface module 308 may be transmitted to or received from the healthcare data system 102 by way of the data management module 202.

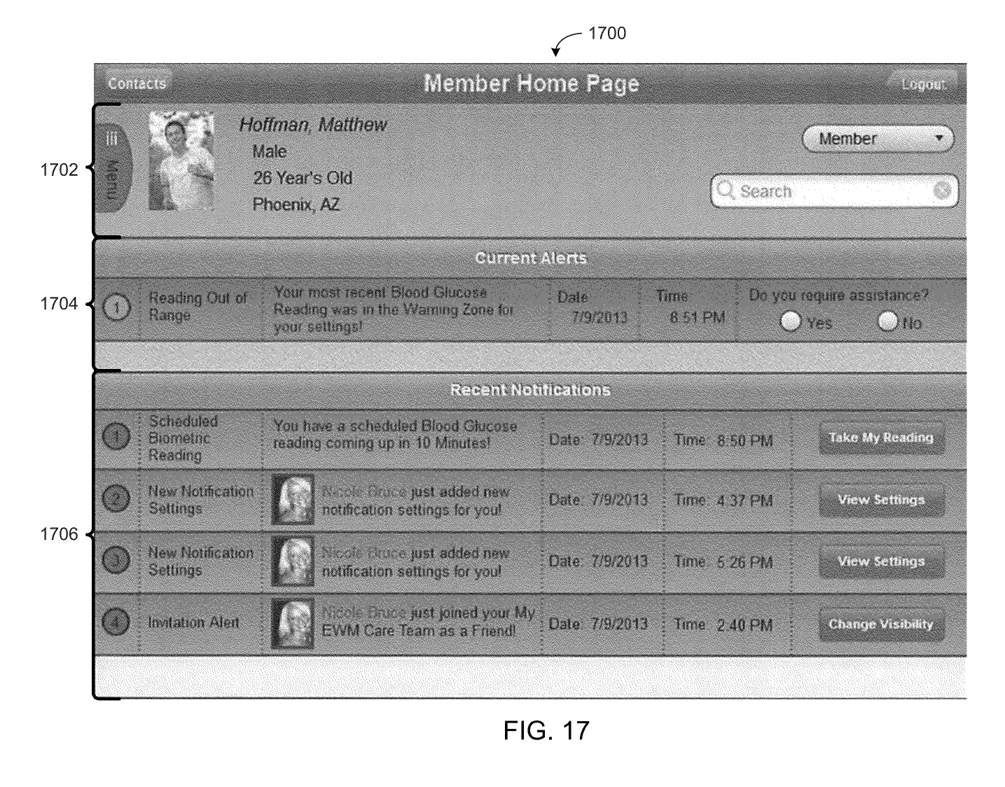

FIG. 17 is a screenshot of an example graphical user interface 1700 for a user home page in accordance with various embodiments. The user home page provided by the graphical user interface 1700 can present and summarize the most recent healthcare information, alerts, and notifications on the healthcare data system 102 that are relevant to a given user on the healthcare data system 102. As shown in FIG. 17, the graphical user interface 1700 can include a panel 1702 for the given user's personal information, a panel 1704 for current notifications (e.g., alerts or reminders) that await the given user's attention or consideration, and a panel 1706 for recent notifications reviewed by the given user.

As depicted in FIG. 17, the panel 1704 can present a current alert that warns the given user that a recent health reading (e.g., recent blood glucose level) is out of range (e.g., in warning range or danger range) based on the given user's parameters or settings, which may be define a preferred range or optimal range for the health reading (e.g., healthy blood glucose range) for the given user. The given user's parameters or settings may ones defined or adjusted by the given user or another user in the given user's healthcare team, such as healthcare provider user (e.g., the given user's physician). As described herein, the health reading can include the given user's blood glucose level, blood pressure, heart activity (e.g., ECG), and the like. A current alert that indicates a health reading warning may indicate details regarding the warning, such as the health reading value(s), how out of range the health reading is, or suggested solutions that may at least temporarily address issues relating to the health reading (e.g., take specific medication as soon as possible). When a current alert provides a health reading warning (e.g., indicates that health reading is out of range, is an anomaly, or indicates a problem), the panel 1704 may the given user with an option to responding to the current alert. Example responses to a health reading alert can include requesting medical assistance, requesting an appointment or consultation (e.g., with a health care provider), contacting another user (e.g., a health care provider user, a family user, or a friend user), retaking the health reading, snoozing the health reading alert (e.g., remind the given user in 5 minutes), and removing the health reading alert).

Depending on the embodiment, the graphical user interface 1700 may be provided by the user communication interface module 320 of the healthcare data client 300, and the features provided through the graphical user interface 1700 may be implemented by the user communication module 214 of the healthcare data system 102.

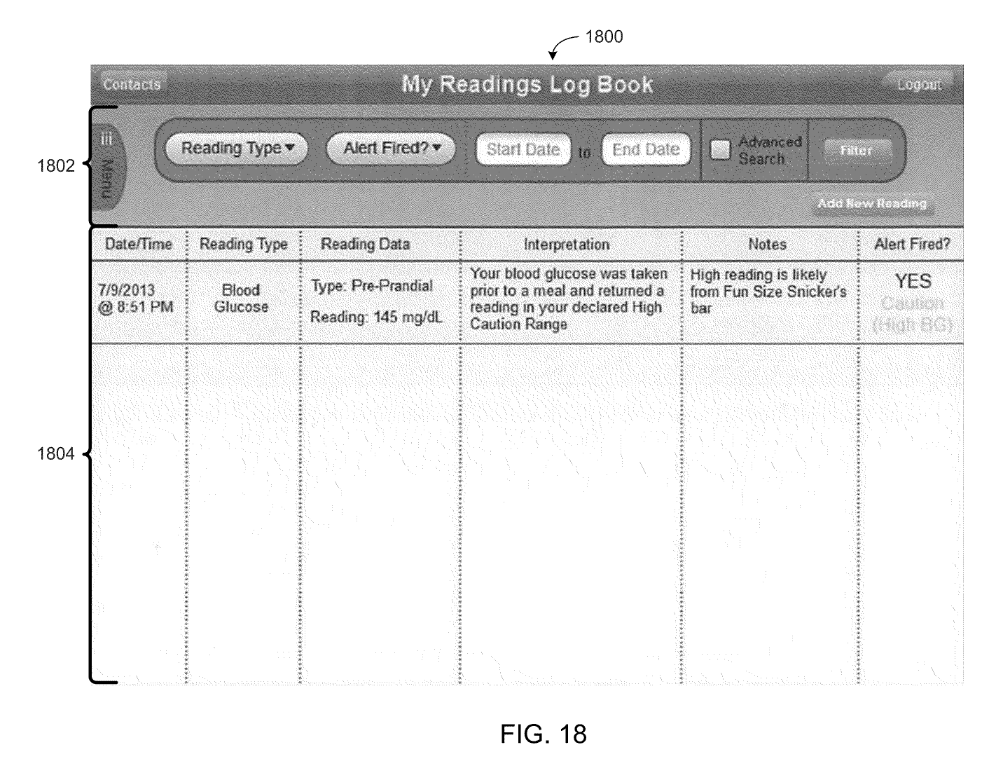

FIG. 18 is a screenshot of an example graphical user interface 1800 for health readings in accordance with various embodiments. The graphical user interface 1800 can enable a given user on the healthcare data system 102 to add their health reading, remove a past health reading, or review a past health reading. As shown in FIG. 18, the graphical user interface 1800 may present the given user with a listing 1804 (e.g., a log) of past health readings and details regarding those past health readings. For example, for each health reading listed, the listing 1804 may provide the time and date of the health reading, the type of health reading (e.g., blood pressure, blood glucose, etc.), the health reading data, an analysis or interpretation of the health reading, any notes associated with the health reading, any warnings relating to the health reading, and an indication if, when, or to whom an alert or reminder was issued to a user of the healthcare data system 102 (e.g., to the given user or a user in the given user's healthcare team). The graphical user interface 1800 may also include a panel 1802 that permits the given user to filter the listing of 1804 of past health readings according to user-specified parameters, such as health reading type, whether an alert was issued in connection with a health reading, date(s) associated with a health reading, and the like. For some embodiments, the graphical user interface 1800 may be provided by the health reading interface module 308 of the healthcare data client 300, and the data received or accessed through the health reading interface module 308 may be transmitted to or received from the healthcare data system 102 by way of the data management module 202.

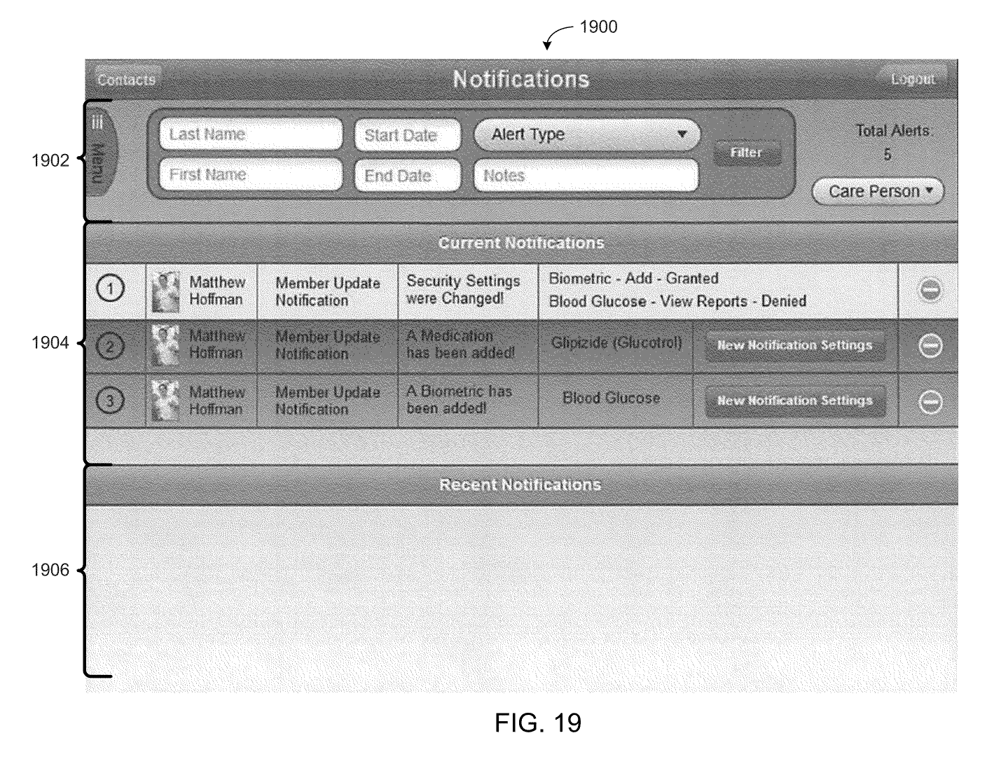

FIG. 19 is a screenshot of an example graphical user interface 1900 for notifications in accordance with various embodiments. Through the graphical user interface 1900, a given user on the healthcare data system 102 may search for, review, or respond to current or recent notifications (e.g., alerts or reminders) on the healthcare data system 102. In particular, the graphical user interface 1900 may be configured for a healthcare provider user, or another kind of user (e.g., friend or family user), to search for, review, or respond to notifications with respect to another user on the healthcare data system 102. In this way, the graphical user interface 1900 can enable the given user, such as one associated with another user's healthcare team, to effectively and efficiently monitor the health or wellness of the other user through the healthcare data system 102.

As shown in FIG. 19, the graphical user interface 1900 can include a panel 1904 for current notifications (e.g., alerts or reminders) that await a given user's attention or consideration, and a panel 1906 for recent notifications reviewed by the given user. In particular, the panel 1904 can present a first user with a notification regarding an update by a second user (e.g., patient user) that is associated with the first user (e.g., the healthcare provider user). The second user may be a patient user, the first user may be a healthcare provider, family, or friend, and the first and second user may have a corresponding association (e.g., relationship) established on the healthcare data system 102. Based on one or more of the second user's preferences, settings, and the established association, the first user may be permitted second-user-controlled data access privileges to the second user's healthcare data, which may permit the first user to monitor the health of the first user and receive notifications in regard to the second user. As depicted in FIG. 19, through the panel 1904, the first user may receive a current notification regarding such updates as a change in security or privacy settings by the second user, which may affect the first user's data access privileges to the second user's healthcare data on the healthcare data system 102. Additionally, current notifications to the first user may be regarding updates to the second user's medication regimen, or regarding the second user's health reading (e.g., the second user adds a new health reading to their healthcare data).

The graphical user interface 1900 may also include a panel 1902 that permits a given user on the healthcare data system 102 to filter the current notifications listed by the panel 1904, or recent notifications listed by the panel 1906. The given user may filter the notifications according to such user-specified parameters as last name or first name of a user associated with notifications, date of the notifications, the type of alert, notes associated with notifications, and the like. For some embodiments, the graphical user interface 1900 may be provided by the user communication interface module 320 of the healthcare data client 300, and the features provided through the graphical user interface 1900 may be implemented by the user communication module 214 of the healthcare data system 102.

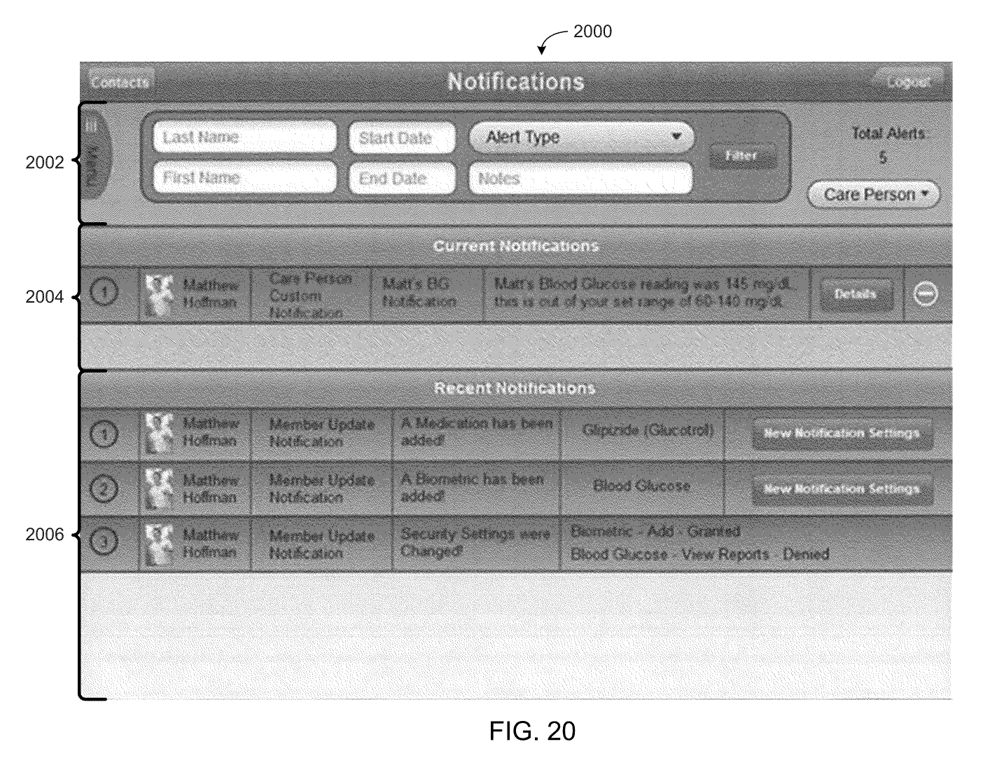

FIG. 20 is a screenshot of an example graphical user interface 2000 for notifications in accordance with various embodiments. Through the graphical user interface 2000, a given user on the healthcare data system 102 may search for, review, or respond to current or recent notifications (e.g., alerts or reminders) on the healthcare data system 102. In particular, the graphical user interface 2000 may be configured for a healthcare provider user, or another kind of user (e.g., friend or family user), to search for, review, or respond to notifications with respect to another user on the healthcare data system 102. In this way, the graphical user interface 2000 can enable the given user, such as one associated with another user's healthcare team, to effectively and efficiently monitor the health or wellness of the other user through the healthcare data system 102.

As shown in FIG. 20, the graphical user interface 2000 can include a panel 2004 for current notifications (e.g., alerts or reminders) that await a given user's attention or consideration, and a panel 2006 for recent notifications reviewed by the given user. In particular, the panel 2004 can present a first user with a notification regarding alert or warning based on a health reading relating to a second user (e.g., patient user) that is associated with the first user (e.g., the healthcare provider user). The second user may be a patient user, the first user may be a healthcare provider, family, or friend user, and the first and second user may have a corresponding association (e.g., relationship) established on the healthcare data system 102. As depicted in FIG. 20, through the panel 2004, the second user may receive a current notification regarding the first user's health reading of their blood glucose level (e.g., 145 mg/dL), and this health reading being outside the range (e.g., 60-140 mg/dL) set by the second user. From the panel 2004, the second user may respond to the current notification by reviewing additional details regarding the health reading.

The graphical user interface 2000 may also include a panel 2002 that permits the given user to filter the current notifications listed by the panel 2004, or recent notifications listed by the panel 2006. As described herein, a given user on the healthcare data system 102 may filter the notifications according to such user-specified parameters as last name or first name of a user associated with notifications, date of the notifications, the type of alert, notes associated with notifications, and the like. For some embodiments, the graphical user interface 2000 may be provided by the user communication interface module 320 of the healthcare data client 300, and the features provided through the graphical user interface 2000 may be implemented by the user communication module 214 of the healthcare data system 102.

Depending on the embodiment, the graphical user interface 1900 may be provided by the user communication interface module 320 of the healthcare data client 300, and the features provided through the graphical user interface 1900 may be implemented by the user communication module 214 of the healthcare data system 102.

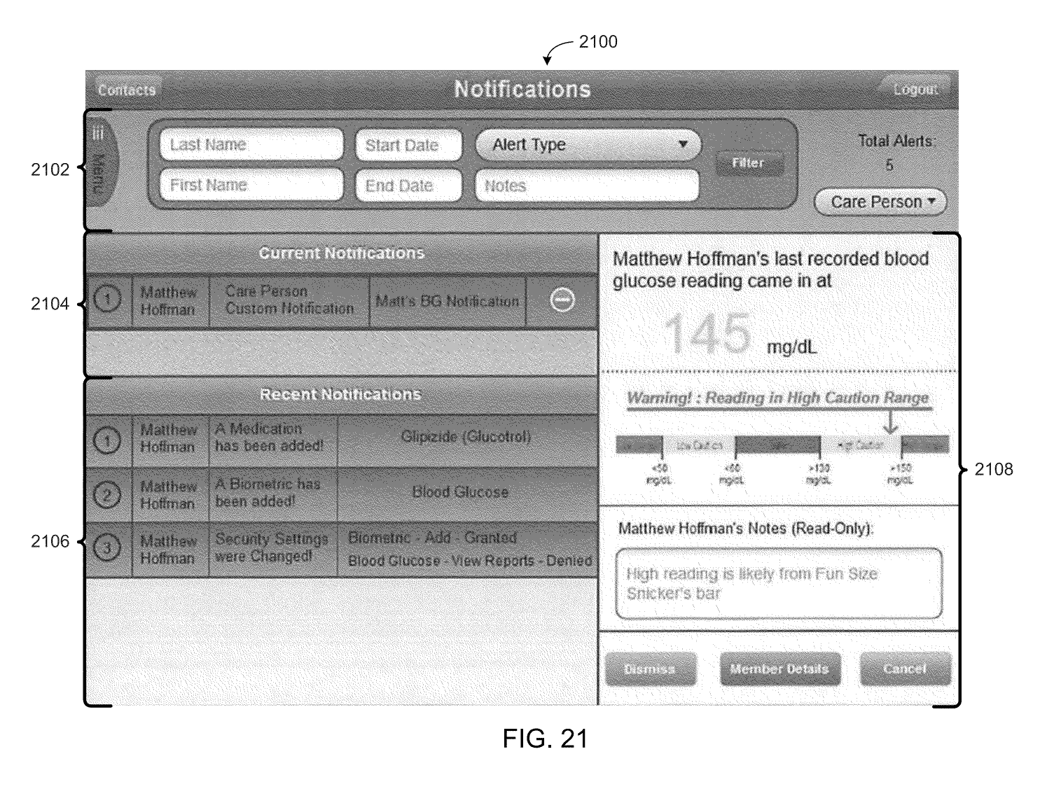

FIG. 21 is a screenshot of an example graphical user interface 2100 for notifications in accordance with various embodiments. Through the graphical user interface 2100, a given user on the healthcare data system 102 may search for, review, or respond to current or recent notifications (e.g., alerts or reminders) on the healthcare data system 102. In particular, the graphical user interface 2100 may reflect the graphical user interface 2000 of FIG. 20 once the given user selects to review the details of a current alert. As shown in FIG. 21, the graphical user interface 2100 includes a can include a panel 2104 for current notifications (e.g., alerts or reminders) that await the given user's attention or consideration, a panel 2106 for recent notifications reviewed by the given user, and a panel 2102 that permits the given user to filter the current notifications listed by the panel 2104 or recent notifications listed by the panel 2106.

As also shown in FIG. 21, the graphical user interface 21 can include a panel 2108 that allows a first user to review the details of a current notification regarding a health reading alert or warning associated with a second user on the healthcare data system 102. As part of the detail, the panel 2108 may present the first user with a graphical representation (e.g., chart) of a health reading range (e.g., defined by the first or second user) associated with the second user and may further present with respect to the graphical representation, the health reading data that resulted in the current notification. In response to the current notification regarding the health reading, the panel 2108 may permit the given user to dismiss, cancel, or forward (e.g., to another user) the current notification, and may further permit the given user to add notes to the current notification.

Depending on the embodiment, the graphical user interface 2100 may be provided by the user communication interface module 320 of the healthcare data client 300, and the features provided through the graphical user interface 2100 may be implemented by the user communication module 214 of the healthcare data system 102.

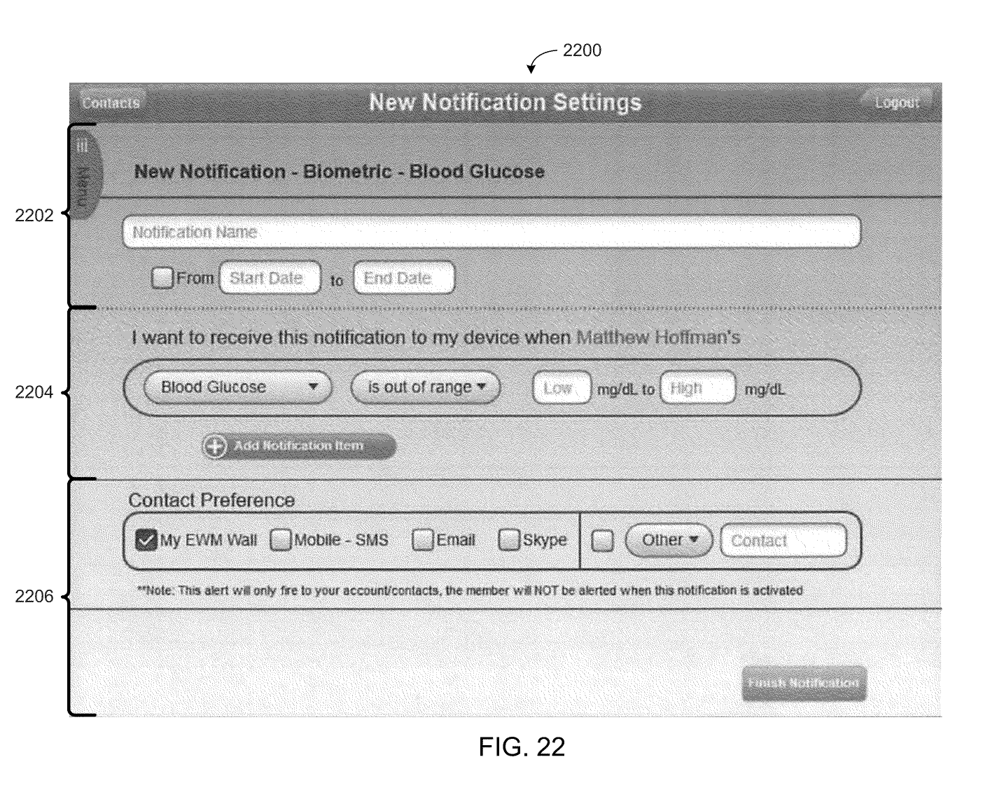

FIG. 22 is a screenshot of an example graphical user interface 2200 for notifications in accordance with various embodiments. Using the graphical user interface 2200, a given user on the healthcare data system 102 may create or adjust a new notification (e.g., alert or reminder) on the healthcare data system 102 with respect to another user to whom the given user has an established association (e.g., relationship) on the healthcare data system 102. In particular, the graphical user interface 2200 may be configured for a healthcare provider user, or another kind of user (e.g., friend or family user), to create a new notification with respect to another user's health readings, such as the other user's health readings relating to blood glucose levels.

As shown in FIG. 22, the graphical user interface 2200 can include a panel 2202 that allows a given user on the healthcare data system 102 to provide a name to the new notification or provide a date range for when the new notification will be active for the other user. The graphical user interface 2200 can include a panel 2204 that enables the given user to select one or more types of health reading to associate with the new notification, and to provide for each of the selected health reading types a range that can be associated with the new notification. Based on the range or some other condition (e.g., a single threshold) provided by the given user, the new notification can be issued to the given user, the other user, or both. The graphical user interface 2200 may further include a panel 2206 that allows the given user to select one or more modes of communication by which the new notification can be sent including, for example, an in-system communication transport (e.g., the given user's message post wall, “My EWM Wall”), text message (e.g., SMS), e-mail, Skype®, or social networking-based messaging system.

Depending on the embodiment, the graphical user interface 2200 may be provided by the user communication interface module 320 of the healthcare data client 300, and the features provided through the graphical user interface 2200 may be implemented by the user communication module 214 of the healthcare data system 102.

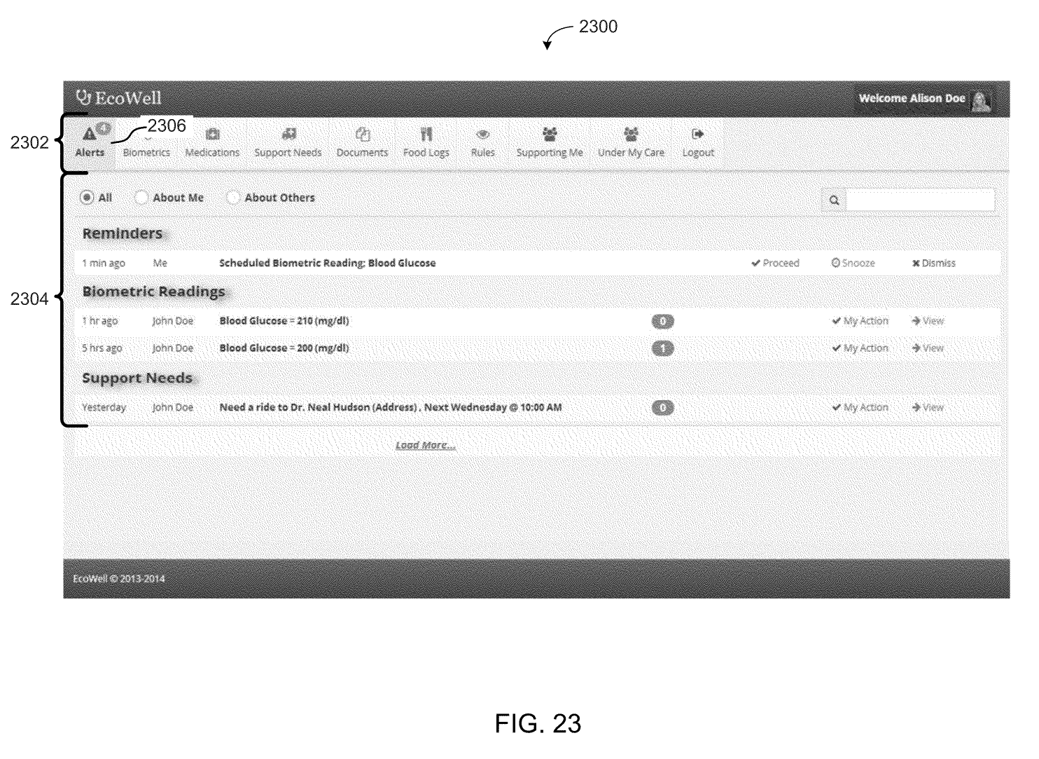

FIG. 23 is a screenshot of an example graphical user interface 2300 for notifications in accordance with some embodiments. Through the graphical user interface 2300, a given user on the healthcare data system 102 may receive, review, or respond to one or more notifications (e.g., alert or reminder) provided (e.g., generated or issued), by the healthcare data system 102, in association with the given user. As shown in FIG. 23, the graphical user interface 2300 may include a menu 2302 configured to provide the given user access to various features supported by the healthcare data system 102, such as notifications, biometrics, medications, support needs, documents, food logs, and rules. For instance, the given user may access a notifications panel 2304 by selecting a graphical element 2306 included by the menu 2302, which in turn may cause the notifications panel 2304 to be displayed by the graphical user interface 2300. Depending on the embodiment, the graphical element 2306 may indicate when a notification for the given user is pending their review or response, may indicate the urgency of the one or more notifications awaiting the given user's review or response, and may indicate the number of notifications awaiting the given user's review or response.

The notifications panel 2304 may be configured to facilitate a given user's (e.g., healthcare provider, friend, or family user's) management or review of notifications provided by the healthcare data system 102 in connection with the user or another user on the healthcare data system 102. Examples of notifications that may be accessed through the notifications panel 2304 include reminders (e.g., for medical appointments or medications), alerts regarding biometric readings (e.g., health readings that meet or exceed a threshold), a support alert (e.g., an notification to one user on the healthcare data system 102 alerting them to support another user on the healthcare data system 102), a communication between users (e.g., an in-system communication message from one user to another user), and the like.

In FIG. 23, the notifications panel 2304 provides a user with a reminder to take a biometric reading (e.g., a blood glucose reading), alerts regarding previous biometric readings (e.g., blood glucose levels that meet or exceed predetermined thresholds), alerts to support a user in need (e.g., alert that a user needs a ride to a medical appointment). With respect to one or more notifications, the notifications panel 2304 may provide when a notification has been provided (e.g., time or date when a notification issued, or how much time has elapsed since a notification issued), how many notifications have issued, whether a response has been provided with respect to a given notification, how many responses have be provided for a given notification, identification of a user associated with a notification (e.g., user for which a biometric reading notification is issued), access additional details with respect to a notification, or one or more options for responding to a notification, including taking an action with respect.

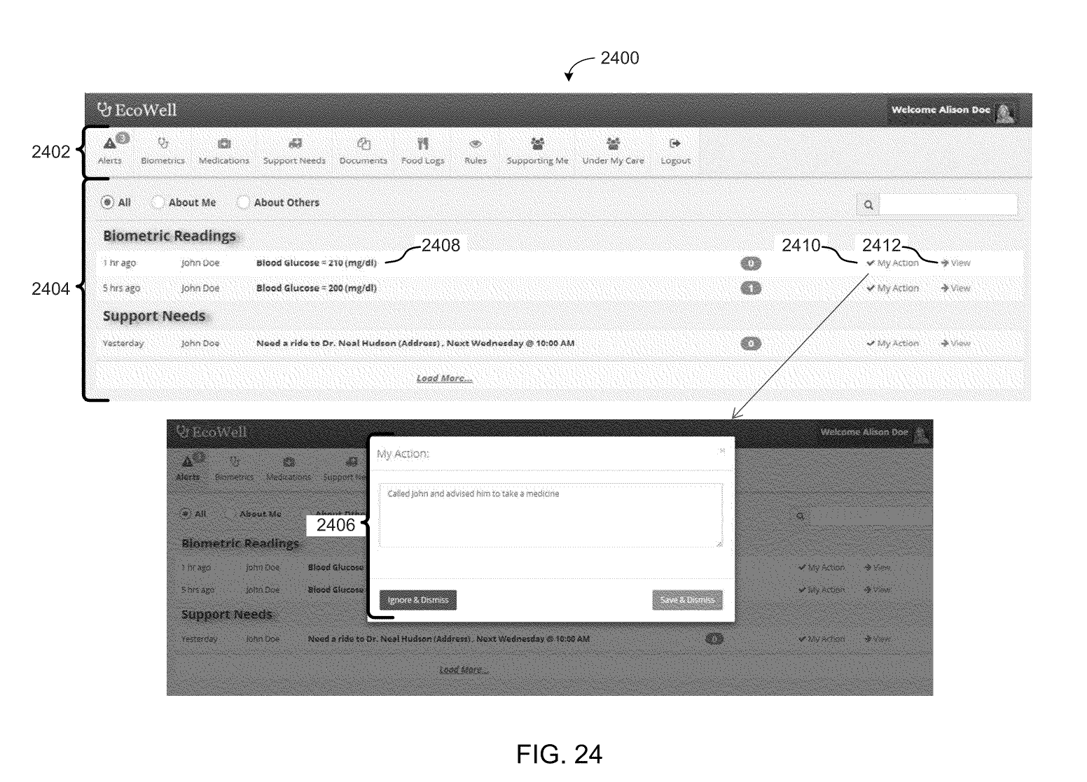

FIG. 24 is a screenshot of an example graphical user interface 2400 for notifications in accordance with some embodiments. Through the graphical user interface 2400, a given user on the healthcare data system 102 may receive, review, or respond to one or more notifications (e.g., alert or reminder) provided (e.g., generated or issued), by the healthcare data system 102, in association with the given user. As shown in FIG. 24, the graphical user interface 2400 includes a menu 2402 configured to provide the given user access to various features supported by the healthcare data system 102, such as notifications, biometrics, medications, support needs, documents, food logs, and rules. The graphical user interface 2400 may also include a notifications panel 2404 configured to facilitate the given user's (e.g., healthcare provider, friend, or family user's) management or review of notifications provided by the healthcare data system 102 in connection with the user or another user on the healthcare data system 102. Depending on the embodiment, a user may respond to one or more notifications listed in the notifications panel 2404, and the user may have more than one option available for responding to a given notification. Options for responding to a given notification may depend on the given notification's type (e.g., reminder, health reading alert, in-system communication, request to join healthcare team, etc.), may depend on the identity of the user receiving the given notification, may depend on the user type of the user receiving the given notification, or may depend on when the given notification was issued. Various embodiments may take into consider other factors when determining what notification response options are provided to a user.

In FIG. 24, a healthcare provider user of the healthcare data system 102 may receive a notification 2408 regarding a blood glucose reading taken by another user on the healthcare data system 102. By selecting a graphical element 2410 (e.g., link) “My Actions” associated with the notification 2408, the healthcare provider user may be presented with one or more options to respond to the notification 2408. In the case of FIG. 24, the healthcare provider user is presented/prompted a field 2406, which may enable the healthcare provider user to send a communication (e.g., in-system communication) to the user taking the blood glucose reading (e.g., where the user is monitoring the blood glucose readings of another user), may enable the healthcare provider user to make a note with regard to the notification (e.g., “Called the user to advise them to take their medication to lower their blood glucose level”), or may enable the healthcare provider user to ignore or dismiss the notification 2406 (which in turn may cause the notification 2406 to be removed from the notifications panel 2404).

Upon presenting the notification 2408 on the notifications panel 2404, a healthcare provider user may select to review additional details regarding the notification 2408. In FIG. 24, the healthcare provider user may select a graphical element 2412 to review additional details regarding the notification 2408. For example, selection of the graphical element 2412 by the healthcare provider user may cause the healthcare provider user to be prompted with dialog box providing the additional details.

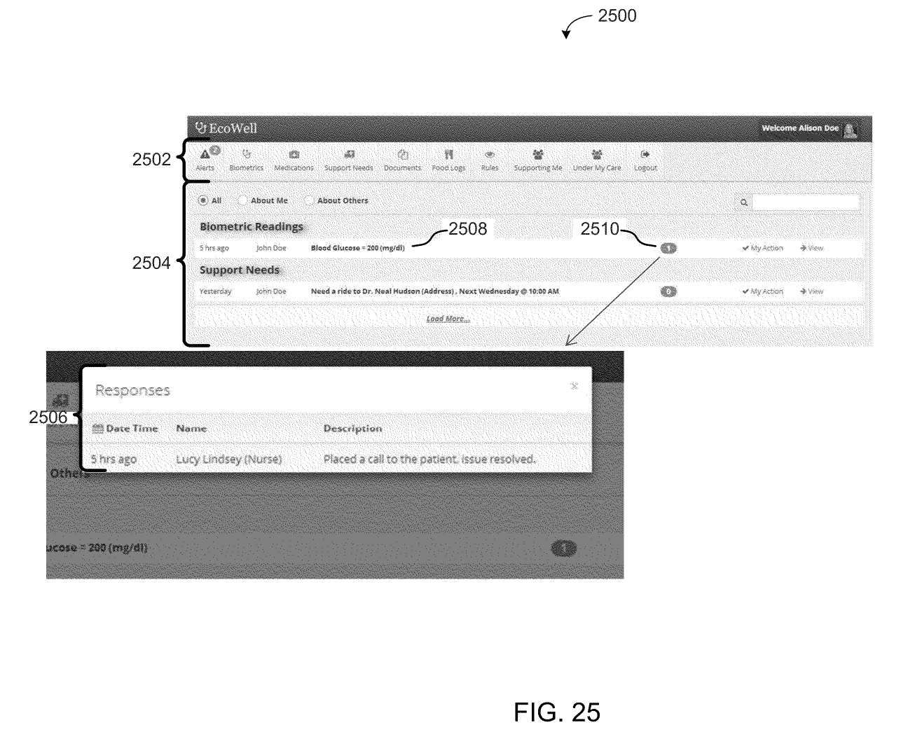

FIG. 25 is a screenshot of an example graphical user interface 2500 for notifications in accordance with some embodiments. Through the graphical user interface 2500, a given user on the healthcare data system 102 may receive, review, or respond to one or more notifications (e.g., alert or reminder) provided (e.g., generated or issued), by the healthcare data system 102, in association with the given user. As shown in FIG. 25, the graphical user interface 2500 includes a menu 2502 configured to provide the given user access to various features supported by the healthcare data system 102, such as notifications, biometrics, medications, support needs, documents, food logs, and rules. The graphical user interface 2500 may also include a notifications panel 2504 configured to facilitate the given user's (e.g., healthcare provider, friend, or family user's) management or review of notifications provided by the healthcare data system 102 in connection with the user or another user on the healthcare data system 102. Depending on the embodiment, the notifications panel 2504 may indicate (e.g., graphically or by text) whether a given notification has been responded, how many responses the healthcare data system 102 has received with respect to a given notification, which user or users on the healthcare data system 102 have responded to a given notification, how user or users on the healthcare data system 102 have responded to a given notification, or when a given notification was responded to. Various embodiments may provide other information regarding responses to notifications listed through the notifications panel 2504.

In FIG. 25, a healthcare provider user the healthcare data system 102 may receive a notification 2508 regarding a blood glucose reading taken by another user on the healthcare data system 102. With respect to the notification 2508, the notifications panel 2504 may provide a response graphical indicator 2510, which may indicate whether a response has been provided to the healthcare data system 102 for the notification 2508, and may further indicate how many such responses have been provided to the healthcare data system 102. As shown in FIG. 25, when the healthcare provider user selects the response graphical indicator 2510, the healthcare provider user may be prompted with a dialog box 2506 providing details regarding one or more responses associated with the notification 2508. Example responses (associated with the notification 2508) that the dialog box 2506 can possibly list include a note posted on the healthcare data system 102 by a user (e.g., note by another user on the healthcare data system 102 that the other user placed a call to the user taking the biometric reading associated with the notification 2508). Other actions the user can request the healthcare data system 102 take in response to the notification 2508 can include dismissing the notification 2508, sending an in-system communication in connection with the notification 2508, creating a new notification in response to the notification 2508, forwarding the notification 2508 to another user on the healthcare data system 102, and creating a new rule in response to the notification 2508. Depending on the embodiment, a given user may request that the healthcare data system 102 take more than one response with respect to a given notification.

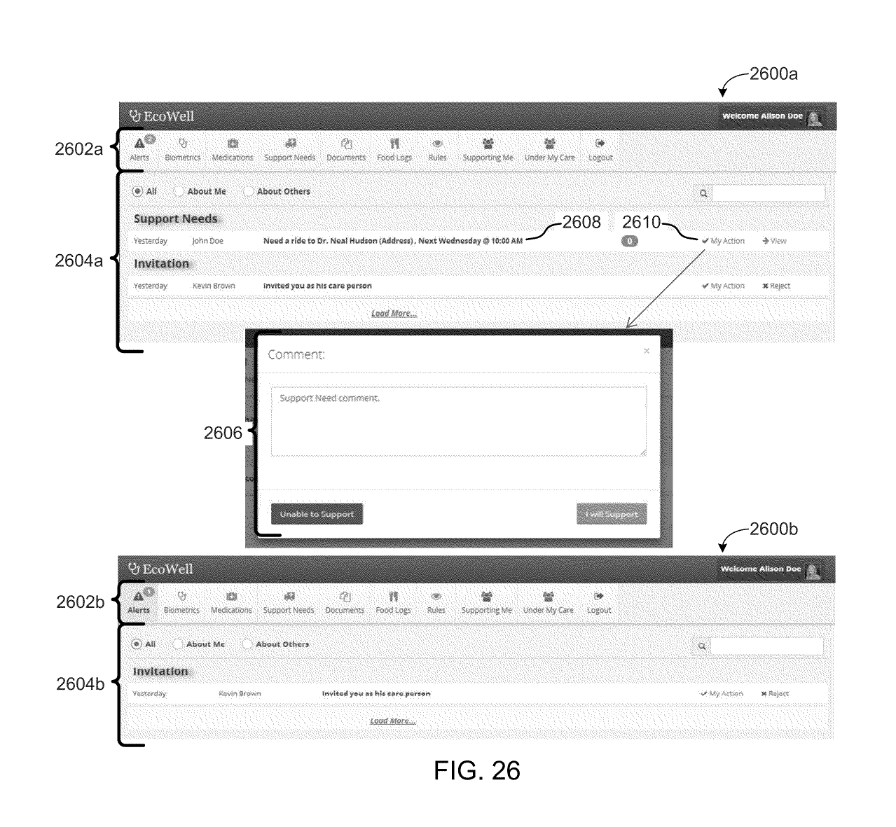

FIG. 26 is a screenshot of an example graphical user interfaces 2600a and 2600b for notifications in accordance with some embodiments. Through the graphical user interface 2600a, a given user on the healthcare data system 102 may receive, review, or respond to one or more notifications (e.g., alert or reminder) provided (e.g., generated or issued), by the healthcare data system 102, in association with the given user. As shown in FIG. 26, the graphical user interface 2600a includes a menu 2602a configured to provide the given user access to various features supported by the healthcare data system 102, such as notifications, biometrics, medications, support needs, documents, food logs, and rules. The graphical user interface 2600a may also include a notifications panel 2604a configured to facilitate the given user's (e.g., healthcare provider, friend, or family user's) management or review of notifications provided by the healthcare data system 102 in connection with the user or another user on the healthcare data system 102. By way of the notifications panel 2604a, the given user may receive various notifications provided (e.g., generated or issued) by the healthcare data system 102, including notifications relating to biometric readings taken by one or more users on the healthcare data system 102, and notifications relating to one or more users for whom the given user is providing user-support (e.g., supporting those users' needs).

In FIG. 26, a healthcare provider user of the healthcare data system 102 may receive a notification 2608 regarding a support needed by another user (e.g., patient user) of the healthcare data system 102. As also described herein, a user may respond to the notification 2608 by selecting a graphical element 2610 (e.g., link) “My Actions” associated with the notification 2608, which in turn may cause the graphical user interface 2600 to display one or more options for responding to the notification 2608. For instance, when the user selects the graphical element 2610, the graphical user interface 2600 may present a dialog box 2606 that may enable the healthcare provider user to respond to the notification 2608 by confirming whether the healthcare provider user will support the other user with respect to the need detailed by the notification 2608, and that may further enable the healthcare provider user to provide a note (e.g., comment) when responding to the notification 2608. Once the healthcare provider user responds to the notification 2608, the graphical user interface 2600a may be adjusted to reflect the healthcare provider user's response to the notification 2608. An example of this adjustment is illustrated by the graphical user interface 2600b, which includes a menu 2602b that reflects one less alert, and a notifications panel 2604b that does not include the notification 2608.

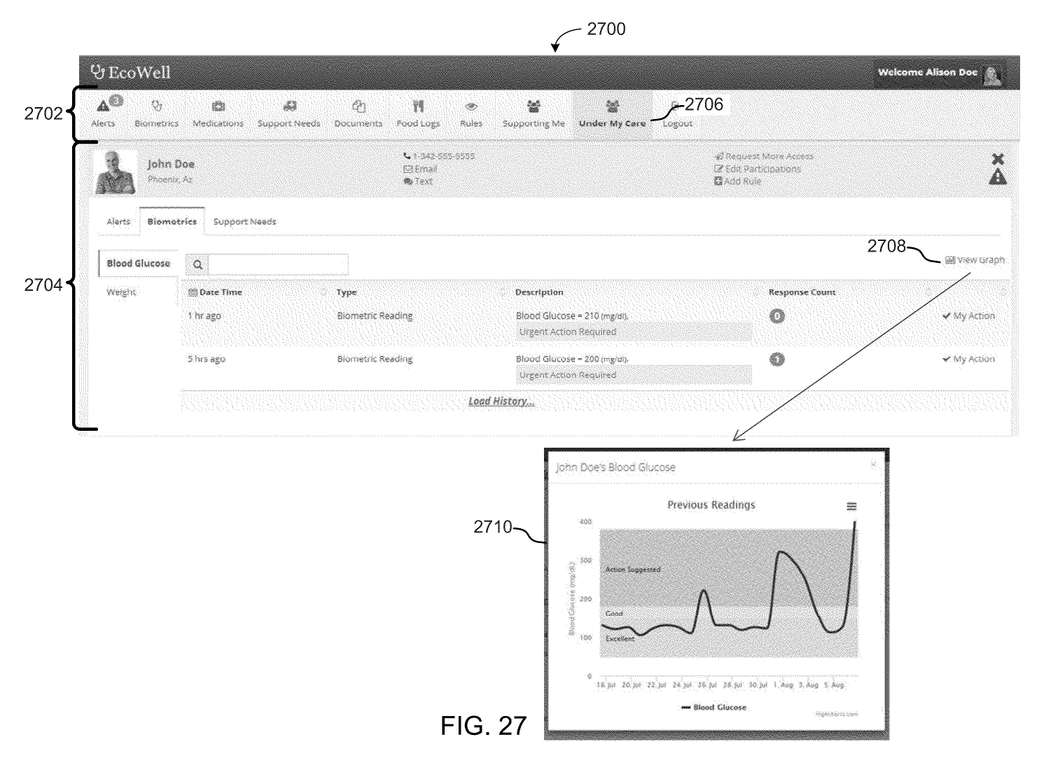

FIG. 27 is a screenshot of an example graphical user interface 2700 for user-support features in accordance with various embodiments. For some embodiments, a given user on the healthcare data system 102 supports another user on the healthcare data system 102 with whom the given user has established a user-support relationship on the healthcare data system 102. Such a user-support relationship may be indirectly established (e.g., by default) when the given user becomes a member of the other user's healthcare data system. For some embodiments, the user-support features provided by the healthcare data system 102 enables the given user to assist in, or otherwise facilitate, healthcare of another user. For instance, user-support features provided by the healthcare data system 102 may permit the given user to assist in, or otherwise facilitate, in health monitoring activity of another user (e.g., alert the given user that another user's health readings indicates a possible health emergency), attendance of medical appointments by another user (e.g., notify the given user that another user needs a ride to a medical appointment), or administration of medication to another user (e.g., inform the given user to pick up medication for another user, or when the other user fails to take their medication).

Through the graphical user interface 2700, a given user on the healthcare data system 102 may access features or settings relating to the given user's support of another user on the healthcare data system 102 (e.g., another user “under the care” of the given user). For instance, the graphical user interface 2700 may facilitate the given user's access to one or more user-support notifications (e.g., alert or reminder) provided (e.g., generated or issued by the healthcare data system 102) to the given user in connection with one or more users on the healthcare data system 102 the given user is supporting. With respect to user-support notifications, the given user may receive, review, or respond to one or more user-support notifications presented by the graphical user interface 2700.

As shown in FIG. 27, the graphical user interface 2700 includes a menu 2702 configured to provide a given user on the healthcare data system 102 (e.g., healthcare provider user) access to various features supported by the healthcare data system 102, such as notifications, biometrics, medications, support needs, documents, food logs, and rules. To access features or settings relating to the given user's support of another user (e.g., patient user), the given user may select a graphical element 2706 (e.g., link) included by the menu 2702, which in turn may cause the graphical user interface 2700 to present a user-support panel 2704 to the given user. Depending on the embodiment, the user-support panel 2704 may be presented in connection with one or more users on the healthcare data system 102 that the given user is supporting through the healthcare data system 102. With respect to another user, the user-support panel 2704 can provide the given user with access to features or settings relating to alerts for the other user (e.g., alert issues when other user forgets to take medication), notifications regarding biometric readings by the other user (e.g., notification when blood glucose level is at or above threshold), or notifications regarding support needs for the other user (e.g., notification when the other user needs a ride to an appointment). With respect to health readings (or other information) relating to the other user, the user-support panel 2704 can include a graphical element 2708 that when selected by the given user, causes the graphical user interface 2700 to provide the given user with a graph 2710 (or some other graphical representation of data) relating to the health readings.

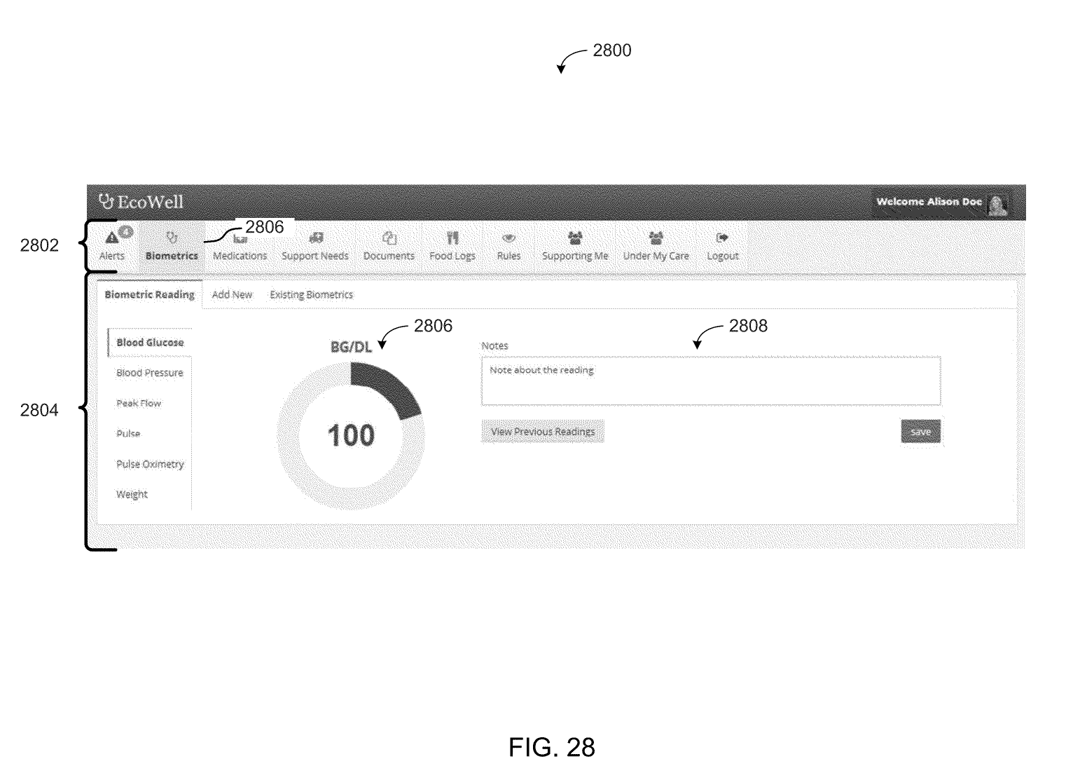

FIG. 28 is a screenshot of an example graphical user interface 2800 for biometrics in accordance with various embodiments. Through the graphical user interface 2800, a given user on the healthcare data system 102 may access features, provided by the healthcare data system 102, that relate to health readings. For instance, the graphical user interface 2800 may permit the given user to review a summary of one or more of their biometric readings, add new biometric readings to the healthcare data system 102, schedule future biometric readings to be entered to the healthcare data system 102, or review their latest biometric readings. Examples of biometric readings include blood glucose level, blood pressure, peak flow, pulse, pulse oximetry, weight, and the like. Depending on the embodiment, the graphical user interface 2800 may enable the given user to add one or more notes (e.g., comments) with respect to particular health readings, and may further enable the given user to edit or remove one or more previous health readings (e.g., erroneous readings) entered to the healthcare data system 102.

As shown in FIG. 28, the graphical user interface 2800 may include a menu 2802 configured to provide a given user on the healthcare data system 102 access to various features supported by the healthcare data system 102, such as notifications, biometrics, medications, support needs, documents, food logs, and rules. The given user may access a biometric readings panel 2804 by selecting a graphical element 2806 included by the menu 2802, which in turn may cause the biometric readings panel 2804 to be displayed by the graphical user interface 2800. The biometric readings panel 2804 may include a graphical element 2806 that can summarize a reading for a given biometric (e.g., blood glucose level), and may include a text field 2808 that permits the given user to enter a note (e.g., comment) with respect to a given reading (e.g., biometric reading before taking medication).

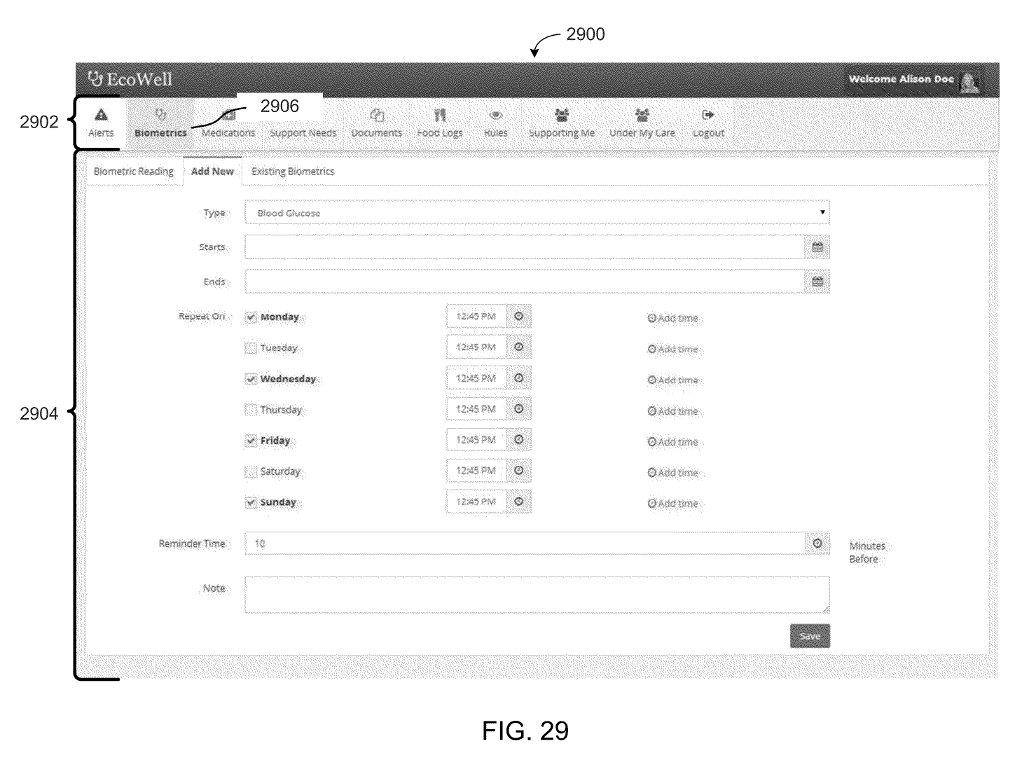

FIG. 29 is a screenshot of an example graphical user interface 2900 for biometrics in accordance with various embodiments. Through the graphical user interface 2900, a given user on the healthcare data system 102 may access features provided by the healthcare data system 102 with respect to health readings. For instance, the graphical user interface 2900 may permit the given user to review a summary of one or more of their biometric readings, add new biometric readings to the healthcare data system 102, schedule future biometric readings to be entered to the healthcare data system 102, or review their latest biometric readings.

As shown in FIG. 29, the graphical user interface 2900 may include a menu 2902 configured to provide a given user on the healthcare data system 102 access to various features supported by the healthcare data system 102, such as notifications, biometrics, medications, support needs, documents, food logs, and rules. The given user may access a biometric readings panel 2904 by selecting a graphical element 2906 included by the menu 2902, which in turn may cause the biometric readings panel 2904 to be displayed by the graphical user interface 2900. The biometric readings panel 2904 may enable the given user to schedule one or more biometric readings, and may include one or more graphical elements (e.g., text such as fields, sub-menus, and option boxes) to facilitate such scheduling. For example, various graphical elements included in the biometric readings panel 2904 may permit the given user to enter or otherwise adjust parameters with respect to one or more biometric reading schedules. The given user may utilize the various graphical elements to specify the type of biometric reading being scheduled, when the biometric reading schedule starts, when the biometric reading schedule ends, what days or times the biometric reading will be taken, or when a notification (e.g., alert or reminder) should be issued with respect to scheduled biometric readings. The graphical elements included in the biometric readings panel 2904 may also permit the given user to add one or more notes in association with a scheduled biometric reading (e.g., purpose of the scheduled biometric reading, or additional instructions for the scheduled biometric reading).

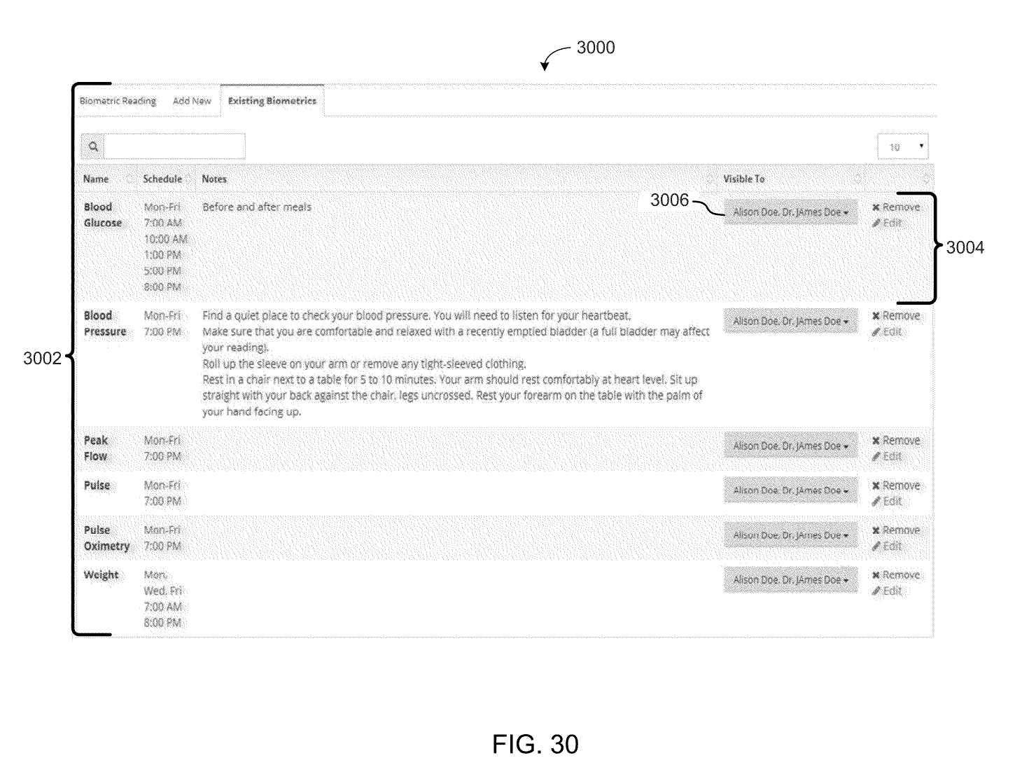

FIG. 30 is a screenshot of an example graphical user interface 3000 for biometrics in accordance with various embodiments. Through the graphical user interface 3000, a given user may access features provided by the healthcare data system 102 with respect to health readings. For instance, the graphical user interface 3000 may permit the given user to review, add, edit, or remove one or more scheduled health readings.

As shown in FIG. 30, the graphical user interface 3000 may include a biometric readings panel 3002 configured to list one or more health readings schedule for a given user on the healthcare data system 102. For the scheduled biometric readings listed, the biometric readings panel 3002 may provide the type of biometric reading scheduled, the day, time or date for scheduled for the biometric reading, one or more notes associated with the scheduled biometric reading, or other parameters associated with the scheduled biometric reading. Additionally, the biometric readings panel 3002 may enable the given user to review, add, edit, or remove access (e.g., visibility) of a given scheduled biometric reading by one or more other users on the healthcare data system 102. For example, the biometric readings panel 3002 may list a scheduled biometric reading 3004 and may include, with the listing, a dropdown menu 3006 that one or more users on the healthcare data system 102 that have visibility access with respect to the scheduled biometric reading 3004. By selecting the dropdown menu 3006, the given user may determine which users currently have visibility access to the scheduled biometric reading 3004, grant visibility access to users that do not currently having visibility access to the scheduled biometric reading 3004, or remove or modify visibility access for users that do currently have visibility access. Those users, on the healthcare data system 102, having visibility access with respect to a particular scheduled biometric reading may be able to review details regarding the particular scheduled biometric reading, review (past or current) results from biometric readings taken in accordance with the scheduled biometric reading, or receive one or more notifications based on biometric readings taken in accordance with the scheduled biometric reading. Depending on the embodiment, access types associated with a scheduled biometric reading can include a particular user's ability to read (e.g., review), write (e.g., create), edit, or remove (e.g., delete) a scheduled biometric reading associated with the given user.

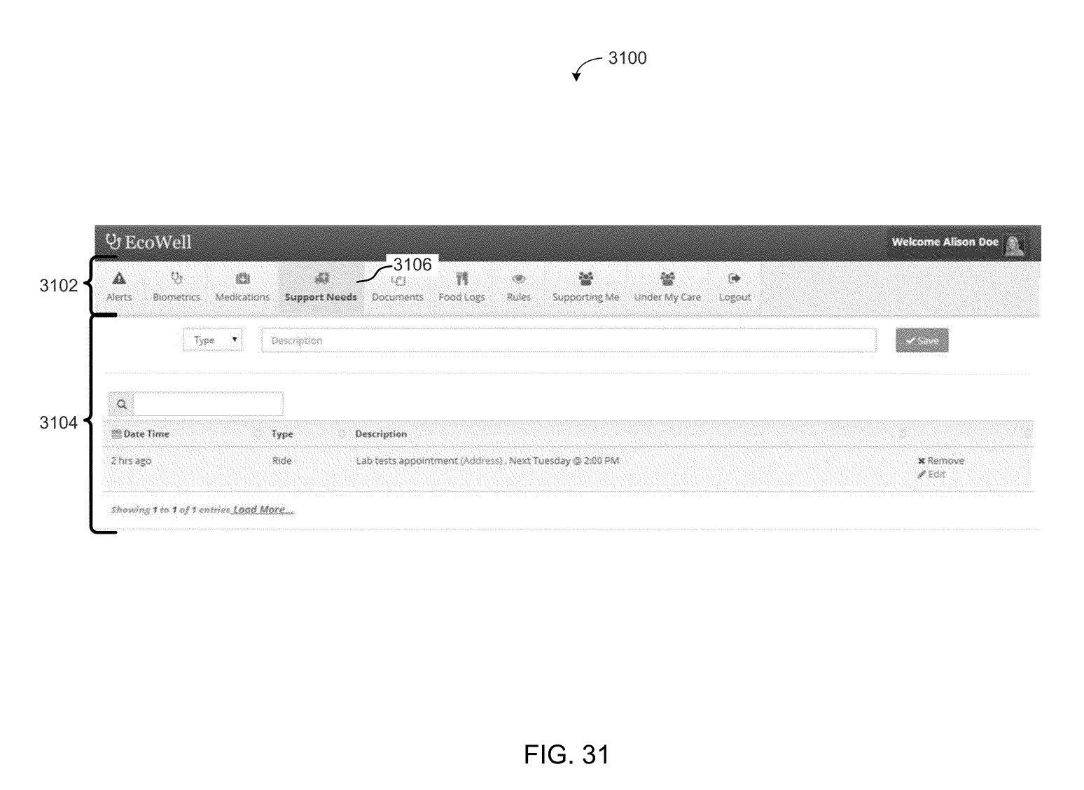

FIG. 31 is a screenshot of an example graphical user interface 3100 for user-support features in accordance with various embodiments. Through the graphical user interface 3100, a given user on the healthcare data system 102 may access features provided by the healthcare data system 102 with respect to reviewing, adding, editing, or removing requests for user-support. As shown in FIG. 31, the graphical user interface 3100 may include a menu 3102, which may enable the given user to access various features provided by the healthcare data system 102, such as notifications, biometrics, medications, support needs, documents, food logs, and rules. The given user may access a user-support panel 3104 by selecting a graphical element 3106 included by the menu 3102, which in turn may cause the biometric readings panel 3104 to be displayed by the graphical user interface 3100. The biometric readings panel 3104 may enable the given user to add a new request for user-support or edit, remove, or review (e.g., review the status of) an existing request for user-support. The biometric readings panel 3104 may list the existing requests for user-support and may provide various information regarding those existing requests, such as the current status of the request, the time or date at which the request was submitted, duration of user-support requested, a description of the user-support requested, the type of user-support requested, who received the request for user-support, or who has responded to the request.

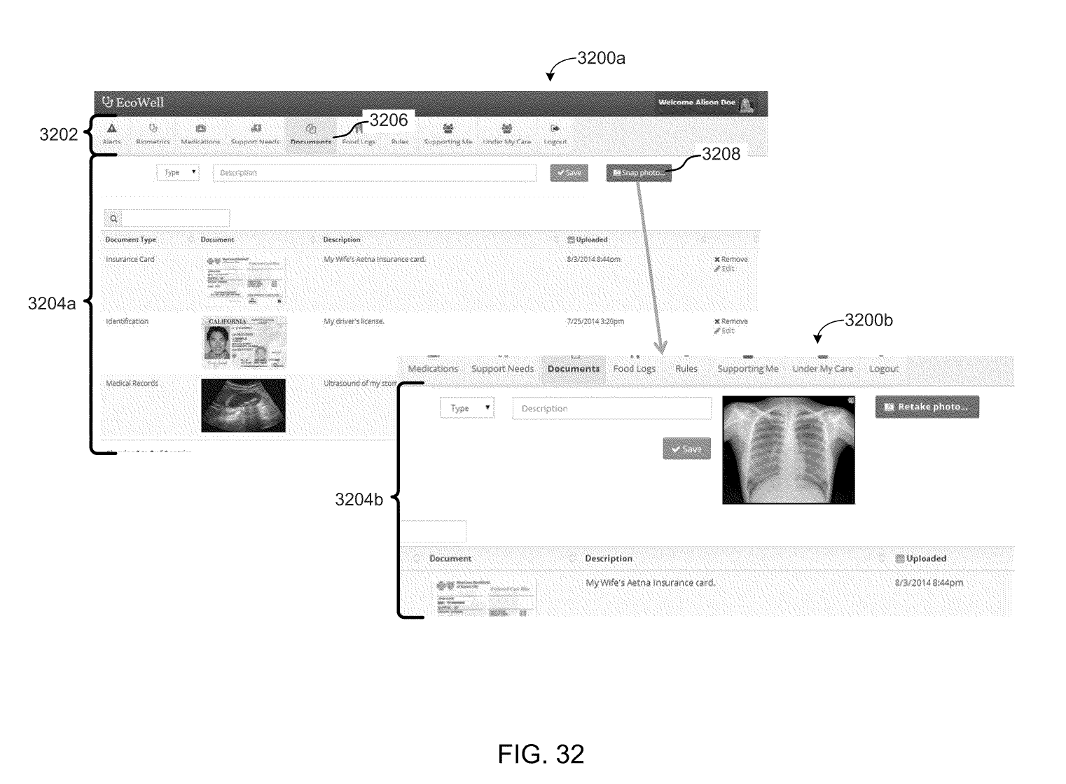

FIG. 32 is a screenshot of example graphical user interfaces 3200a and 3200b for documents in accordance with various embodiments. Through the graphical user interface 3200a, a given user on the healthcare data system 102 may access features provided by the healthcare data system 102 with respect to documents, which can include features for uploading documents to, downloading documents from, or managing documents on the healthcare data system 102. For instance, the graphical user interface 3200a may permit the given user to review a listing of one or more healthcare-related documents maintained by the healthcare data system 102 on behalf of the given user. Examples of healthcare-related documents maintained by the healthcare data system 102 can include healthcare-related documents uploaded to the healthcare data system 102 by the given user, or healthcare-related documents associated with the given user and uploaded to the healthcare data system 102 by another user on the healthcare data system 102, such as a x-ray images healthcare provider user (e.g., doctor user) on the given user's healthcare team. Depending on the embodiment, the healthcare-related documents can include text documents (e.g., medical reports, medical appointment results, blood results, prescriptions, etc.), images (e.g., x-ray images, CAT scans, etc.), video, and the like. The healthcare-related document can include documents commonly used by the given user when visiting a healthcare professional, such as a copy of the given user's medical card, prescription card, or government-issued identification.

As shown in FIG. 32, the graphical user interface 3200a includes a menu 3202 configured to provide a given user on the healthcare data system 102 access to various features supported by the healthcare data system 102, such as notifications, biometrics, medications, support needs, documents, food logs, and rules. The graphical user interface 3200a may also include a documents panel 3204a configured to facilitate the given user's (e.g., healthcare provider, friend, or family user's) management or review of documents maintained by the healthcare data system 102 in connection with the given user or another user on the healthcare data system 102. By way of the documents panel 3204a, the given user may review a listing of health-care documents being maintained by the healthcare data system 102, and may additionally review information associated with those documents, such as document type, document description, a preview of the document (e.g., preview image), time or date of upload, identity of the user who uploaded the document, and the like. The given user may upload and add one or more healthcare-related documents by one or more graphical elements included by the documents panel 3204a. For instance, the given user may select a graphical element 3208 configured to facilitate the upload and addition of an image to the healthcare data system 102. For some embodiments, the selection of the graphical element 3208 permits the given user to capture an image using the given user's client device (e.g., smartphone having camera), the captured image is subsequently uploaded to the healthcare data system 102, and the documents panel 3204a is updated to show the captured and uploaded image (e.g., before the captured and uploaded image is saved to the healthcare data system 102 for future use). An example of the documents panel 3204a as updated is illustrated by the documents panel 3204b, which displays an x-ray image captured and uploaded to the healthcare data system 102 by the given user.

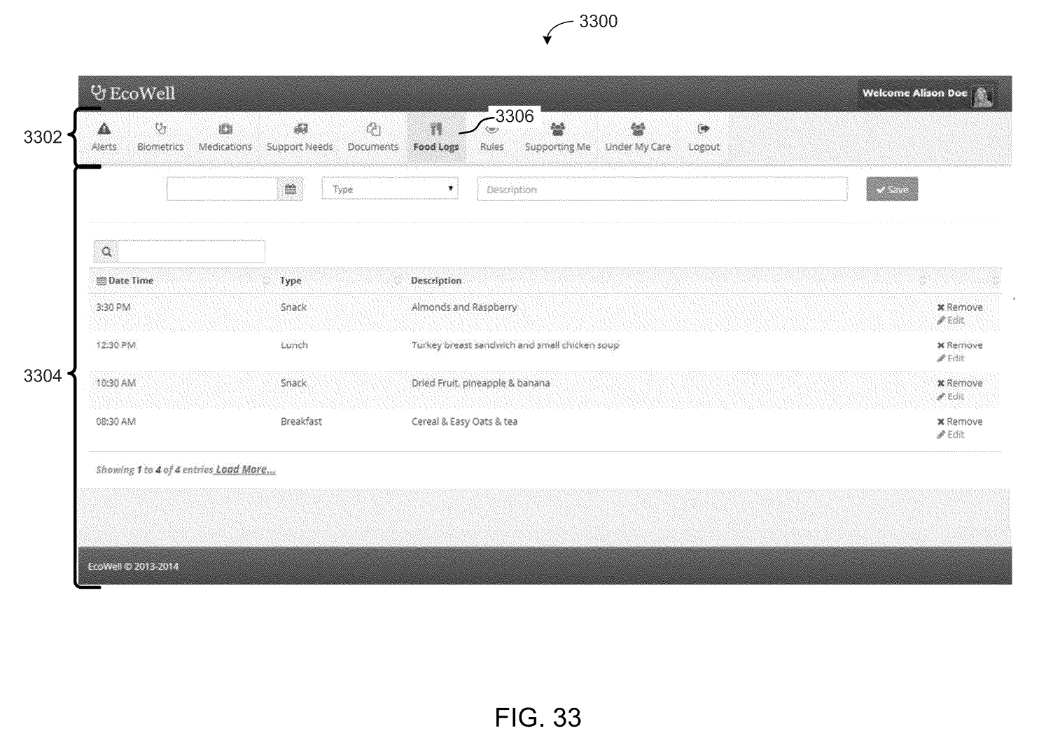

FIG. 33 is a screenshot of an example graphical user interface 3300 for logging food in accordance with various embodiments. Through the graphical user interface 3300, a given user on the healthcare data system 102 may access features provided by the healthcare data system 102 with respect to a user's diet, such as logging food consumption. As shown in FIG. 33, the graphical user interface 3300 includes a menu 3302 configured to provide the given user on the healthcare data system 102 access to various features supported by the healthcare data system 102, such as notifications, biometrics, medications, support needs, documents, food logs, and rules. The given user may access a food log panel 3304 by selecting a graphical element 3306 included by the menu 3302, which in turn may cause the food log panel 3304 to be displayed by the graphical user interface 3300. The food log panel 3304 may be configured to facilitate the given user's (e.g., healthcare provider, friend, or family user's) management or review of a food consumption log. For instance, through the food log panel 3304, the given user can review, remove, or edit one or more existing food log entries being maintained by the healthcare data system 102 for the given user, and the given user can further create (e.g., enter) new food log entries on the healthcare data system 102. The food log panel 3304 may provide the given user with information regarding one or more food log entries, including the time or date of a food log entry, a meal associated with the food log entry (e.g., breakfast, snack, lunch, dinner, etc.), a description of food consumed, nutritional information associated with the food log entry (e.g., calories, carbohydrates, etc.), a brand associated with the food consumed, and the like.

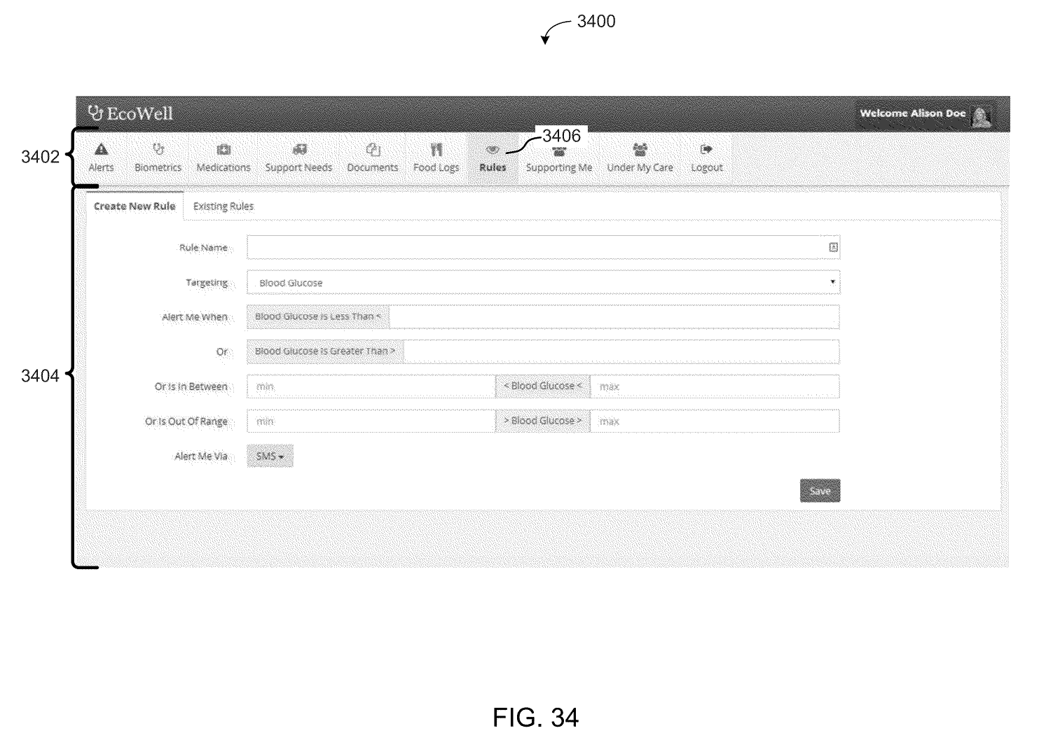

FIG. 34 is a screenshot of an example graphical user interface 3400 for rules in accordance with various embodiments. Through the graphical user interface 3400, a given user on the healthcare data system 102 may access features relating to rules that govern the behavior of the healthcare data system 102 with respect to users. As shown in FIG. 34, the graphical user interface 3400 includes a menu 3402 configured to provide the given user on the healthcare data system 102 access to various features supported by the healthcare data system 102, such as notifications, biometrics, medications, support needs, documents, food logs, and rules. The given user may access a rules panel 3404 by selecting a graphical element 3406 included by the menu 3402, which in turn may cause the rules panel 3404 to be displayed by the graphical user interface 3400.

The rules panel 3404 can include graphical elements that enable a given user to create a new rule, to review a listing of existing rules, or to edit one or more existing rules. For instance, with respect to creating a new rule, the rules panel 3404 can include graphical elements that permit the given user to provide a new rule name, select a healthcare-related objective related to the new rule (e.g., a rule targeting or relating to blood glucose levels), define one or more conditions for the new rule (e.g., when glucose level is above or below a threshold, send an alert), and define an action caused by the new rule when one or more of the conditions are met (e.g., alert the given user). Depending on the embodiments, the given user may create a rule in connection with their self, or in connection with another user on the healthcare data system 102 (e.g., another user that the given user is supporting through the healthcare data system 102).

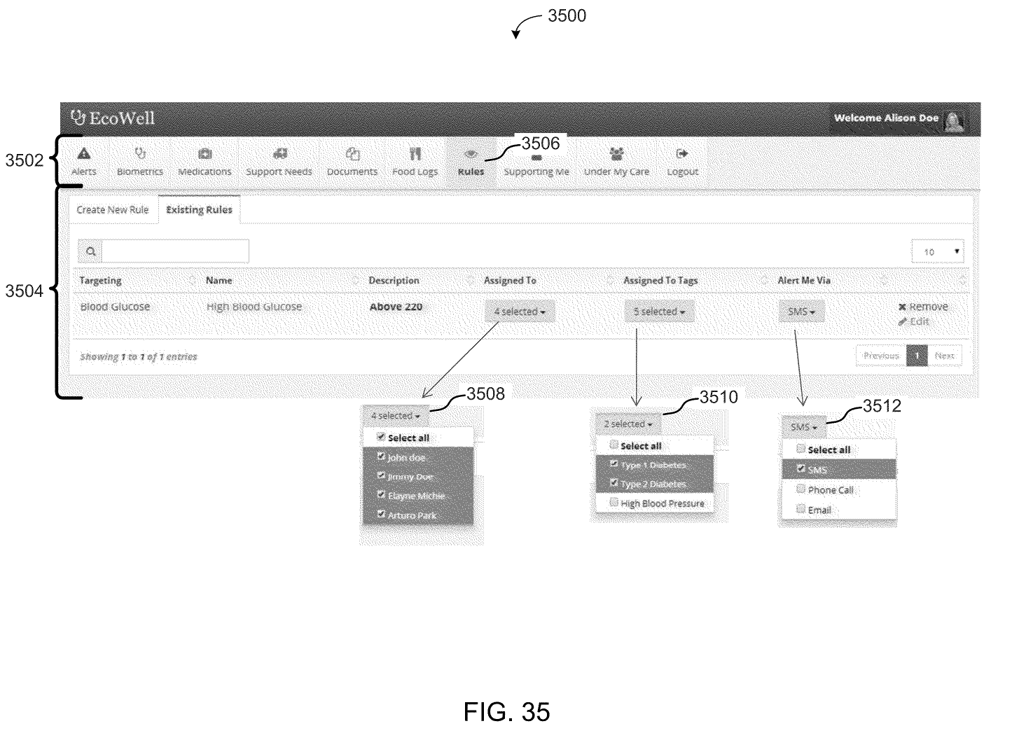

FIG. 35 is a screenshot of an example graphical user interface 3500 for rules in accordance with various embodiments. Through the graphical user interface 3500, a given user on the healthcare data system 102 may access features relating to rules that govern the behavior of the healthcare data system 102 with respect to users. As shown in FIG. 35, the graphical user interface 3500 includes a menu 3502 configured to provide the given user on the healthcare data system 102 access to various features supported by the healthcare data system 102, such as notifications, biometrics, medications, support needs, documents, food logs, and rules. The given user may access a rules panel 3504 by selecting a graphical element 3506 included by the menu 3502, which in turn may cause the rules panel 3504 to be displayed by the graphical user interface 3500.

The rules panel 3504 can include one or more graphical elements that enable a given user to create a new rule, to review a listing of existing rules, or to edit one or more existing rules. For instance, with respect to existing rules, the rules panel 3504 provide various information regarding the existing rules it lists, such as the time or date on which an existing rule was created, one or more users associated with the existing rule (e.g., users assigned to the rule), a description of the existing rule, one or more conditions associated with the existing rule that cause the existing rule to perform an action, one or more tags associated with the existing rule (e.g., healthcare-related tags, such as type 1 diabetes, type 2 diabetes, high blood pressure, migraines, etc.), and one or more actions caused by an existing rule when one or more conditions are satisfied (e.g., send an SMS, phone call, or e-mail alert to the one or more users assigned to the rule). The rules panel 3504 can include various graphical elements that permit the given user to adjust parameters of an existing rule, such as a graphical element 3508 a user assignment of an existing rule, a graphical element 3510 a tag assignment of the existing rule, or a graphical element 3512 action caused by the existing rule (e.g., SMS alert, phone call, etc.).

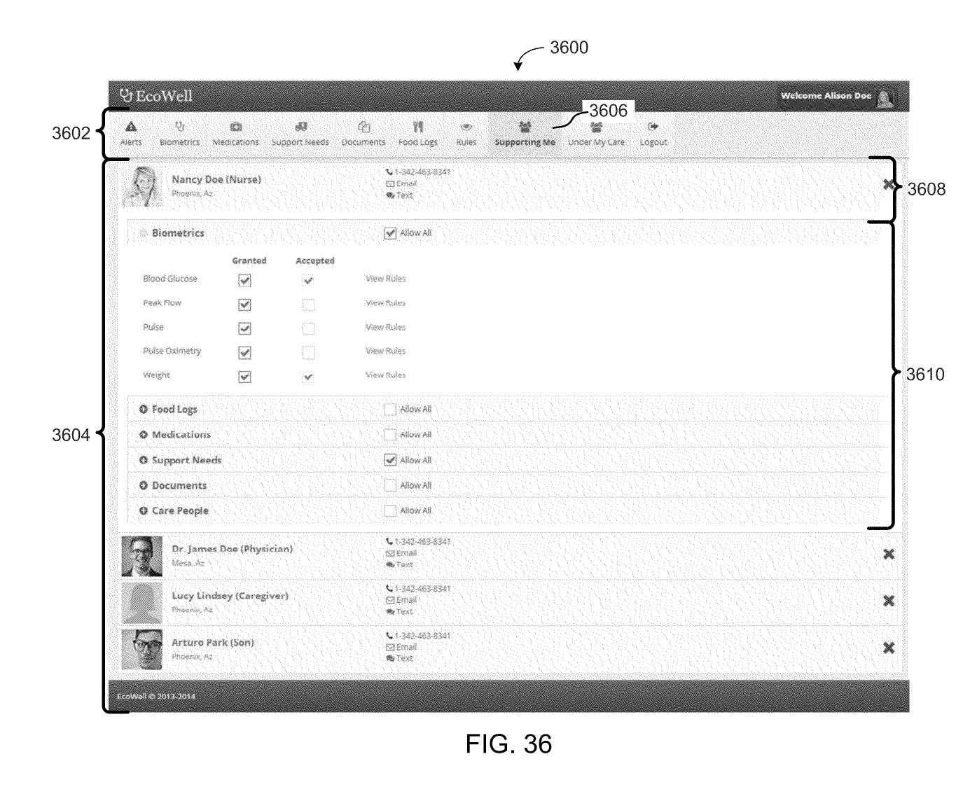

FIG. 36 is a screenshot of an example graphical user interface 3600 for user-support features in accordance with various embodiments. Through the graphical user interface 3600, a given user on the healthcare data system 102 may access user-support features provided by the healthcare data system 102. In particular, user-support features accessible through the graphical user interface 3600 can include those relating to user-support provided to the given user by one or more other users on the healthcare data system 102 (e.g., healthcare provider users or family users who are members of the given user's healthcare team). As shown in FIG. 36, the graphical user interface 3600 includes a menu 3602 configured to provide the given user on the healthcare data system 102 access to various features supported by the healthcare data system 102, such as notifications, biometrics, medications, support needs, documents, food logs, and rules. The given user may access a user-support panel 3604 by selecting a graphical element 3606 included by the menu 3602, which in turn may cause the user-support panel 3604 to be displayed by the graphical user interface 3600.

The user-support panel 3604 can include graphical elements that enable a given user to review a listing of users, on the healthcare data system 102, who are currently supporting the given user through the healthcare data system 102, or who could be supporting the given user through the healthcare data system 102. For example, the user-support panel 3604 could list family users, healthcare provider users, friend users, and the like who are currently members of the given user's healthcare team. The user-support panel 3604 may allow the given user to add one or more users to, or remove one or more users from, the given user's list of supporting users. The user-support panel 3604 may further allow the given user to organize and manage supporting users according to teams (e.g., manage the user's healthcare team). The healthcare data system 102 may modify association between the given user and the one or more to reflect changes the given user performs through the user-support panel 3604.

Through the user-support panel 3604, the given user may control access of their healthcare-related data by the one or more users supporting the given user (e.g., those listed by the user-support panel 3604). For instance, with respect to a user 3608 listed on the user-support panel 3604 (as one supporting the given user), the user-support panel 3604 may include one or more graphical elements 3610 that permit the given user to add, remove, or modify access privileges the user 3608 has with respect to the given user's healthcare-related data through the healthcare data system 102 (e.g., allow, deny, or limit access to some or all the healthcare-related data). As shown in FIG. 36, the given user may control access to the given user's biometric reading data, the given user's food log data, the given user's user-support data, the given user's documents, or the identities of one or more users on the healthcare data system 102 that are associated with the given user (e.g., on the given user's healthcare team). As also illustrated, the given user may be provided with a granular-level of data access control, where the given user can, for example, specify access control according to the type of healthcare-related data (e.g., medication data or documents) or according to subsets of data associated with a particular type of healthcare-related data (e.g., subset of data of biometric reading data).

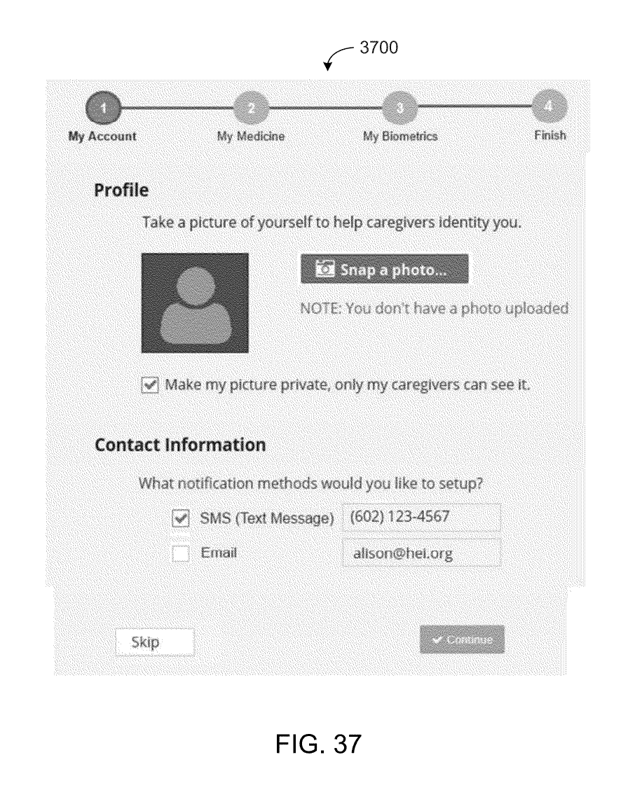

FIGS. 37-47 are screenshots of example graphical user interfaces for user account setup features in accordance with various embodiments. In FIG. 37, a graphical user interface 3700 may be configured to receive and gather profile information from a new user to the healthcare data system 102. Information gathered through the graphical user interface 3700 can include, for example, the new user's profile photo and contact information, such as an e-mail address, telephone numbers, a text message number (e.g., SMS number), a residential address, and the like.

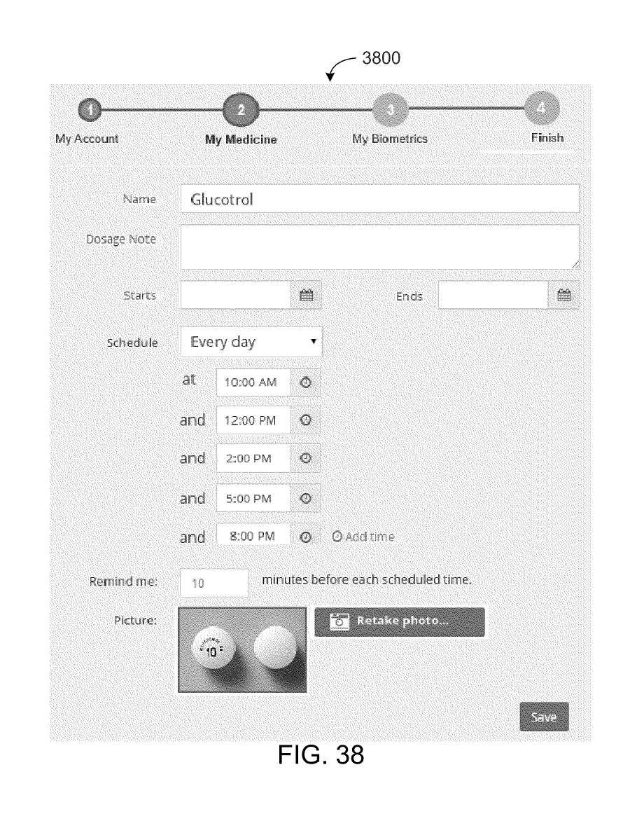

With respect to FIG. 38, a graphical user interface 3800 may be configured to receive and gather medication information from a new user to the healthcare data system 102. Information gathered through the graphical user interface 3800 can relate to the new user's current or future medication regimen. Depending on the embodiment, information relating to a medication regimen can include a medication name, a medication origin, type of medication (e.g., prescription or over the counter), identity of prescriber, notes regarding the medication (e.g., instructions for taking the medication, or dosage information), a start or end time or date for the medication regimen, a medication schedule (e.g., every day at specified times), reminder parameters (e.g., day or minutes from a scheduled dosage), a picture of the medication (e.g., image of the pills), and the like.

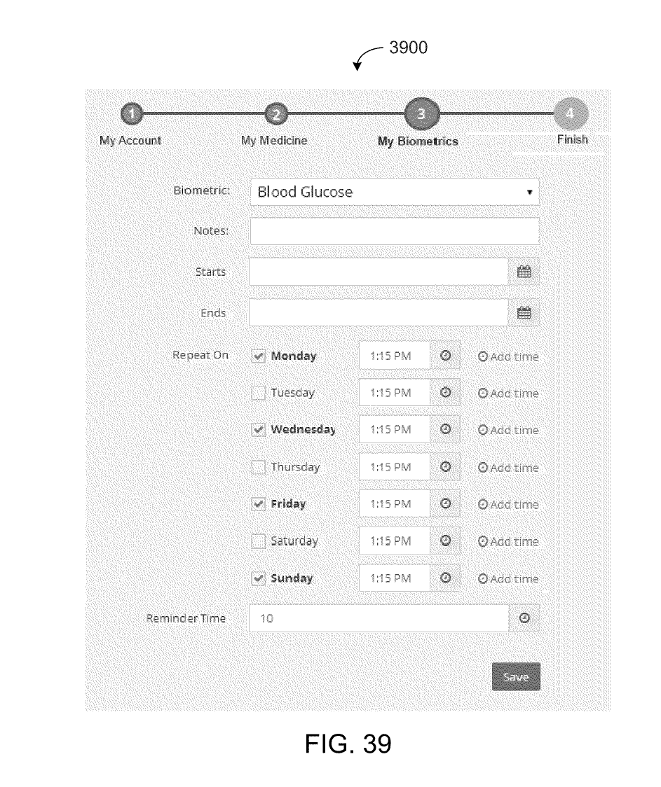

With respect to FIG. 39, a graphical user interface 3900 may be configured to receive and gather, from a new user to the healthcare data system 102, information regarding the new user's biometric reading schedule. For example, with respect to scheduling one biometric reading, the give graphical user interface 3900 may receive from the new user a selection of a biometric reading type (e.g., blood pressure or blood glucose level), notes (e.g., instructions or reasons for taking the biometric reading), a start time or date from which one or more of the biometrics readings will be scheduled, an end time or date until which one or more of the biometrics readings will be scheduled, days or times of the week when one or more of the biometrics readings will be scheduled, a reminder parameter (e.g., days or minutes from a scheduled reading), and the like.

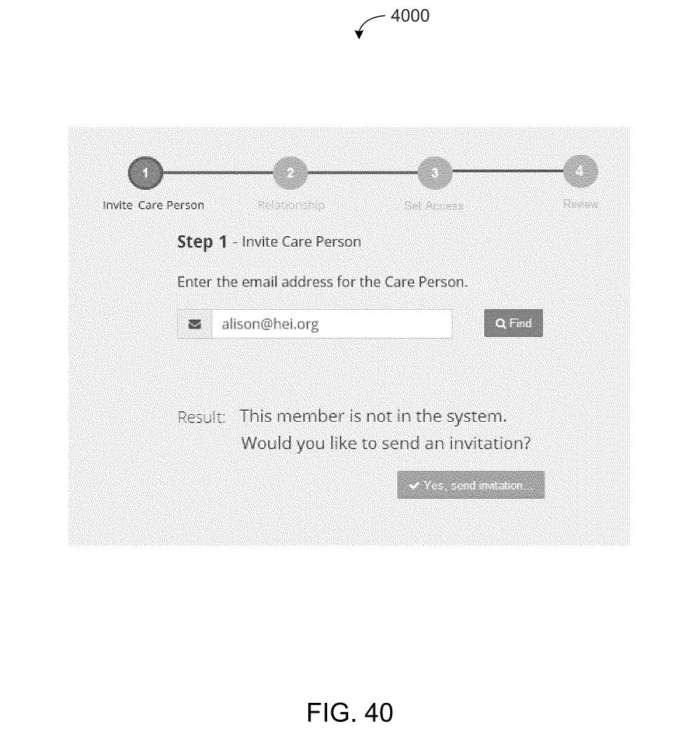

With respect to FIG. 40, a graphical user interface 4000 may be configured to receive and gather, from a new user to the healthcare data system 102, information regarding one or more users (e.g., healthcare provider users) the new user wishes to invite to the new user's support team (e.g., healthcare team). For instance, the graphical user interface 4000 may accept from the new user contact information or identification information for a particular individual that the new user wishes to invite to the new user's support team. Using the contact or identification information, the healthcare data system 102 may determine whether the particular individual is already a user on the healthcare data system 102 and, if so, may send an in-system invitation from the new user to the particular individual to join the new user's support team. In the event the particular individual is not already a user of the healthcare data system 102, the healthcare data system 102 may use the contact information (e.g., e-mail address) to send the particular individual an invite to join the healthcare data system 102 as a user, and an additional invite to join the new user's support team.

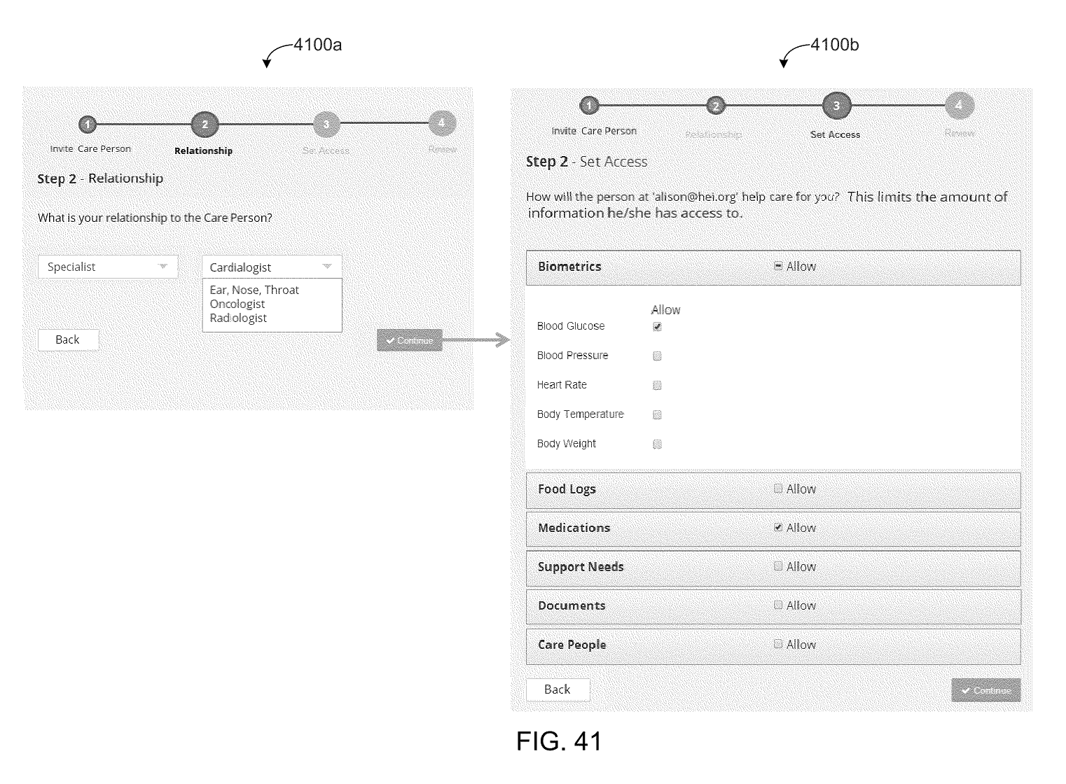

With respect to FIG. 41, graphical user interfaces 4100a and 4100b may be configured to receive and gather, from a new user to the healthcare data system 102, information regarding another user (e.g., healthcare provider user) the new user wishes to invite to the new user's support team (hereafter, an invited user). In particular, the graphical user interface 4100a may receive from the new user information regarding the relationship between the new user and the invited user. For instance, through the graphical user interface 4100a, the new user may specify that the invited user is the new user's doctor (e.g., oncologist, radiologist, and cardiologist), a family member, or a friend. With respect to the graphical user interface 4100b, the new user may add, remove, or modify the invited user's access privileges with respect the new user's healthcare-related data (e.g., biometric reading data, food log data, medication data, support need data, etc.) on the healthcare data system 102.

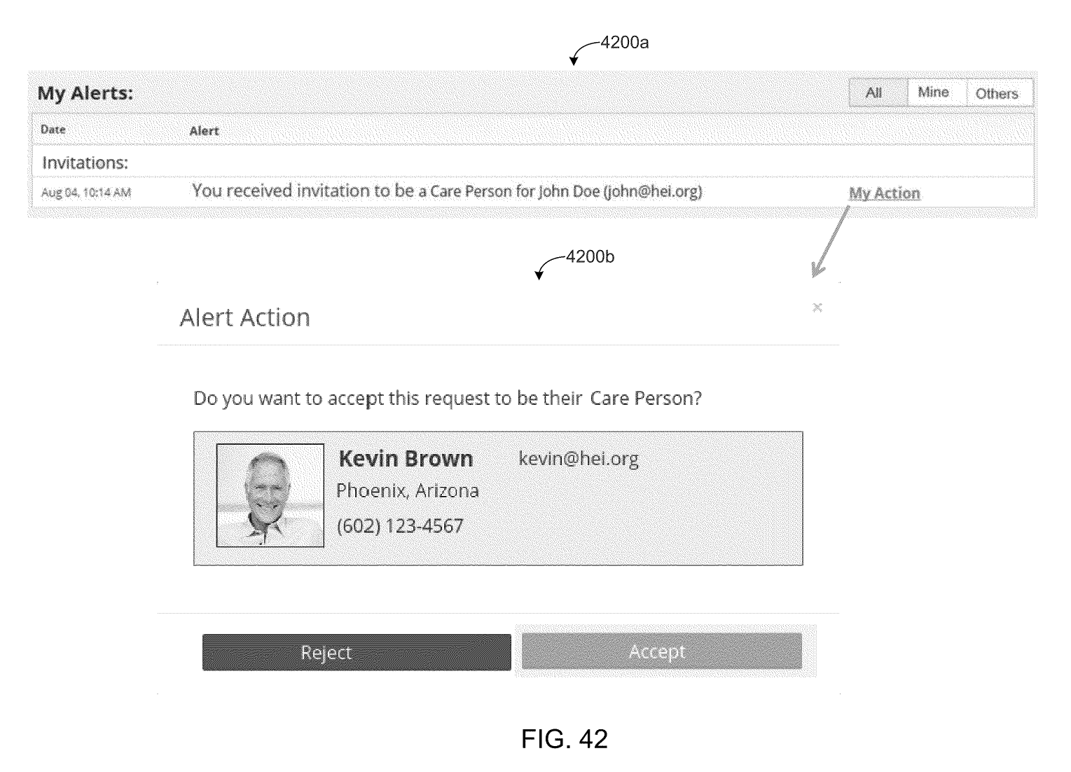

With respect to FIG. 42, graphical user interfaces 4200a and 4200b relate to an invited user's review and acceptance or rejection of an invitation to become a member of a new or existing user's support team (e.g., healthcare team) on the healthcare data system 102. As shown, the graphical user interface 4200a may present the invitation to the invited user as a notification that the invited user can respond to with an action. When the user chooses to respond to the invitation notification (e.g., by selecting the “My Action” link), the graphical user interface 4200a may present the graphical user interface 4200b, which may facilitate the invited user's acceptance or rejection of the invitation.

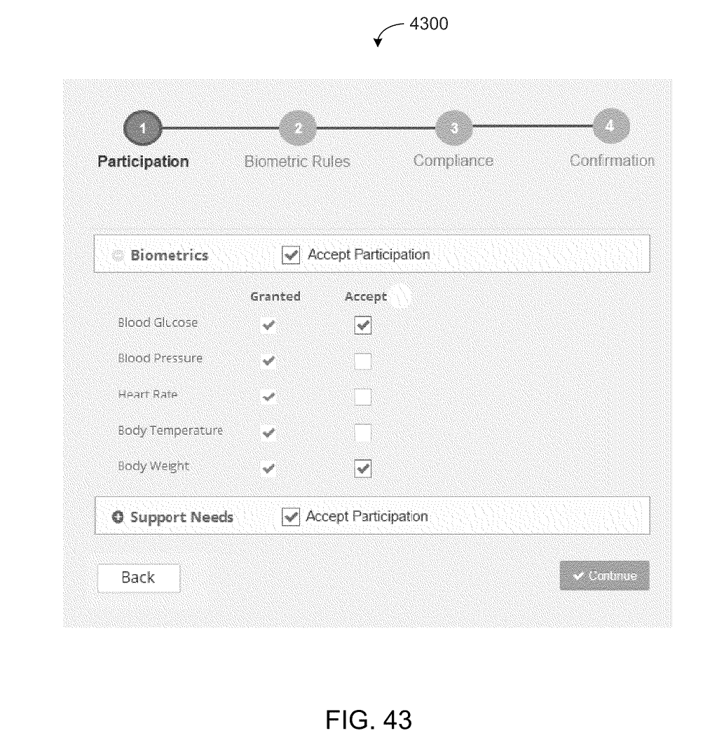

With respect to FIG. 43, a graphical user interface 4300 may be configured to present an invited user with their current access privileges with respect to an inviting user's healthcare-related data on the healthcare data system 102. For some embodiments, the graphical user interface 4300 is presented to the invited user at or after the invited user has accepted an invitation from the inviting user to join the inviting user's support team (e.g., healthcare team). As shown, through the graphical user interface 4300, the invited user may review the access privileges currently granted to them by the inviting user, and the invited user may choose to elect or decline one or more of the access privileges (e.g., access to biometric reading data or support need data) the inviting user granted the invited user. For some embodiments, the access privileges listed as granted are those the inviting user chose to grant the invited user during the invitation generation process (e.g., invitation to join support team defines the access privileges being granted). Through the graphical user interface 4300, the invited user may choose to select some or all of the privileges the inviting user granted to the invited user.

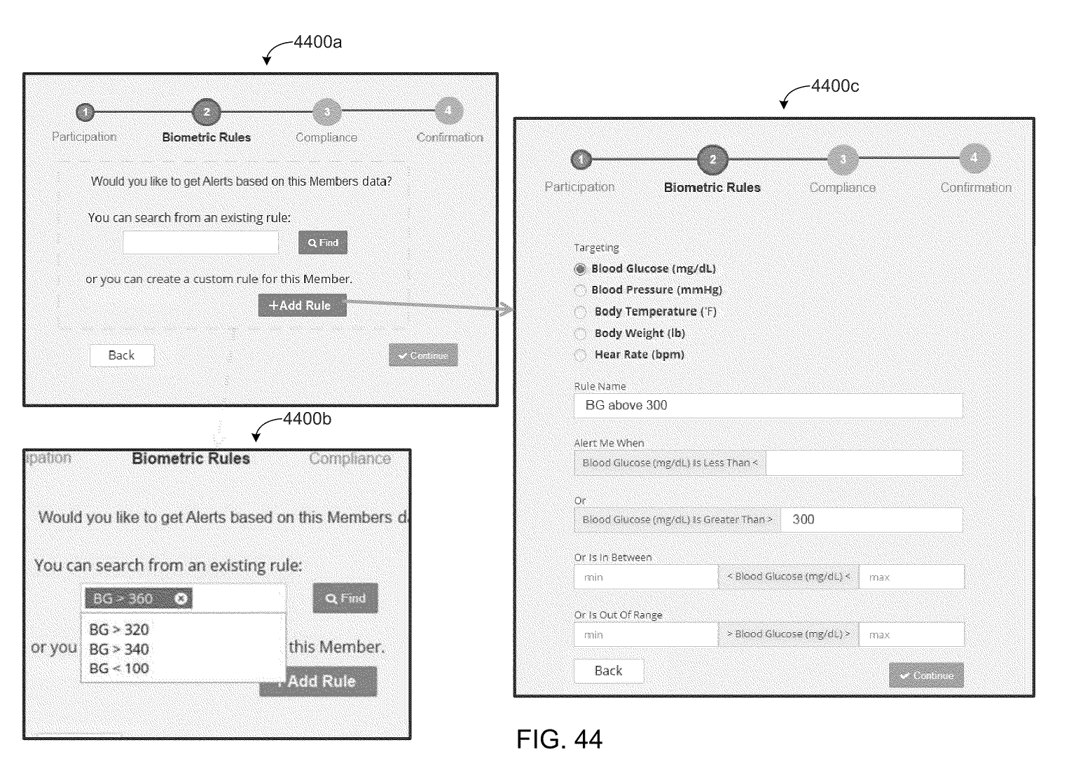

With respect to FIG. 44, graphical user interface 4400a, 4400b, 4400c may be configured to facilitate an invited user's addition of one or more health reading (e.g., biometric) rules with respect to an inviting user. In particular, the graphical user interface 4400a may permit the invited user to search the healthcare data system 102 for one or more existing biometric reading rules and then present the invited user with the results of the search. For example, as illustrated by the graphical user interface 4400b, the invited user may enter search terms, relating to a desired biometric reading rule, into a search field included by the graphical user interface 4400b, which may result in the graphical user interface 4400b presenting a listing of one or more existing biometric reading rules available for the invited user's selection. Examples of search terms for existing biometric rules can include conditions specified by biometric reading rules, name of biometric reading rules, keywords in the description of biometric reading rules, one or more actions performed by biometric reading rules (e.g., alert via SMS) when one or more conditions of are satisfied, and other parameters related to biometric reading rules.

Alternatively or additionally, the graphical user interface 4400a may permit an invited user to create a new biometric reading rule and add the newly-created biometric reading rule (e.g., a custom biometric reading rule) in association with an inviting user. For instance, as illustrated by the graphical user interface 4400c, the invited user may specify a type of biometric reading for a new biometric reading rule, provide a name for the new biometric reading rule, provide one or more actions for the new biometric reading rule (e.g., alert by e-mail and phone call), or specify one or more conditions for the new biometric reading rule.

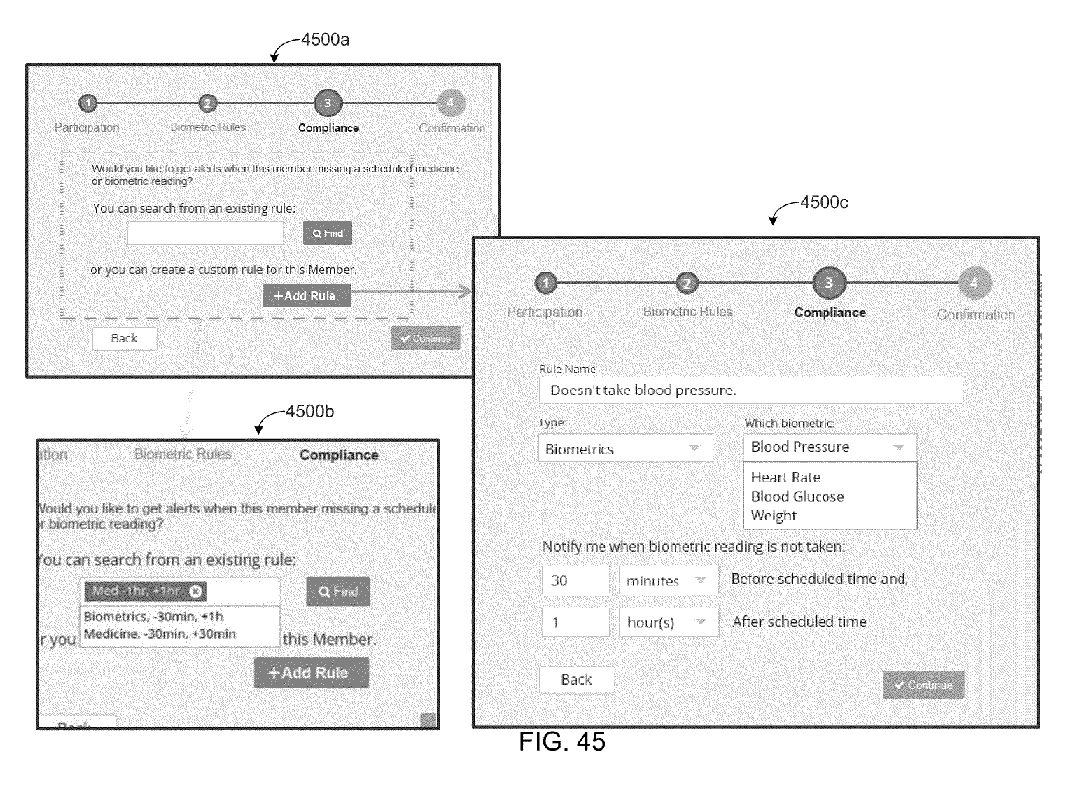

With respect to FIG. 45, graphical user interface 4500a, 4500b, 4500c may be configured to facilitate an invited user's addition of one or more compliance rules with respect to an inviting user. In particular, the graphical user interface 4500a may permit the invited user to search the healthcare data system 102 for, and then present the invited user with, one or more existing compliance rules that relate to the invited user complying with their medication regimen (e.g., monitored by the healthcare data system 102 for the inviting user), or the invited user complying with their scheduled biometric readings (e.g., scheduled in the healthcare data system 102 for the inviting user). For example, as illustrated by the graphical user interface 4500b, the invited user may enter search terms, relating to a desired compliance rule, into a search field included by the graphical user interface 4500b, which may result in the graphical user interface 4500b presenting a listing of one or more existing compliance rules available for the invited user's selection. Examples of search terms for existing compliance rules can include conditions (e.g., time conditions) specified by compliance rules, name of compliance rules, keywords in the description of compliance rules, one or more actions performed by compliance rules (e.g., alert via SMS), the type of compliance rule (e.g., medication or biometric reading-related), and other parameters related to biometric reading rules.

Alternatively or additionally, the graphical user interface 4500a may permit an invited user to create a new compliance rule and add the newly-created compliance rule (e.g., a custom compliance rule) in association with an inviting user. For instance, as illustrated by the graphical user interface 4500c, the invited user may specify a type of compliance rule (e.g., medication or biometric-reading compliance rule), provide a name for the new compliance rule, provide one or more actions for the new compliance rule (e.g., alert by SMS), or specify one or more conditions for the new compliance rule (e.g., notify the invited user 30 minutes before a scheduled biometric reading, or 1 hours after the scheduled biometric reading has not been taken).

It will be understood that for some embodiments a user can search for or add various types of rules to the healthcare data system 102 using methods or graphical user interfaces similar to those illustrated by FIG. 44 and FIG. 45.

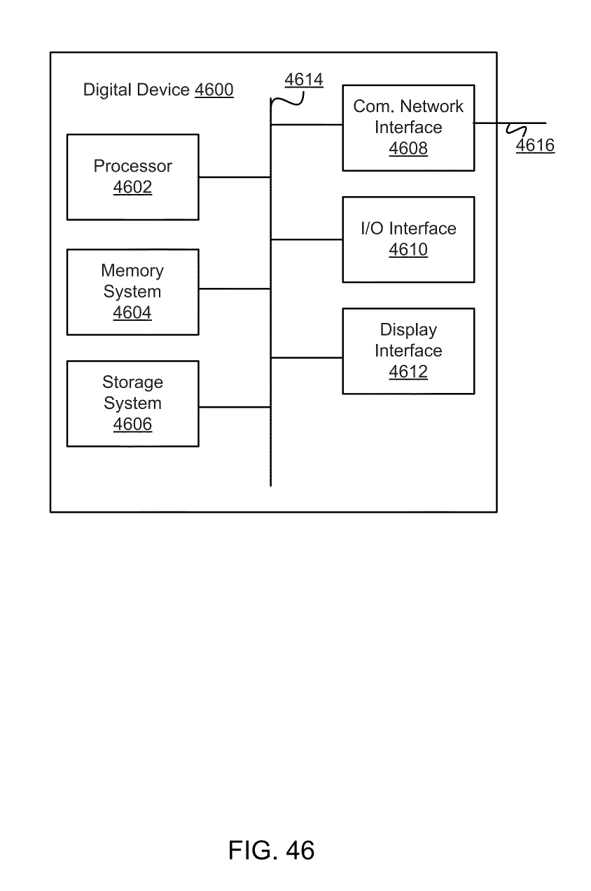

FIG. 46 is a block diagram of an exemplary digital device 4600. The digital device 4600 comprises a processor 4602, a memory system 4604, a storage system 4606, a communication network interface 4608, an I/O interface 4610, and a display interface 4612 communicatively coupled to a bus 4614. The processor 4602 is configured to execute executable instructions (e.g., programs). In some embodiments, the processor 4602 comprises circuitry or any processor capable of processing the executable instructions.

The memory system 4604 is any memory configured to store data. Some examples of the memory system 4604 are storage devices, such as RAM or ROM. The memory system 4604 can comprise the RAM cache. In various embodiments, data is stored within the memory system 4604. The data within the memory system 4604 may be cleared or ultimately transferred to the storage system 4606.

The storage system 4606 is any storage configured to retrieve and store data. Some examples of the storage system 4606 are flash drives, hard drives, optical drives, and/or magnetic tape. In some embodiments, the digital device 4600 includes a memory system 4604 in the form of RAM and a storage system 4606 in the form of flash data. Both the memory system 4604 and the storage system 4606 comprise computer readable media which may store instructions or programs that are executable by a computer processor including the processor 4602.

The communications network interface (com. network interface) 4608 can be coupled to a network (e.g., the computer network 104) via the link 4616. The communication network interface 4608 may support communication over an Ethernet connection, a serial connection, a parallel connection, or an ATA connection, for example. The communication network interface 4608 may also support wireless communication (e.g., 802.11a/b/g/n, WiMax). It will be apparent to those skilled in the art that the communication network interface 4608 can support many wired and wireless standards.

The optional input/output (I/O) interface 4610 is any device that receives input from the user and output data. The optional display interface 4612 is any device that is configured to output graphics and data to a display. In one example, the display interface 4612 is a graphics adapter.

It will be appreciated by those skilled in the art that the hardware elements of the digital device 4600 are not limited to those depicted in FIG. 46. A digital device 4600 may comprise more or less hardware elements than those depicted. Further, hardware elements may share functionality and still be within various embodiments described herein. In one example, encoding and/or decoding may be performed by the processor 4602 and/or a co-processor located on a GPU (i.e., Nvidia®).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

Various embodiments are described herein as examples. It will be apparent to those skilled in the art that various modifications may be made and other embodiments can be used without departing from the broader scope of the invention(s) presented herein. These and other variations upon the exemplary embodiments are intended to be covered by the present invention(s).

What is claimed is:

1. A system comprising:
a datastore including healthcare data associated with a first user;
a relationship module configured to establish an association between the first user and a second user;
a data access control module configured to control data access privileges of the second user to the healthcare data on the datastore, the data access privileges being controlled by the data access control module based on the association between the first user and the second user; and
a decision module configured to access at least a first subset of the healthcare data based on the data access privileges of the second user, and configured to issue or schedule a notification for the second user based on the first subset of data.

2. The system of claim 1, wherein the association includes a family relationship, a friendship, a healthcare professional, or a healthcare non-professional.

3. The system of claim 1, wherein the data access privileges comprises privileges for viewing, adding, modifying, or removing a second subset of data with respect to the healthcare data.

4. The system of claim 1, wherein the healthcare data includes a second subset of data regarding an existing health condition, a biometric, personal medical history, family medical history, a diet, medication history of the first user, currently prescribed medication regimen, or a prescription issued to the first user.

5. The system of claim 4, wherein the second subset of data includes an instruction, health practitioner information, a medication identifier, a dosage, an expiration, a medication amount, a refill count, refill date, or a refill condition relating to the prescription of the first user.

6. The system of claim 1, wherein the healthcare data includes a note, audio, a video, or an image relating to healthcare of the first user.

7. The system of claim 1, wherein at least some of the healthcare data is received from the first user through a mobile computing device.

8. The system of claim 7, wherein the at least some of the healthcare data is captured by the first user by the mobile computing device.

9. The system of claim 1, further comprising a user communication module configured to provide an in-system communication transport between two or more users of the system.

10. The system of claim 9, wherein the user communication module is further configured to transmit, based on a request by the first user, a second subset of data from the first user to another user over the in-system communication transport, the second subset of data being selected from the healthcare data by the first user.

11. The system of claim 1, further comprising a decision module configured to determine, based on a second subset of data from the healthcare data, whether the first user is complying with a prescribed medical regimen.

12. The system of claim 1, further comprising an authorization module configured to authorize or deny a first request, by the second user, for modifying the data access privileges of the second user to the healthcare data, or configured to authorize or deny a second request, by the second user, for establishing the association between the first user and the second user.

13. A method comprising:
storing, on a datastore, healthcare data associated with a first user;
establishing an association between the first user and a second user;
controlling data access privileges of the second user to the healthcare data on the datastore, the controlling being based on the association between the first user and the second user;
accessing at least a first subset of the healthcare data based on the data access privileges of the second user; and
issuing or scheduling a notification for the second user based on the first subset of data.

14. The method of claim 13, wherein the association includes a family relationship, a friendship, a healthcare professional, or a healthcare non-professional.

15. The method of claim 13, wherein the data access privileges comprises privileges for viewing, adding, modifying, or removing a second subset of data with respect to the healthcare data.

16. The method of claim 13, wherein the healthcare data includes a second subset of data regarding an existing health condition, a biometric, personal medical history, family medical history, a diet, medication history of the first user, currently prescribed medication regimen, or a prescription issued to the first user.

17. The method of claim 16, wherein the second subset of data includes an instruction, health practitioner information, a medication identifier, a dosage, an expiration, a medication amount, a refill count, refill date, or a refill condition relating to the prescription of the first user.

18. The method of claim 13, wherein the healthcare data includes a note, audio, a video, or an image relating to healthcare of the first user.

19. The method of claim 13, wherein at least some of the healthcare data is received from the first user through a mobile computing device.

20. The method of claim 19, wherein the at least some of the healthcare data is captured by the first user by the mobile computing device.

21. The method of claim 13, further comprising providing an in-system communication transport between two or more users of the method.

22. The method of claim 21, further comprising transmitting, based on a request by the first user, a second subset of data from the first user to another user over the in-system communication transport, the second subset of data being selected from the healthcare data by the first user.

23. The method of claim 13, further comprising determining, based on a second subset of data from the healthcare data, whether the first user is complying with a prescribed medical regimen.

24. The method of claim 13, further comprising authorizing or denying a first request, by the second user, for modifying the data access privileges of the second user to the healthcare data, or authorizing or denying a second request, by the second user, for establishing the association between the first user and the second user.

25. A system comprising:
means for storing, on a datastore, healthcare data associated with a first user;
means for establishing an association between the first user and a second user;
means for controlling data access privileges of the second user to the healthcare data on the datastore, the controlling being based on the association between the first user and the second user;
means for accessing at least a first subset of the healthcare data based on the data access privileges of the second user; and
means for issuing or scheduling a notification for the second user based on the first subset of data.
